(19) United States
(12) Patent Application Publication
(10) Pub. No.: US 2026/0054242 A1
(43) Pub. Date: Feb. 26, 2026

(54) Continuous Processing System And Methods For Internal And External Modifications To Nanoparticles

(71) Applicant: University of Connecticut, Farmington, CT (US)

(72) Inventors: Antonio P. Costa, Farmington, CT (US); Diane J. Burgess, Farmington, CT (US)

(21) Appl. No.: 19/327,445

(22) Filed: Sep. 12, 2025

Related U.S. Application Data
(63) Continuation-in-part of application No. 17/286,956, now Pat. No. 12,434,208.
(60) Provisional application No. 62/751,162, filed on Oct. 26, 2018.

(51) Int. Cl. B01J 19/00; B01J 13/02

(52) U.S. Cl. CPC B01J 19/0033; B01J 13/02; B01J 2219/002; B01J 2219/00234

(57) ABSTRACT

A continuous nanoparticle processing system includes a continuous flow path between an inlet and an outlet. The system has at least one sensor positioned to generate a signal indicative of a quality attribute of nanoparticles within the flow path, at least one actuator coupled to the flow path; and a controller operatively coupled to the sensor and the actuator and configured to, during operation, adjust the actuator in response to the signal to maintain the quality attribute of the nanoparticles within a target range while the nanoparticles traverse the flow path. A computer program product is disclosed.

### CROSS REFERENCE TO RELATED APPLICATIONS

This application is filed as a Continuation-In-Part of U.S. patent application Ser. No. 17/286,956 filed Apr. 20, 2021, which is a U.S. National Phase Application pursuant to 35 U.S.C. § 371 of International Application No. PCT/US2019/058305 filed Oct. 28, 2019, which claims priority to U.S. Provisional Application Ser. No. 62/751,162 filed Oct. 26, 2018. The foregoing references and U.S. patent application Ser. No. 15/557,575, now issued as U.S. Pat. No. 10,632,072, have been incorporated by reference herein in their entirety.

### STATEMENT REGARDING FEDERALLY SPONSORED RESEARCH

This invention was made with government support under contract numbers HHSF223201610121C and U01 FD005773 awarded by the United States Food and Drug Administration. The government has certain rights in the invention.

### BACKGROUND OF THE INVENTION

### 1. Field of the Invention

The technology disclosed herein relates to a continuous processing system for the controlled modification of pre-formed vesicular nanoparticles such as liposomes and other similar structures such as polymeric vesicles made from amphiphilic block copolymers.

### 2. Description of the Related Art

Liposomal nanoparticles are colloidal dispersions that are composed of one or more lipid-bilayers that surround an aqueous core. Important physicochemical properties of liposomes such as the hydrodynamic diameter or particle size, surface charge (typically measured as zeta-potential), lipid-packing, bilayer lamellarity, encapsulation efficiency, drug encapsulation, molecular loading and external modifications (such as polymer coatings and targeting moiety incorporation) are necessary to accurately control and measure to properly manufacture a pharmaceutical drug product. Liposomal nanoparticles can be formed to have a hydrodynamic diameter (in nanometers [d·nm]) ranging from approximately 30 d·nm to over 1,000 d·nm. For liposomal nanoparticles that are less than 1,000 d·nm, these particles exhibit Brownian motion and remain as a colloidal dispersion since the thermal motion of the particles overcome gravitational forces that would otherwise increase the likelihood of sedimentation.

There are many methods to form liposomal nanoparticles. One method is based on the solvent injection approach, where lipid molecules are dissolved in an organic solvent phase (e.g. ethanol) and the lipid/solvent is injected into an aqueous phase. By using this and similar approaches, empty liposomes can be formed at precise particle sizes. However, these pre-formed liposomes may lack molecular entrapment (e.g. of a drug molecule) and also surface modifications (e.g. polymer coatings) and will require multiple, subsequent processes to make such modifications.

A mechanism to load molecules in the intraliposomal space of pre-formed liposomes is known as remote loading (also referred to as active loading). Examples of molecules that can be loaded by this approach include amphipathic weak acids and bases such as doxorubicin, daunorubicin, epirubicin, idarubicin, vincristine and irinotecan hydrochloride. In one method, the active loading process includes first forming a liposomal dispersion in a high salt aqueous phase (e.g. 250 millimolar [mM]) followed by removing unencapsulated or extra-liposomal salt. Examples of salts applicable to this method include the ammonia salts of sulfate, phosphate, citrate, acetate, among others. The difference in salt concentration between the intraliposomal environment and the extraliposomal environment, along with a transmembrane pH gradient, establishes a driving force for the aforementioned molecules to enter the liposomal interior. Moreover, intraliposomal and extraliposomal pH values are important to control in order to perform the loading process.

Additional factors that impact the active loading include the partition coefficient of the loading molecule and its negative log of the acid dissociation constant (pKa). Accordingly, in order to achieve a high degree of drug loading, these molecules are partially unionized at the loading pH and are able to permeate through the lipid-bilayer. Upon permeating through the bilayer and partitioning into the intraliposomal aqueous space, the molecule may undergo precipitation, crystallization or gelation. For example, doxorubicin-hydrochloride has been referred to as a nanorod or nanocrystal, which is formed when the active loading process incorporates ammonium sulfate at salt concentrations over 150 mM, or as precipitates of doxorubicin sulfate, which are formed when the intraliposomal space is typically less than 100 mM salt concentrations.

Conventional pharmaceutical manufacturing is operated as a batch process, which typically requires large volumes of liposomes to be processed (e.g. hundreds of liters) at multiple stages. For example, the first stage may be to form pre-formed, empty liposomes followed by multiple tangential flow filtration stages and further followed by an active loading stage. One problem with the remote loading approach while operating as a batch process is that this approach requires prolonged times (e.g. up to several hours) and adequate heating in order to achieve over 90% drug encapsulation. In addition, conventional approaches require that the extraliposomal aqueous phase to be at a very low salt concentration compared to the intraliposomal space to establish a sufficient salt gradient. In this manner, prolonged batch processing times, large processing volumes, high temperatures (e.g. over 60 degrees Celsius) and removal processes of extraliposomal salt are barriers to effectively implement the active loading approach for large-scale manufacturing on a wide scale.

A second problem is that actively-loaded molecules may form multiple structural states or morphologies, especially during batch manufacturing. These structural states may include salt-drug precipitates and nanocrystals of various shapes (e.g. rod-like appearance and curved structures) and nanocrystals of various lengths. These different structural states are also known to affect nanoparticle stability, drug dissolution from the intraliposomal space and may even lead to adverse reactions by activation of the human complement system, inter alia. With respect to complement activation, it has been proposed that elongated nanoparticles, i.e. particles with an apparent aspect ratio of >1.15, which is caused by extended crystal growth, may cause palmar-plantar erythrodysestheisa (also known as hand-foot syndrome). This elongation of the nanoparticles can occur when the nanocrystal growth is uncontrolled during the active loading processing stage. Accordingly, without proper control of the crystal growth in the liposomal compartment, a pharmaceutical drug product may vary from batch to batch, which could lead to variability in the drug product's effectiveness and safety over the product's lifespan. Moreover, generic pharmaceutical drug formulations may have different safety data and exhibit dissimilar adverse reactions when compared to a reference listed drug product (or a reference standard in some cases).

In another aspect, an environment for the study of controlled structural growth kinetics of nanocrystals is difficult to form. In this manner, the intraliposomal compartment can be considered as a reactor to study the growth of various structures and phases. Moreover, as the liposomal colloidal dispersion is subject to Brownian motion, and to a lesser degree impacted by the effects of gravity (e.g. sedimentation), it becomes an important tool that can be used to study crystal growth kinetics by observing structural formation within a confined, isolated aqueous environment, i.e. the intravesicular aqueous space.

What are needed are improved methods and apparatus for the formation of liposomes.

### SUMMARY OF THE INVENTION

In one embodiment, a continuous nanoparticle processing system is provided. The system includes a continuous flow path between an inlet and an outlet; at least one sensor positioned to generate a signal indicative of a critical quality attribute of nanoparticles within the flow path; at least one actuator coupled to the flow path; and a controller operatively coupled to the sensor and the actuator and configured to, during operation, adjust the actuator in response to the signal to maintain the quality attribute of the nanoparticles within a target range while the nanoparticles traverse the flow path.

The actuator may include at least one of a pump, a valve, a heater, a chiller, or a pressure regulator. The sensor may include at least one of a dynamic-light-scattering probe, a near-infrared probe, a UV-visible probe, a refractive-index detector, or a conductivity probe. The controller may include a processor and a non-transitory memory storing instructions that, when executed by the processor, configure the controller to adjust the actuator in response to the signal. The flow path may include modular connections between unit-operation housings that permit reconfiguration without intermediate hold tanks. The flow path may lack uncontrolled hold volumes between a formation location and a downstream location. The quality attribute may include at least one of particle-size distribution, residual-solvent fraction, nanoparticle concentration, encapsulation efficiency, or surface-ligand density.

In another embodiment, a non-transitory computer-readable medium storing instructions that, when executed by a processor of a controller of a continuous nanoparticle processing system having a flow path between an inlet and an outlet is disclosed. The instructions cause the controller to: receive a signal from at least one sensor indicative of a quality attribute within the flow path; compute an error relative to a set point; and command at least one actuator to adjust at least one parameter to maintain the critical quality attribute within a target range during continuous passage.

The parameter may include at least one of a flow ratio, a recirculation flow, a diafiltration or permeate flow or transmembrane pressure, and a temperature. The sensor may employ at least one of a dynamic-light-scattering, near-infrared, or UV-visible wavelengths. The instructions may implement an API with endpoints to (i) set a target for a critical quality attribute, (ii) read a current value and an error, and (iii) enable or disable closed-loop control. The instructions may expose an API endpoint to write actuator limits comprising a maximum flow, a maximum transmembrane pressure, and a maximum temperature. The instructions may implement role-based access control for API operations including viewing status, editing set points, editing limits, and initiating a controlled shutdown. The instructions may compute a control output by a proportional-integral-derivative algorithm with anti-windup subject to actuator limits. The instructions may implement an API endpoint to publish alarms upon error threshold exceedance or loss of a sensor or actuator. The instructions may load a recipe including a set point, a ramp profile, and actuator limits, and expose an API endpoint to activate the recipe. The instructions may that expose an API endpoint to declare availability of a formation module, a buffer-exchange module, a concentrator, or a modification module and to reconfigure control routing when a module is bypassed. The instructions may be configured to detect loss of sensor updates or control-loop execution and commands a controlled shutdown according to stored limits, a concentrator, or a modification module and to reconfigure control routing when a module is bypassed.

In another embodiment, a continuous nanoparticle processing system is provided. The system includes a flow path that receives a stream with nanoparticles; at least one sensor that generates a signal indicative of a quality attribute; at least one actuator; and a controller configured to adjust the actuator in response to the signal to maintain the quality attribute of the nanoparticles within a target range during continuous passage of the stream. The nanoparticles may include liposomes.

### BRIEF DESCRIPTION OF THE DRAWINGS

The features and advantages of the invention are apparent from the following description taken in conjunction with the accompanying drawings in which:

FIG. 1 is a schematic representation of a formation-centric system for the continuous manufacturing process for liposomal drug formulations.

FIG. 2 is a schematic representation of a lipid mixing process.

FIG. 3 is a control design for a system for the continuous manufacturing process for liposomal drug formulations.

FIG. 4 is a schematic representation of a liposome formation stage.

FIG. 5 is a schematic representation of an example injection port.

FIG. 6 is a schematic representation of a lipid mixing process and a liposome formation stage including an injection port.

FIG. 7 is a schematic representation of the liposome formation stage followed by an ethanol dilution stage.

FIG. 8 is a schematic representation of a lipid concentration stage.

FIG. 9 is a cause and effect diagram highlighting the main stages of the continuous process with subdivisions for each main stage.

FIG. 10 is a cause and effect diagram outlining variables that result in obtaining accurate particle size data for a continuous process.

FIG. 11 is a cause and effect diagram outlining variables that affect the lipid concentration detection via an NIR sensor.

FIG. 12 is a cause and effect diagram outlining variables that affect the liposome formation process with respect to material and process variables.

FIG. 13 is a flowchart illustrating an example of a method.

FIG. 14 is a design space of the DOE study on the impact of lipid concentration and aqueous phase flow rate on particle size.

FIG. 15 is a schematic and photographic image of the injection port that allows formation of a coaxial turbulent jet.

FIG. 16A is a graphical representation of flow velocity ratio (FVR) vs. the mixture Reynolds Number (Remixture).

FIG. 16B is a plurality of flow images corresponding to locations (1, 2, 3, and 4) from FIG. 16a demonstrating flow profiles leading to monodispersed or polydispersed systems.

FIG. 16C is a graphical representation of Z-average particle size vs. Remixture for only monodispersed liposomes. dA1=3.175 mm, dA2=4.572 mm, dE1=0.508 mm, dE2=1.016 mm.

FIG. 17 is a surface profile plot of the Z-average particle size vs. the aqueous phase flow rate (AFR) and lipid concentration.

FIG. 18 is a graphical representation of the effect of lipid type (i.e. DMPC, DPPC, DSPC, DOPC) on mean particle size and PDI.

FIG. 19 is a graphical representation of the effect of aqueous phase additives on mean particle size.

FIG. 20 is a graphical representation of different particle sizing techniques (dynamic light scattering, nanoparticle tracking and particle counting via NS-TEM to assess liposome mean particle size and particle size distribution.

FIG. 21 is a graphical representation of liposome mean particle size and standard deviations for DLS, nanoparticle tracking, NS-TEM and Cryo-TEM.

FIGS. 22A-22D, collectively referred to herein as FIG. 22, are negative stain TEM micrographs of liposomes for three liposome samples produced using different flow conditions.

FIGS. 23A-23C, collectively referred to herein as FIG. 23, are Cryo-TEM micrographs of liposomes for three liposome samples produced using different flow conditions.

FIG. 24 is a model for liposome formation from a coaxial turbulent jet mixer in co-flow.

FIG. 25 is a graphical representation of liposome mean particle size and polydispersity index for both lipid:Chol:DPPG (4.5:3:0.4 molar ratio) liposomes, where lipid refers to either DMPC or DPPC.

FIG. 26 is a graphical representation of liposome mean particle size and polydispersity index for DPPC:Chol:DPPG (4.5:3:0.4 molar ratio) liposomes.

FIG. 27 is a graphical representation of liposome mean particle size and polydispersity index for DMPC:Chol:DPPG (4.5:3:0.4 molar ratio) liposomes.

FIGS. 28A-C, collectively referred to herein as FIG. 28, are a comparison of manual DLS measurement settings on the liposome particle size (z-average), the PDI and the DLS count rate (kcps).

FIG. 29 is a graphical representation of liposome mean particle size and polydispersity index for DPPC:Chol:DPPG (4.5:3:0.4 molar ratio) liposomes.

FIG. 30 is a graphical representation of liposome mean particle size and polydispersity index (PDI) for DMPC:Chol:DPPG (4.5:3:0.4 molar ratio) liposomes in 10 mM Phosphate Buffer.

FIG. 31 is a graphical representation of liposome mean particle size and polydispersity index (PDI) for DPPC:Chol:DPPG (4.5:3:0.4 molar ratio) liposomes in 10 mM Hepes buffer.

FIG. 32 is a graphical representation of liposome mean particle size and polydispersity index (PDI) for DPPC:Chol:DPPG (4.5:3:0.4 molar ratio) liposomes in 10 mM NaCl.

FIG. 33 is a graphical representation of liposome mean particle size and polydispersity index (PDI) for DPPC:Chol:DPPG (4.5:3:0.4 molar ratio) liposomes in 75 mM NaCl.

FIG. 34 is a graphical representation of liposome mean particle size and polydispersity index (PDI) for DPPC:Chol:DPPG (4.5:3:0.4 molar ratio) liposomes in 140 mM NaCl.

FIG. 35 is a graphical representation of liposome mean particle size (z-average, d·nm) for DPPC:Chol:DPPG (4.5:3:0.4 molar ratio) liposomes in 10-140 mM NaCl and 10 mM PB.

FIG. 36 is a graphical representation of liposome zeta potential for DPPC:Chol:DPPG (4.5:3:0.4 molar ratio) liposomes in 10-140 mM NaCl and 10 mM phosphate buffer.

FIG. 37 is a graphical representation of an example of automatic particle size control for HSPC:Chol:DPPG (4.5:3:0.4 molar ratio) liposomes prepared in 10 mM NaCl is shown.

FIG. 38 is a graphical representation of an experimental design of the lipid concentration prediction model based on scattered light from an NIR turbidity sensor.

FIG. 39 is a graphical representation of an experimental design for the lipid concentration with factors including particle size (d·nm), polydispersity index (PDI), ppm and CU.

FIG. 40 is a graphical representation of a surface profile plot for the lipid concentration [Lipid] prediction model.

FIG. 41 is a graphical representation of an example of how the NIR signal output in PPM is affected by the polydispersity of a liposomal formation.

FIG. 42 illustrates a table showing DOE on lipid concentration vs. particle size-model parameter estimates sorted by statistical significance.

FIG. 43 illustrates a table showing variables that influence continuous particle size measurements.

FIG. 44 illustrates a table showing TSQ HPLC-MS ESI operating conditions used in the analysis of lipid concentration quantitation.

FIG. 45 illustrates a table showing sorted parameter estimates and model terms for Model 1.

FIG. 46 illustrates a table showing sorted parameter estimates and model terms for Model 2.

FIG. 47 illustrates a table showing validation data points for both lipid concentration ([Lipid]) models. {END OF [072]}

FIG. 48 is a schematic representation of another system for the continuous manufacturing process for the production of nanoparticles.

FIG. 49 is a schematic representation of an embodiment of an end-to-end train system.

FIG. 50 is a schematic representation of another embodiment of the system of FIG. 49.

FIG. 51 is a schematic representation of another embodiment of the system of FIG. 49.

FIG. 52 is a schematic representation of another embodiment of the system of FIG. 49.

FIG. 53 is a schematic representation of another embodiment of the system of FIG. 49.

FIG. 54 is a schematic representation of another embodiment of the system of FIG. 49.

FIG. 55 is a schematic representation of another embodiment of the system of FIG. 49.

FIG. 56 is a schematic representation of another embodiment of the system of FIG. 49.

FIG. 57 is a schematic representation of another embodiment of the system of FIG. 49.

FIG. 58 is a schematic representation of another embodiment of the system of FIG. 49.

FIG. 59 is a schematic representation of another embodiment of the system of FIG. 49.

FIG. 60 is an example of controlled molecular growth where the turbulent jet mixer is in co-flow.

FIG. 61 is an example mechanism of molecular growth within the liposomal core.

FIG. 62 illustrates an electronic spectrum shift and new peak formation of an unencapsulated molecule and the encapsulated molecule.

FIG. 63 is a flowchart illustrating an example of a method.

FIG. 64 is a flowchart illustrating another example of a method.

### DETAILED DESCRIPTION OF THE INVENTION

Disclosed herein are methods and apparatus for forming nanoparticles from an organic phase and an aqueous phase. The platform technology provides for conditioning the dispersion to meet targets for composition of the nanoparticles. Sensors provide signals that correlate with characteristics such as size and composition of the nanoparticles. A controller is provided to adjust flow and temperature and to otherwise maintain target values for forming of the nanoparticles.

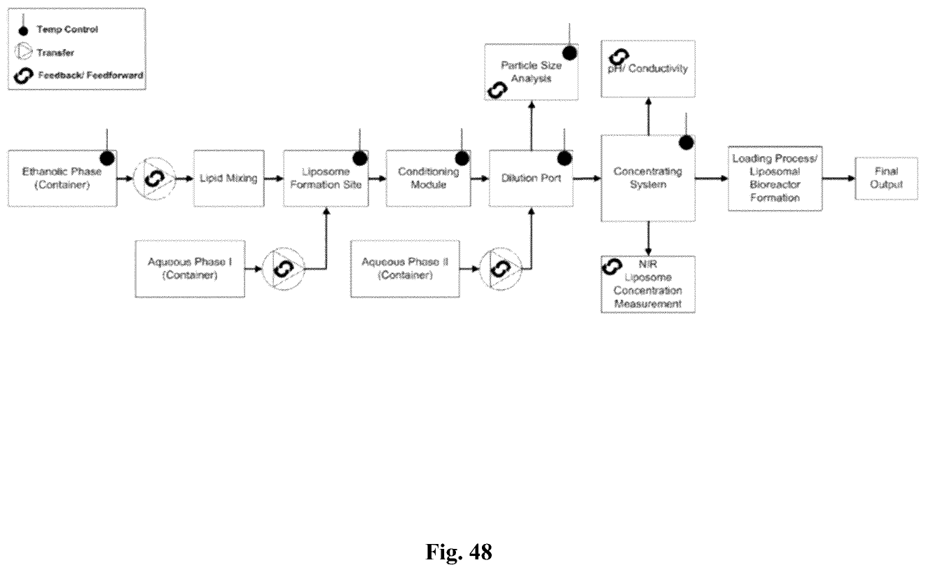

In a second version of the technology (described in more detail with reference to FIGS. 48-64), a continuous train that performs buffer exchange, concentration, and post-formation modification is disclosed. In this example, a modification module performs internal loading or external surface change. The train links formation, buffer exchange, concentration, and modification without intermediate storage that causes uncontrolled change.

Generally, as used herein the terms “mixing module” (110) also refers to formation; includes injectors/mixers, devices and techniques; the term “conditioner” (120) also refers to early solvent control, with “degassing unit” (129) as an optional sub-unit; the “buffer-exchange module” (140) also refers to diafiltration devices and techniques; the “concentrator” (130A/130B) and “manifold” (132) also refers to TFF concentration layouts devices and techniques; the “modification module” (150) also refers to internal loading or external surface change devices and techniques; “sensors” (160) also refers to DLS/NIR/UV-Vis/refractive index devices and techniques; “controller” (170) generally refers to devices and techniques for reading, computing, adjusting, controlling, monitoring, storing and logging; and the recirculation loop (180) (as stated).

Generally, as used herein, the term “actuator” is a broad term that refers to a device that changes a process variable in a flow path in response to a control signal. Non-limiting examples include a positive-displacement pump changes a total flow rate in the flow path when a controller changes a motor speed that a flowmeter confirms. Other non-limiting examples include a metering pump; a control valve; a three-way valve; a proportional valve; a back-pressure regulator; a heater; a chiller; a variable-speed drive coupled to a pump; an in-line mixer with an adjustable speed. Generally, an actuator responds to an electronic control signal and produces a measurable change in at least one of flow rate, pressure, temperature, stream routing or other parameter in order to control quality of product within a defined response time.

Generally, the term “liposome” refers to a minute spherical sac of phospholipid molecules enclosing, for example, a water droplet, especially as formed artificially to carry drugs or other substances into the tissues. Generally, liposomes are classified into four categories based on size and number of bilayers: small unilamellar vesicles (SUV), large unilamellar vesicles (LUV), multilamellar vesicle (MLV), and multivesicular vesicles (MVV). Liposomes have mono phospholipid bilayer in a unilamellar structure, while they have an onion-like structure in a multilamellar structure. MVV form a multilamellar arrangement with concentric phospholipid spheres as many unilamellar vesicles are produced within larger liposomes. Liposome encapsulation efficiency increases with liposome size and decreases with the number of bilayers for hydrophilic compounds only. The size of the vesicles is an important factor that controls the circulation half-life of liposomes. Both the size and number of bilayers influence the amount of the encapsulated drug. When liposomes are employed for drug delivery, the desired vesicles usually extend from 50 nm to 150 nm. Liposomes interaction with the cell membrane is represented by various theories: specific (modified with receptor-mediated) or nonspecific endocytosis, local fusion (adhesion), phagocytosis, and absorption into the cell membrane. Liposome-cell interactions are influenced by a variety of factors, including composition, the diameters of liposomes, surface charge, targeting ligand on the liposome surface, and biological environment.

Structurally, liposomes are spherical or multilayered spherical vesicles made by the self-assembly of diacyl-chain phospholipids (lipid bilayer) in aqueous solutions. The bilayer phospholipid membrane has a hydrophobic tail and a hydrophilic head that leads to the formation of an amphiphilic structure. Liposomes can be made from both natural and synthetic phospholipids. Lipid composition strongly affects liposome characteristics that include: particle size, rigidity, fluidity, stability, and electrical charge. For example, liposomes formulated from natural unsaturated phosphatidylcholine, as egg or soybean phosphatidylcholine, provide highly permeable and low stable properties. Though, saturated-phospholipids-based liposomes such as dipalmitoyl phosphatidylcholine led to rigid and almost impermeable bilayer structures.

The hydrophilic group in the lipids may be negatively, positively charged, or zwitterionic (both negative and positive charge in the same molecule). The charge of the hydrophilic group provides stability through electrostatic repels. The hydrophobic group of lipids varies in the acyl chain length, symmetry, and saturation. The lipids that used in liposomes preparation may be classified as: natural lipids; synthetic lipids; steroids; surfactants; and others.

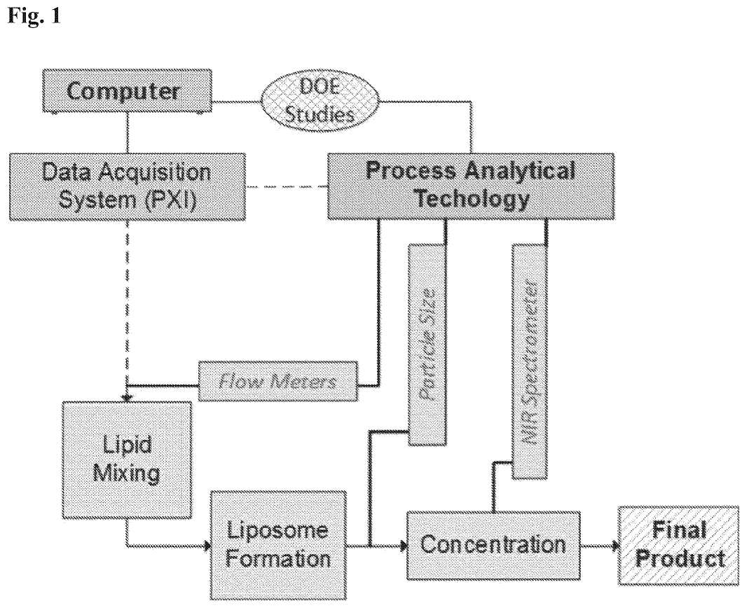

Generally, FIG. 1 depicts aspects of a continuous formation system with a mixing module, a conditioner, a buffer-exchange module, a concentrator, sensors, and a controller. The example of FIG. 1 illustrates an overview of an embodiment of a continuous manufacturing process for liposomal drug formulations. In this example, the computer/data acquisition system controls/acquires all signals from the process. The continuous manufacturing design may include “Process Analytical Technology” (PAT) to increase quality assurance and consistency during operation. PAT will analyze parameters such as particle size, zeta potential, and encapsulated drug for quality control purposes in real-time. These formulation parameters will be fed back into the system such that the overall process is constantly controlled and monitored, leading to ultimately a high quality formulation with increased throughput.

A PAT tool may be any tool that fits under the following categories: (1) acquire/analyze data (multivariate capable); (2) processing analyzer; (3) process control tool; and (4) management tool that allow for continuous improvement and knowledge of a process. Multivariate tools may be statistical designs of experiments (DOE). Combining these DOE studies with some type of computer software (as a process control tool) to control and alter processing conditions would fit under this category. In this case, a predictive equation or results from a DOE study may then be used to adjust the final formulation when process variations are encountered. Process analyzing tools can be implemented in three ways: (1) at-line, or where a sample is removed and isolated from a system; (2) on-line, or where a sample is diverted, measured and returned to the process; or (3) in-line, or where a sample is measured directly in the process. Process analyzers generate large amounts of data that can be collected and stored for quality control purposes and reporting. Lastly, analysis of data to build on the understanding of the overall process will aid in a continuous learning and improvement of the processing stream, which will facilitate regulatory acceptance and provide evidence to support alterations to an existing process.

An example of a possible at-line or on-line measurement technique makes use of the Malvern Zetasizer with a flow-cell attachment. A solenoid valve may be configured to open and direct the flow of the sample to the Zetasizer flow cell and closes once enough sample is loaded in the cell. The Zetasizer then performs a measurement and this information may be sent to purpose oriented software, such as a custom-built LabVIEW program. In the LabVIEW program, the measurement value is analyzed and process conditions (e.g. flow rates) may be altered to re-adjust the particle size to be within quality control limits.

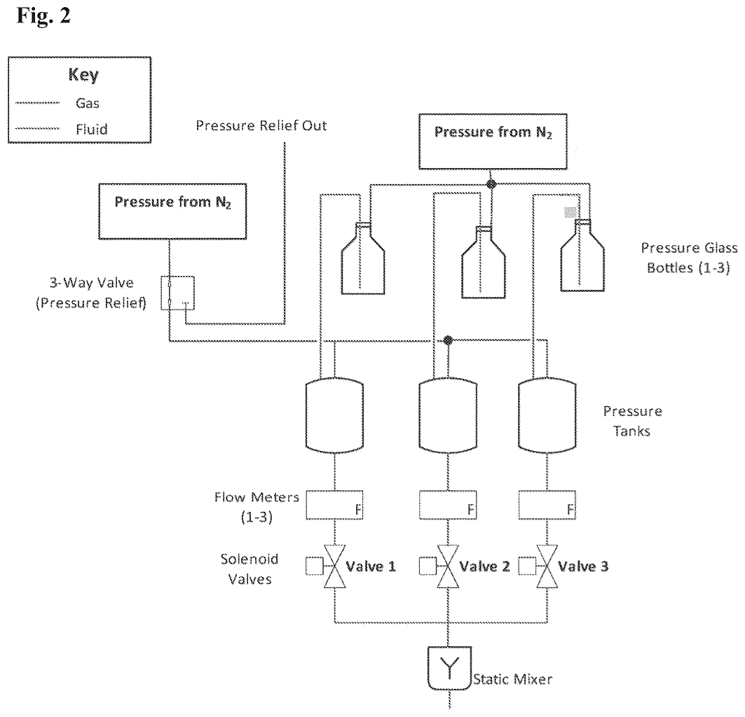

FIG. 2 illustrates an example of a lipid-mixing stage of the continuous liposome manufacturing process. In the example as shown in FIG. 2, the mixer is a static mixer that combines solutions from each of the one or more containers. In the particular example shown in FIG. 2, the lipid-mixing stage includes three containers including three different reservoirs of lipid dissolved in ethanol. An ethanol-injection method was chosen to prepare the liposomes. The ethanol-injection method can be developed as a continuous process and the solvent (ethanol) is less toxic than other solvents (e.g. chloroform) used in other preparation methods. Moreover, many lipids are soluble or moderately soluble in ethanol. However, other organic solvents are possible as well.

Since the lipid concentration in each reservoir may be different, the system shown in FIG. 2 describes a way to mix the lipid dissolved in ethanol. Lipid and ethanol may be placed in each of the three glass pressure bottles, although other containers are possible as well. Further, there may be additional or fewer containers than the three glass pressure bottles shown in FIG. 2. A nitrogen gas tank may be connected to each container with a maximum of 20 psi flowing into each of the containers. Other maximum pressures are possible as well. In addition, lipid and ethanol may be transferred from reservoirs via a pump (e.g. a gear pump) instead of using pressurized containers. It is useful to maintain a constant flow without many disturbances in the fluid flow (e.g. abruptly changing the flow rates on a short time scale).

As shown in FIG. 2, a first set of one or more valves may be positioned between the one or more containers and the one or more pressure tanks. Further, a second set of one or more valves may be positioned in fluid communication with each of the one or more containers. In addition, one or more flow meters may be positioned between each of the one or more pressure tanks and each of the one or more valves of the second set. In one example, the first set of one or more valves are solenoid valves, and the second set of one or more valves are proportioning valves.

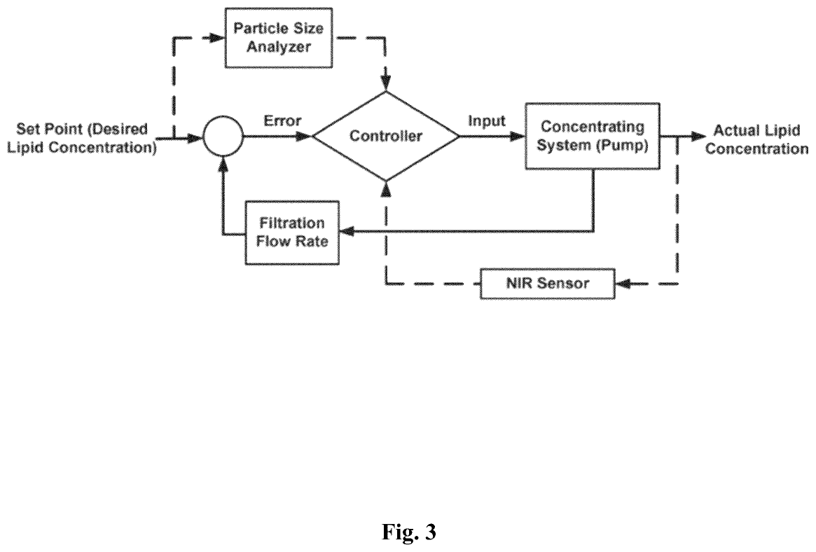

In the example shown in FIG. 2, the proportioning valves are positioned downstream from the containers. When the solenoid valves open, ethanol flows through one or more flow meters. In another embodiment, the solenoid valves may be replaced by air/pressure actuated valves, or any type of valve that can be controlled via a control system. Each of the one or more flow meters detects the flow rate of the ethanol and sends feedback to a controller. The feedback may be controlled via a proportional-integral-derivative (PID) controller. FIG. 3 is an example of a control loop using both feedback and feedforward control.

As shown in FIG. 3, the feedback control may include a pump that adjusts to maintain a set flow rate and may be used to increase or maintain a lipid concentration. A particle size analyzer and near-infrared (NIR) sensor may be used as feedforward controls in that measurements from these components may be used as inputs in a predictive model that is used to determine the lipid concentration.

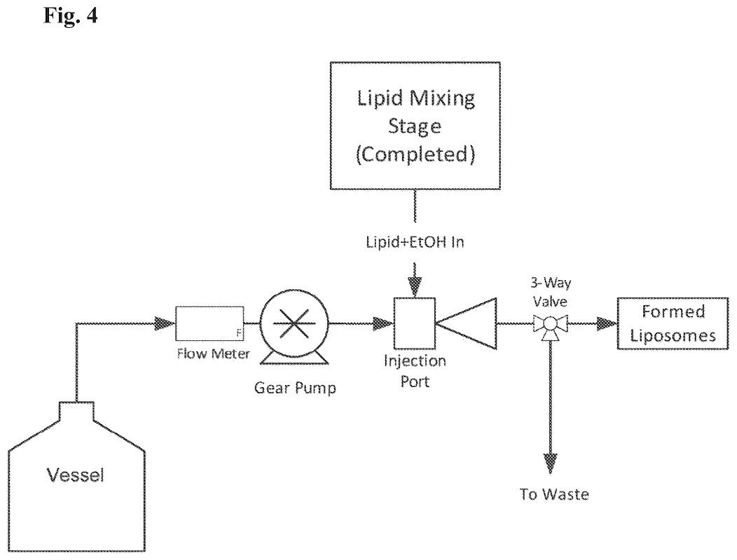

FIG. 4 illustrates the liposome formation stage of the continuous liposome manufacturing process. The liposome formation stage will consist of an “injection port” that connects the lipid and ethanol liquid stream with an aqueous stream. When both streams come in contact, liposomes will be formed. The diffusion of lipid from the ethanol stream into the aqueous stream causes the lipid to form into bilayers and subsequently liposomes. In order to transfer the aqueous medium from a vessel to the injection port, a gear pump may be incorporated into the design, as shown in FIG. 4. A gear pump may be advantageous since it has a continuous duty cycle, which prevents a pulsed flow. For example, peristaltic pumps have a pulsed flow due to the motor heads compressing the tubing to move the fluid. This pulsing will cause flow rates to change and may result in liposome formation with heterogeneous particle sizes. In one specific example, an I-Drive gear pump may be used to control the flow rate of the aqueous or aqueous-organic mixture phase input. This gear pump is a compact, brushless DC electromagnetic drive and is controlled via a 4-20 mA analog signal. The wetted parts are: 316 SS body, polyphenylene sulfide (PPS), polytetrafluoroethylene (PTFE)—all of which are compatible with water and ethanol. The flow rate range for this gear pump is approximately 20-500 mL/min. Other pumps that maintain a constant flow rate are possible as well.

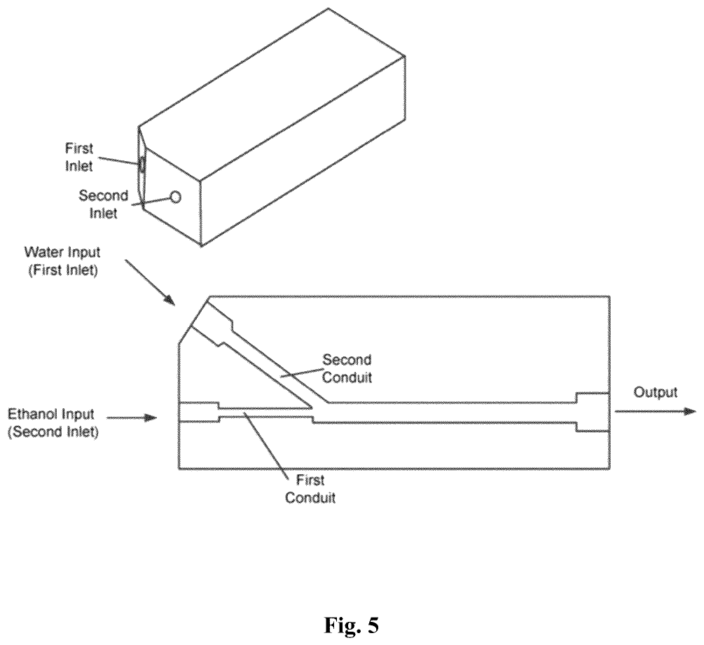

An example injection port is shown in FIG. 5. Such an injection port allows for rapid mixing of the ethanol and lipid into the aqueous phase. This rapid mixing is the location where the liposomes are formed. The injection port may comprise stainless steel, such as 304 stainless steel or 316 stainless steel. In another example, the injection port may comprise a plastic material, such as PTFE. Other materials are possible as well. As shown in FIG. 5, the injection port includes two inlets, one for lipid and ethanol and one for the aqueous or aqueous-organic mixture phase. The joined output is designed for flow rates greater than about 400 mL/min.

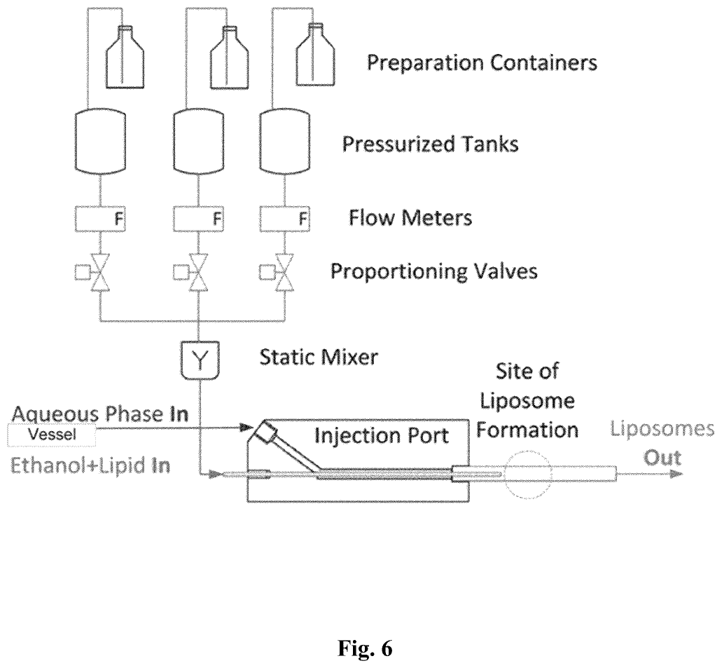

One particular embodiment of the system for continuous production of liposomes is shown in FIG. 6. As shown in FIG. 6, the system may include a mixer in fluid communication with one or more preparation containers. The mixer may be a static mixer configured to combine a solution from each of the one or more preparation containers. The system may further include a vessel. An example vessel may include an aqueous solution, such as water, a low-medium ionic strength water (e.g. 0.9% NaCl in water), an aqueous-organic phase mixture, an aqueous phase buffer, or any type of buffer commonly used in drug products (e.g. phosphate buffer or histidine buffer with sucrose), as examples. The system may further include one or more injection ports, each injection port including a first inlet, a second inlet, and an outlet, as discussed above in relation to FIG. 5. The first inlet may include a first conduit in fluid communication with the mixer, and the second inlet may include a second conduit in fluid communication with the vessel. As shown in FIG. 6, the second conduit may extend through the outlet of the injection port. The first conduit may be positioned concentrically within the second conduit such that the first conduit extends through the outlet of the injection port and terminates within the second conduit. The location of the liposome formation may not be located inside the injection port, but rather approximately the location where the first conduit terminates within the second conduit. In one particular example, the first conduit extends between about 0.5 inches to about 24 inches from the outlet of the injection port, and the second conduit extends between about 0.5 inches to about 24 inches from the outlet although other examples are possible as well. In one example, the plurality of liposomes formed in the system are unilamellar liposomes.

In the particular example shown in FIG. 6, the system further includes one or more pressure tanks connected to the one or more containers. The system may further include one or more valves in fluid communication with the one or more containers, and one or more flow meters positioned between the one or more pressure tanks and the one or more valves. In yet another example, the system may include one or more pulseless pumps (e.g., gear pumps) and a one or more non-pressurized containers to maintain low flow rates. As discussed above, the one or more containers may each include a different concentration of lipid dissolved in ethanol. As such, by adjusting the ratio of a solution comprising a combination of fluid from each of the one or more containers, the system may consequently adjust a lipid concentration of a lipid solution provided to the first inlet of the injection port.

In another embodiment, the first inlet of each of the one or more injection ports includes a third conduit in fluid communication with the mixer, wherein the third conduit is positioned concentrically within the second conduit and adjacent to the first conduit such that the third conduit extends through the outlet.

The system may further include a particle size analyzer configured to determine a size and/or a size distribution (e.g., a mean, mode, or percentage of a size class) of liposomes created within the system. The mean particle size diameter and particle size distribution of liposomes can be analyzed by a variety of instruments and technologies. These technologies include but are not limited to: dynamic light scattering, static light scattering, particle tracking, various forms of electron microscopy and acoustic spectroscopy. In order to accommodate many liposomal formulations, particle sizing technology used to measure liposomes may be capable of measuring particle diameters as low as 25 nm. Moreover, many of these technologies are only applicable to off-line measurements and cannot be implemented into a process (i.e. batch nor continuous). For a continuous process, the measurement may be either at/on/in-line capable. Two technologies that have this capability are dynamic light scattering and acoustic spectroscopy.

Dynamic light scattering is based on light or photon fluctuations that are correlated to the diffusion of particles, which is then related to particle size information. This technique uses two analyses in calculating the particle size data; namely, an intensity-based analysis and an intensity-weighted or cumulants analysis. The intensity analysis is based on the raw data (photon fluctuations). The cumulants analysis is based on an exponential equation and is weighted according to the intensity of the particles. For continuous measurements, this technique can be setup in a process stream by the use of a flow cell. The flow cell enables the sample to enter the cell at one end and leave the cell at the other. A pump may be used to control the flow rate and/or stop the flow into the flow cell. If the flow rate is low enough to sustain laminar flow (around 1-1.5 ml/min), then the sample may constantly flow through the flow cell during measurement. For higher flow rates, turbulence develops and the higher velocities impart motion to the particles, resulting in erroneous particle size measurements. If higher flow rates are required (>1.5 mL/min), the sample can be rapidly loaded into the flow cell followed by stopping the flow prior to the particle sizing measurement.

Acoustic spectroscopy is based on the propagation of sounds waves at multiple frequencies while measuring the attenuation of the ultrasound, which is then used in calculating the particle size distribution. There is a correlation between the displacement of the sound waves at multiple frequencies with the mean particle size and size distribution. The advantage of this technique is that the particle size measurements can be taken at higher flow rates that are not constrained to the laminar flow regime as is the case with dynamic light scattering. A disadvantage of this technique is that air bubbles may interfere with the particle size measurements.

From a quality perspective, it is useful that the mean particle size and size distribution of the liposomal formulation is within specifications. For example, these specifications could be that the mean particle size diameter is 100 nm±10 nm with a particle size distribution of 25 nm. For both batch and continuous processes, the particle size can be measured during or after processing. However, continuous processing has the advantage in that the particle size measurement can be performed continuously as the liposomes are being formed, and this information can be used to: divert out-of-specification liposomes to waste without compromising the entire unit or batch; and to correct the problem that caused the formation of out-of-specification liposomes. In contrast to the continuous process, the particle size measurement for a batch process would take place once all of the liposomes are formed and consequently failure to meet the particle size specifications would result in removal of the entire batch. In the system described herein, the mean liposome particle size diameter and particle size distribution can be quantitatively monitored during continuous processing and this information can be used in a feedback algorithm to maintain these liposomal quality attributes.

The system may also include a controller (e.g., a microprocessor, FPGA, microcontroller, or the like) configured to (i) determine a difference between a desired size and/or desired size distribution of the liposomes and the determined size and/or size distribution as measured by the particle size analyzer, and (ii) adjust one or more parameters of the system in response to the determined difference. In one example, adjusting one or more parameters of the system comprises adjusting a flow rate at which the aqueous solution is supplied from the vessel to the second inlet of the injection port. In particular, if the system detects that the size of the liposomes formed in the second conduit are smaller than the desired size, the controller may be configured to decrease the flow rate at which the aqueous solution is supplied from the vessel to the second inlet of the injection port. In contrast, if the system detects that the size of the liposomes formed in the second conduit are larger than the desired size, the controller may be configured to increase the flow rate at which the aqueous solution is supplied from the vessel to the second inlet of the injection port.

In another example, adjusting one or more parameters of the system comprises adjusting a lipid concentration of the organic lipid solution supplied from the mixer to the first inlet of the injection port. As discussed above, the organic lipid solution may comprise a mixture from one or more containers. Each of the one or more containers may have a different concentration of lipid dissolved in ethanol. As such, by adjusting the ratio of a solution comprising a combination of fluid from each of the one or more containers, the system may consequently adjust a lipid concentration of a lipid solution provided to the first inlet of the injection port. In particular, if the system detects that the size of the liposomes formed in the second tube are smaller than the desired size, the controller may be configured to increase the lipid concentration of the organic lipid solution supplied from the mixer to the first inlet of the injection port. In contrast, if the system detects that the size of the liposomes formed in the second tube are larger than the desired size, the controller may be configured to decrease the lipid concentration of the organic lipid solution supplied from the mixer to the first inlet of the injection port.

In yet another example, adjusting one or more parameters of the system comprises adjusting a viscosity of the aqueous solution supplied from the vessel to the second inlet of the injection port. In particular, if the system detects that the size of the liposomes formed in the second tube are smaller than the desired size, the controller may be configured to increase the viscosity of the aqueous solution supplied from the vessel to the second inlet of the injection port. In one particular example, this may be accomplished by increasing a percentage of ethanol in the aqueous solution. In contrast, if the system detects that the size of the liposomes formed in the second tube are larger than the desired size, the controller may be configured to decrease the viscosity of the aqueous solution supplied from the vessel to the second inlet of the injection port. In one particular example, this may be accomplished by decreasing a percentage of ethanol in the aqueous solution. Other parameters of the system may be adjusted as well.

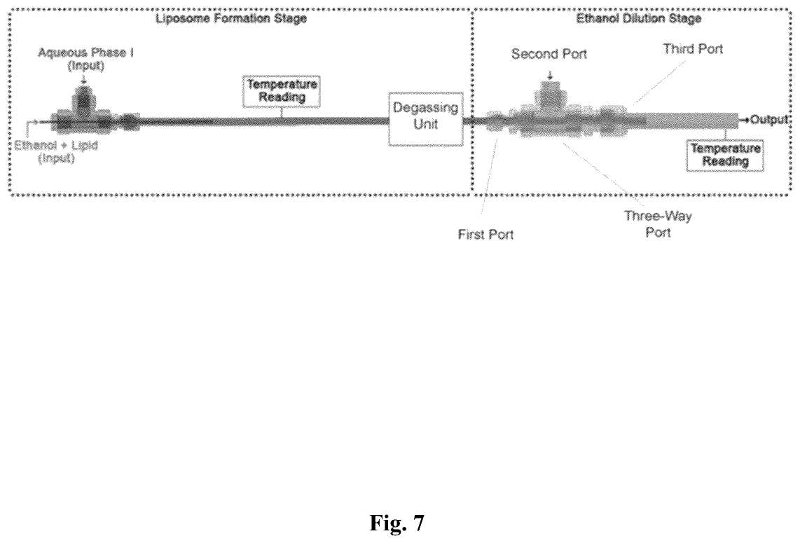

FIG. 7 illustrates a schematic representation of the liposome formation stage followed by an ethanol dilution stage, according to an example embodiment. As shown in FIG. 7, after the liposomes are formed in the second conduit of the injection port, the liposomes may be passed through one or more degassing units. Next, the liposomes may be passed through a three-way port including a first port, a second port, and third port. As shown in FIG. 7, the first port may be in fluid communication with the one or more degassing units, the second port may be in fluid communication with the vessel, and the third port may be an outlet port. In one example, the ethanol dilution stage of the system may further include a gear pump positioned between the vessel and the three-way port.

FIG. 8 illustrates a concentration stage of the continuous liposome manufacturing process, according to an example embodiment. The total lipid concentration is a quality attribute for liposomal drug products. The total lipid concentration may refer to the amount of phospholipid and/or other lipid molecules such as cholesterol that form the liposomal bilayer. The lipid concentration can be used to estimate the amount of liposomal vesicles, which may further be related to either drug encapsulation, i.e. drug molecules in the aqueous compartment of the liposomes, to drug loading or to the intercalation of molecules within the lipid bilayer. In addition, lipid concentration is used to effectively evaluate drug-to-lipid ratios. For example, doxorubicin-to-lipid ratios of 0.3:1 led to an increase in biological activity in mice.

Liposomal lipid concentrations may be toxic depending on the type of lipid in the liposome composition. For example, phosphatidylglycerol and phosphatidylserine liposomes were toxic from 0.13-3.0 mM for some cultured human cell lines whereas dipalmitoylphosphatidylcholine containing liposomes were non-toxic at 4 mM. In addition, certain lipid concentrations may promote cytotoxicity and can be used as a measure to determine drug effects on changes in IC₅₀-values. For example, amphotericin B containing liposomes increased the IC₅₀-value in a macrophage-like cell line (Raw 264.7) when compared to liposomes without amphotericin B. Moreover, macrophage cells are major sites of liposomal accumulation and high lipid concentrations may cause macrophage cells to exhibit phospholipid overload and inhibit phagocytic function.

FDA-approved drug products are formulated with total lipid concentrations ranging from 9.15 mg/mL up to 103 mg/mL, with the majority in the range from 9.15 mg/mL-34.88 mg/mL. This provides a pharmaceutically relevant range of lipid concentrations that are considered safe and effective.

At this stage in the process, the liposomes created in the liposome creation stage are concentrated for further processing and purification. As shown in FIG. 8, the concentration stage is a continuous process using sensors such as an NIR sensor combined with a tangential flow filtration device, a pump and a custom developed computer program that may be used to control the concentration of the final product liposomes. Such an NIR sensor may be a dual channel turbidity sensor using two simultaneous channels, i.e. light absorption and light scattering. The concentration information determined from this stage of the process will be fed back to control when the liposomes pass to a subsequent stage that consists of the addition of molecules to be encapsulated inside the liposomes.

In certain embodiments, such as shown in FIGS. 1-8, one or more components (e.g., injection port, the three-way port, the first conduit, the second conduit, etc.) may be made using an additive-manufacturing process, such as stereolithography. As such, the example injection ports described above may include a variety of materials, including calcium carbonate of poly(dimethylsiloxane) (PDMS), as examples. In such an example, the one or more components described above may represent a module, a segment, or a portion of program code, which includes one or more instructions executable by a processor or computing device for creating such devices using an additive-manufacturing system. The program code may be stored on any type of computer readable medium, for example, such as a storage device including a disk or hard drive. The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage device.

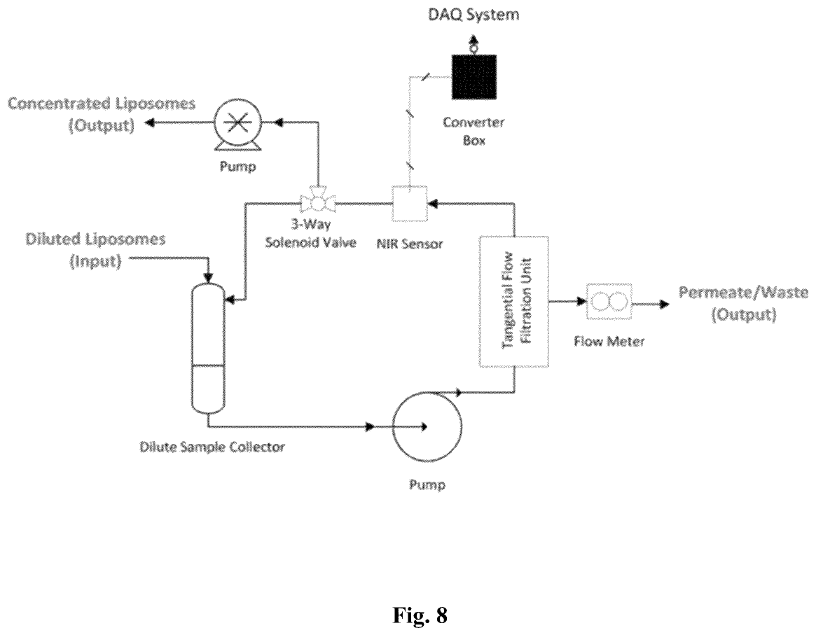

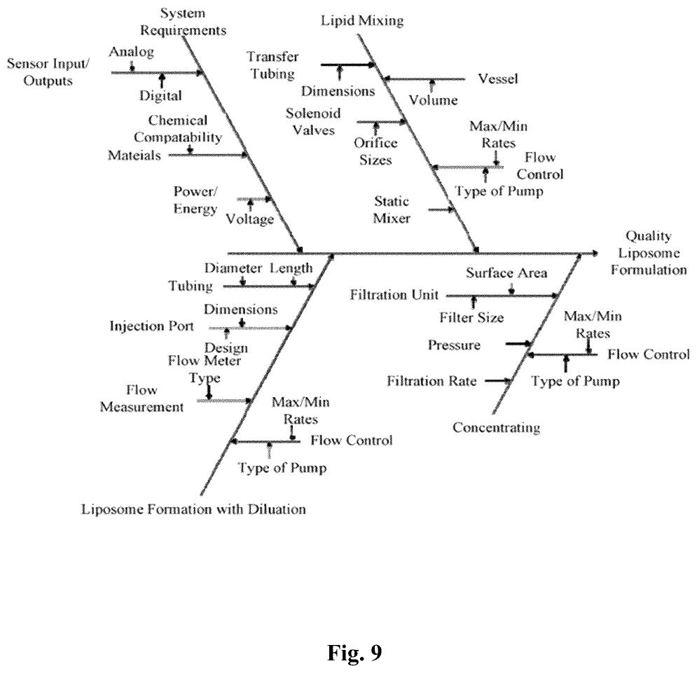

FIG. 9 illustrates is a cause and effect diagram highlighting the main stages of the continuous process with subdivisions for each main stage, according to an example embodiment. FIG. 9 illustrates a cause and effect diagram for the entire process with the single effect of forming a “quality liposome formulation.” For a quality liposome formulation, the process would need to achieve sufficient control (e.g. control of particle size and particle size distribution), be reproducible and accurate, and have the ability to be adaptable to cover formulation changes.

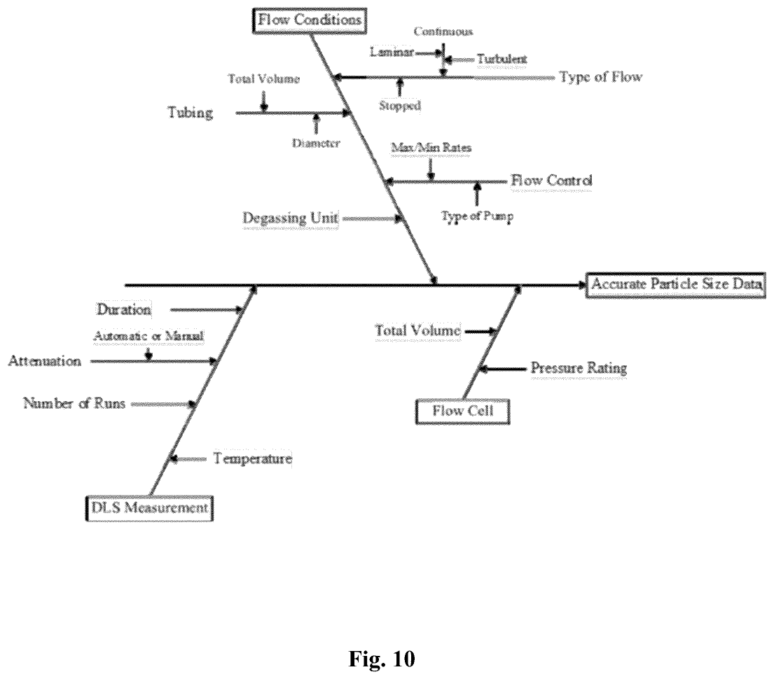

FIG. 10 illustrates a cause and effect diagram outlining variables that result in obtaining accurate particle size data for a continuous process, according to an example embodiment. The effect/outcome of this diagram was the accurate measurement of particle sizing data for a continuous process. The causes were subdivided into flow conditions, flow cell and dynamic light scattering (DLS) measurement. The flow conditions outlined how to control the flow of the sample to the instrument (e.g. pump selection) and flow requirements (e.g. continuous and laminar flow vs. stopped flow). The flow cell has limitations such as the total volume of the flow cell and the pressure rating, which would limit the flow rate of the sample through the flow cell. Lastly, DLS measurement parameters will further impact the accuracy of particle sizing data. These parameters include temperature, measurement duration (e.g. 10 seconds), number of runs per measurement and the attenuation setting. As DLS uses a macroscopic fitting algorithm to determine the particle size, the sample temperature and photon count rate will impact the particle size analysis. For example, if the temperature is set at 25° C., but the sample temperature is actually 22° C., then the measured particle size may be higher than actual since particles move more slowly at lower temperatures than higher temperatures. In this case, the set temperature and the actual sample temperature are preferably similar to achieve accurate results. As a second example, the photon count rate is the rate at which photons are detected. For low count rates, there is not enough information for the macroscopic fitting algorithm to determine the particle size. In addition, at higher count rates, the DLS detector may no longer be operating in a linear range. Therefore, a range of count rates should be determined that provide accurate data.

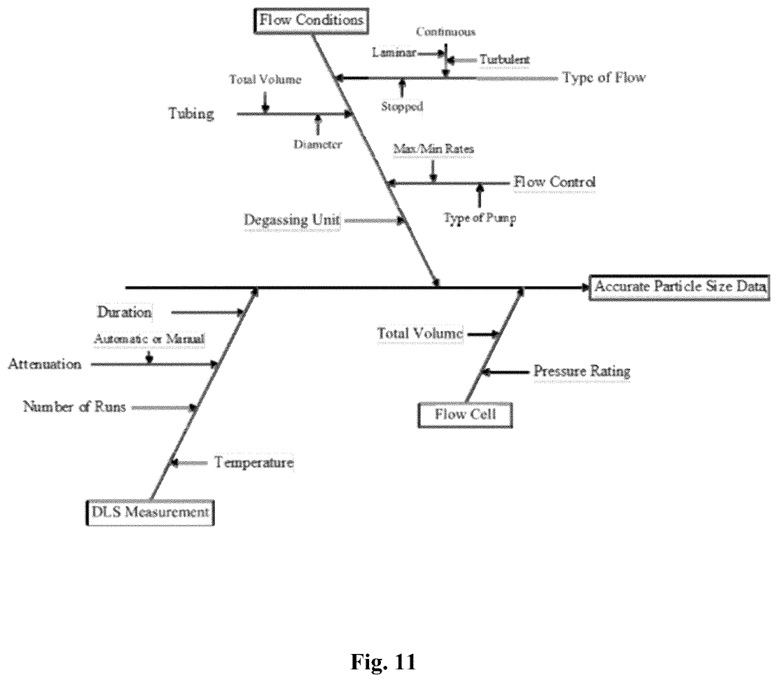

FIG. 11 illustrates a cause and effect diagram outlining variables that affect the lipid concentration detection via an NIR sensor, according to an example embodiment. For instance, there are a two common NIR sensor styles, i.e. a probe design or a flow cell design. The probe design may be more prone to air bubble accumulations at the detection window. In addition, the probe design may have a limited optical path length (e.g. up to only 10 mm), whereas the flow cell design may have longer optical paths (e.g. up to 160 mm). The longer optical path would accommodate samples that scatter a small amount of light (i.e. smaller diameter particles at low concentrations). In addition, NIR probes may be designed at a single wavelength or a band of wavelengths and at various angles of detection. For angles of detection that are 0° from the light source, the measurement is referred to as absorbance and measured in units such as CU. Scattered light may be detected at angles such as 11° or 90°. For the scattered light, the unscattered light is used as a reference to account for changes in the aqueous medium.

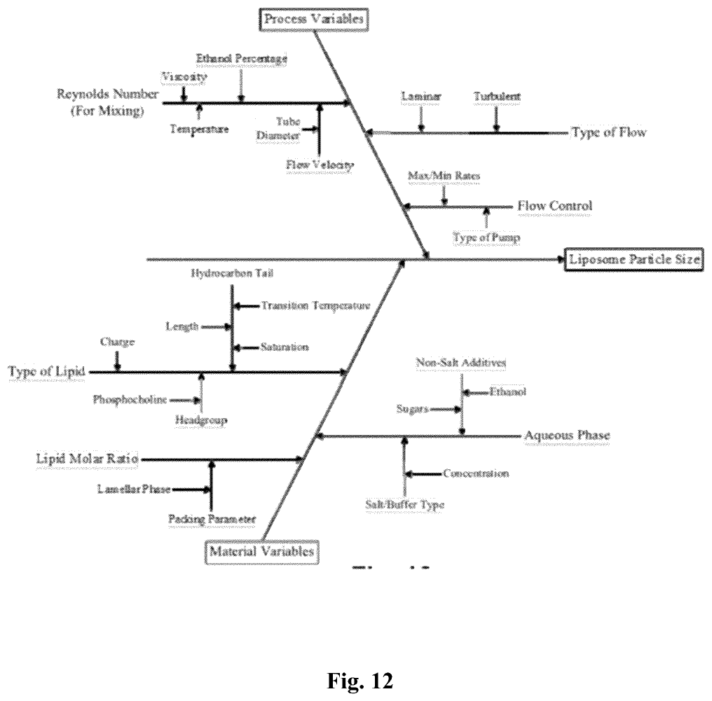

FIG. 12 illustrates a cause and effect diagram outlining variables that affect the liposome formation process with respect to material and process variables, according to an example embodiment. The causes are divided into process variables, material variables and lipid molar ratio. The process variables includes types of flow (e.g. laminar vs. turbulent), type of pump (e.g. pulsatile vs. non-pulsatile) and Reynolds number. The Reynolds number is a means to determine the extent of mixing—with a higher Reynolds number indicating a greater extent of mixing. The Reynolds number is dependent on viscosity, temperature and flow velocities. The material variables are subdivided into type of lipid and aqueous phase. The type of lipid will significantly impact the liposome particle size. For example, each lipid has a transition temperature, which indicates the fluidity of the lipid at a certain temperature. Lipids that may be in the fluid state could possibly form larger liposomes; however, this is not clearly understood at this time. The lipid molar ratio is another cause that my affect the liposome particle size. As many liposomal formulations consist of multiple lipids, the combination of the lipids preferably result in a packing parameter that supports the lamellar structure; otherwise, liposomes will not form. Therefore, the lipid ratio of, for example, cholesterol and other lipids preferably equates to approximately 1 in order to support a lamellar phase-which is the phase that will form liposomes.

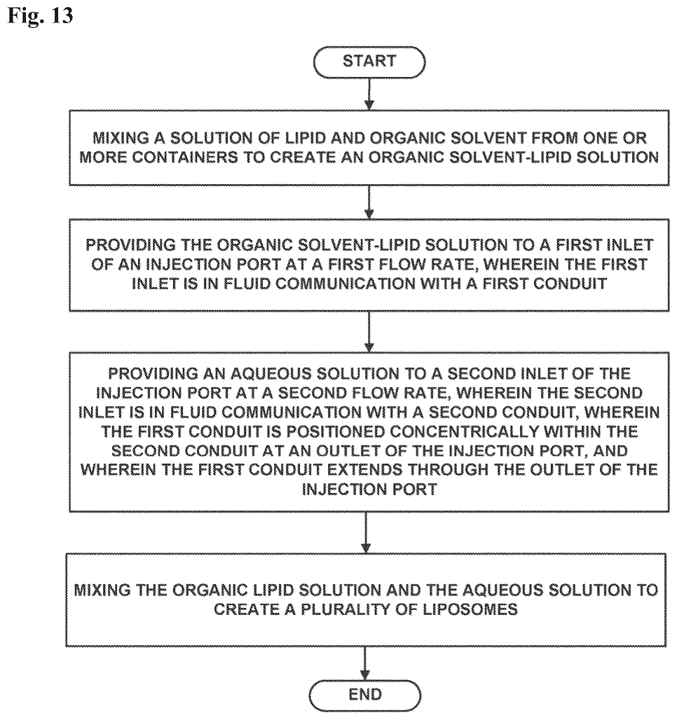

FIG. 13 is a block diagram of an example method for the continuous production of liposomes. The method shown in FIG. 13 presents an embodiment of a method that could be used by one or more of the components described above in relation to FIGS. 1-12. The example method may include one or more operations, functions, or actions as illustrated by the blocks in FIG. 13. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

In addition, for the method and other processes and methods disclosed herein, the block diagram shows functionality and operation of one possible implementation of present embodiments. In this regard, each block may represent a module, a segment, or a portion of program code, which includes one or more instructions executable by a processor or computing device for implementing specific logical functions or steps in the process. The program code may be stored on any type of computer readable medium, for example, such as a storage device including a disk or hard drive. The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage device.

In addition, for the method and other processes and methods disclosed herein, each block in FIG. 13 may represent circuitry that is wired to perform the specific logical functions in the process.

As shown in FIG. 13, one example method for the continuous production of liposomes comprises (a) mixing a solution of lipid and organic solvent from one or more containers to create an organic solvent-lipid solution, (b) providing the organic solvent-lipid solution to a first inlet of an injection port at a first flow rate, wherein the first inlet is in fluid communication with a first conduit, (c) providing an aqueous solution to a second inlet of the injection port at a second flow rate, wherein the second inlet is in fluid communication with a second conduit, wherein the first conduit is positioned concentrically within the second conduit at an outlet of the injection port, and wherein the first conduit extends through the outlet of the injection port, and (d) mixing the organic lipid solution and the aqueous solution to create a plurality of liposomes.

In one example, the first flow rate is between about 5 mL/min and about 40 mL/min, and the second flow rate is between about 70 mL/min and about 300 mL/min. In one example, a first flow of the organic solution through the first tube and a second flow of the aqueous solution through the second tube are under laminar or transitional flow conditions. When the two streams interact, a turbulent mixing patter is formed since the flow rate of each stream is different. In another example, a first flow of the organic solution through the first tube and a second flow of the aqueous solution through the second tube are turbulent flow. Further, in one example the aqueous solution comprises an aqueous-organic solvent mixture, and the plurality of liposomes are unilamellar liposomes.

In another embodiment, the method may further comprise determining a size of one or more of the plurality of liposomes created within the second tube, determining a difference between a desired size of the one or more liposomes and the determined size of the one or more liposomes, and in response to the determined difference, adjusting at least one of the second flow rate and a lipid concentration of the organic lipid solution. In one example, the determining of the size of one or more of the plurality of liposomes is done while the plurality of liposomes move at a constant flow rate. In another example, the determining of the size of one or more of the plurality of liposomes comprises momentarily stopping a pump to prevent fluid flow of the one or more of the plurality of liposomes, determining the size of one or more of the plurality of liposomes while the plurality of liposomes are at rest, and starting the pump to resume fluid flow.

In another embodiment, the method may further comprise determining a size distribution of one or more of the plurality of liposomes created within the second tube, determining a difference between a desired size distribution of the one or more liposomes and the determined size distribution of the one or more liposomes, and in response to the determined difference, adjusting at least one of the second flow rate and a lipid concentration of the organic lipid solution.

In another embodiment, the method may further comprise passing the plurality of liposomes to a degassing unit, passing the plurality of liposomes from the degassing unit to a first port of a three-way port, providing an aqueous buffer to a second port of the three-way port at a third flow rate, and mixing the plurality of liposomes and the aqueous buffer. In such an example, the mixture of the plurality of liposomes and the aqueous buffer have about 5% volume ethanol. Further, in such an example the third flow rate may be between about 300 mL/min and about 10000 mL/min.

In another embodiment, the method may further comprise determining a total lipid concentration of the plurality of liposomes, determining a difference between a desired total lipid concentration of the liposomes and the determined total lipid concentration of the liposomes, and in response to the determined difference, adjusting the second flow rate and/or adjusting a lipid concentration of the organic lipid solution.

In yet another embodiment, the method may further comprise passing the plurality of liposomes to a tangential flow filtration unit, determining a total lipid concentration of the plurality of liposomes, determining a difference between a desired total lipid concentration of the liposomes and the determined total lipid concentration of the liposomes, and in response to the determined difference, adjusting a permeate flow rate of the tangential flow filtration unit and/or adjusting a pressure of the tangential flow filtration unit. In such an example, the total lipid concentration of the plurality of liposomes may be determined via an NIR sensor.

### Example 1

Abbreviations: Reynolds Number—Re; Flow Velocity Ratio—FVR; Dynamic Light Scattering—DLS; Polydispersity Index—PDI; Design of Experiment—DOE; 31 Phosphorous Nuclear Magnetic Resonance—P-NMR; 1,2-dimyristoyl-sn-glycero-3-phosphocholine—DMPC; 1,2-dipalmitoyl-sn-glycero-3-phosphocholine—DPPC; 1,2-distearoyl-sn-glycero-3-phosphocholine—DSPC; 1,2-dipalmitoyl-sn-glycero-3-phospho-(1′-rac-glycerol) (sodium salt)—DPPG; 1,2-dioleoyl-sn-glycero-3-phosphocholine—DOPC; Cholesterol—Chol; Negative Stain Transmission Electron Microscopy—NS-TEM; Cryogenic Transmission Electron Microscopy—Cryo-TEM; National Instruments—NI; International Conference on Harmonisation—ICH; Process Analytical Technology—PAT; Combined Output Flow Rate—Q; Kinematic Viscosity—v; Diameter—D; Outer Diameter—OD; Inner Diameter—ID; Cross—Sectional Area-A;

### Materials and Methods:

Overview of Process with Turbulent Mixer.

Liposomes were prepared by a modified ethanol injection method. A schematic of this system is demonstrated in FIG. 1. Three separate 316 stainless steel tanks were fabricated to house the lipid+ethanol solution. These tanks were pressurized (at typically 20 psi) and the flow rates from these tanks were controlled by analog flow meters (McMillian) and proportioning solenoid valves (Aalborg). The flow meters were factory calibrated for water with less than 1% error. For the lipid+ethanol flow streams, these flow sensors were re-calibrated for ethanol and had an R-squared value of 0.9989, with a working range from 5-50 mL/min. The three tanks were then connected at a single point using a 4-way connector (Swagelok). A static mixer was implemented to ensure that the lipid+ethanol solutions from the three tanks were adequately mixed prior to reaching the injection port where the ethanol and aqueous streams converged. The aqueous phase volumetric flow rate was controlled by a gear pump (Micropump®). The mixed lipid+ethanol solution was then injected into the aqueous phase at various flow rates. The tubing ID of the ethanol phase was 0.508 or 1.016 mm (1.588 mm OD). The aqueous phase tubing ID was fixed at 3.175 or 4.572 mm. Typical flow rates of the lipid+ethanol phase were from 5-40 mL/min and of the aqueous phase were from 60-400 mL/min.

The entire process was controlled by a custom-made program written using National Instruments (NI) LabVIEW® software. A data acquisition system (NI PXIe-1078) was combined with multiple NI modules to accommodate various input/output signals (e.g. analog and digital inputs/outputs, counters, circuit switches, etc.). The entire system was automated and only required the user to define the final lipid concentration and molar ratios of lipid. Process variables such as flow rates, pressure, and temperature were monitored and, for some variables, automatically adjusted using custom computer algorithms. For example, proportional-integral-derivative controls were implemented in the computer program to precisely control the flow rates of both the ethanol and aqueous phases.

### Liposome Preparation.

1,2-dimyristoyl-sn-glycero-3-phosphocholine (DMPC), 1,2-dipalmitoyl-sn-glycero-3-phosphocholine (DPPC), 1,2-distearoyl-sn-glycero-3-phosphocholine (DSPC), 1,2-dipalmitoyl-sn-glycero-3-phospho-(1′-rac-glycerol) (sodium salt) (DPPG) and 1,2-dioleoyl-sn-glycero-3-phosphocholine (DOPC), were purchased from Lipoid™. Cholesterol (Chol) was purchased from Sigma. The lipid (5-30 mM total lipid) was dissolved in ethanol (USP grade) and added to one of the three tanks. To dissolve the lipid in ethanol, the lipid mixture was typically heated to 60° C. for 10 minutes and sonicated for 5 minutes or until all of the lipid was fully dissolved. The ethanol solution was then allowed to reach room temperature (23° C.) prior to running any experiment. In some cases, the entire lipid was combined into a single tank and pure ethanol was added to the other tanks for dilution.

### Dynamic Light Scattering for Particle Size and Zeta-Potential.

Measurements were performed with a Malvern Zetasizer Nano ZS90 for zeta potential and a Malvern Zetasizer Nano S for size. The samples were placed in plastic disposable cuvettes (or a capillary cell for zeta-potential) and equilibrated to 25° C. prior to measurements. Since ethanol was present in the samples, all samples were diluted to 1.64% v/v (ethanol/total solution) and the viscosity and refractive index were adjusted for in the Malvern Zetasizer software. Particle size measurements included the z-average, PDI, volume percentage, intensity mean and intensity width. Zeta potential measurements included zeta-potential and zeta deviation. All measurements were run in triplicate.

### Flow Visualizations.

Nile Red (Sigma-Aldrich®) was used as the dye and was dissolved in ethanol. This solution was added to one of the three pressure tanks. Lipid dissolved in ethanol was added to a second tank. The lipid and Nile Red solutions were run at a 1:1 volumetric ratio under different flow conditions. As Nile Red changes color based on solution polarity, the solution appeared pink in ethanol, pink/orange with lipid dissolved in ethanol and purple/bluish when dissolved or mixed with water without lipid.

### Nanoparticle Tracking Analysis.

Measurements were performed with a Malvern Nanosight™ instrument. The samples were diluted down to 0.05% v/v ethanol. In some cases, additional dilution was necessary to reach acceptable conditions for particle size analysis (e.g. as vesicle diameter decreases, the number of vesicles increased exponentially). As for the measurements, the mean and standard deviation were recorded. All measurements were run in triplicate.

### Negative Stain Transmission Electron Microscopy (NS-TEM).

Liposomes were prepared in 10 mM ammonium acetate-acetic acid buffer at pH 5.00. For each sample, approximately 3 μl of liposomes was placed on a plasma cleaned carbon coated grid (Ted Pella Inc, #01840). After 1 minute incubation, the sample was flooded with several drops of 0.25% of uranyl acetate stain. The excess solution was blotted off and the sample was air dried for approximately 30 minutes. The grid was imaged at 80.0 kV in an FEI Tecnai 12 Biotwin TEM equipped with a LaB6 emitter and an Advanced Microscopy Techniques 2 k XR40 CCD camera. For each sample, 7-10 images were collected and the diameter of more than 500 particles/sample were manually measured using ImageJ. The data was then collected and the mean particle size and standard deviations were determined by fitting a nonlinear analysis using a Gaussian distribution fitting function.

### Cryo-Transmission Electron Microscopy (Cryo-TEM).

Cryo-TEM was performed using cryo-transmission electron microscopy (Jeol 1400 TEM/STEM) operated at 120 kV and viewed under the Minimum Dose System. Briefly, 2 μL of liposome sample was placed on a glow-discharged Holey carbon copper grid (Quantifoil R 2/1). Using a grid plunge freezer (Leica EM GP) at 25° C. and 82% humidity, samples were blotted automatically for 2 s to remove excess liquid and plunged into a bath of liquid ethane at −175° C. The samples were stored in liquid nitrogen until they were transferred to a cryo-TEM holder (Gatan 914) and observed in the pre-cooled cryo-TEM at 120 kV under Minimum Dose System. Images were recorded with a digital CCD Camera (Gatan ORIUS™ SC1000) at magnification of 10000×-20,000×.

### Design of Experiment Study.

A design of experiment was performed to analyze the lipid concentration and aqueous phase flow rates on liposome particle size. The aqueous phase flow rate range was designed to cover a broad range of flow conditions that led to low and high Reynolds Numbers. In addition, these flow rates cover the full range of the system processing capabilities (i.e. pump flow rate working range). Lipid Concentrations studied were based on reported lipid wt % that would possibly lead to the formation of liposomes. A custom 2×4 full factorial design with 5 center-points, and 3 repeats was chosen as the initial design (FIG. 2). This design was chosen to support interaction and higher order terms as well as stay within constraints on the final ethanol percentage. The original design was augmented to increase the design space and to increase the statistical significance of the model (FIG. 2). With respect to model analysis, the r-squared term, analysis of variance (p<0.05) and lack of fit p-value (p>>0.05) were used to determine adequate fitting and the inclusion of model interaction terms. Only the Malvern Zetasizer Nano S was used to determine the particle size and PDI for this study. The model design and analysis was conducted using JMP by SAS.

### Reynolds Number and Flow Velocity Ratio Calculations.

The Reynolds number (Re) is defined as Re=QD/vA, where Q is the combined output flow rate, v is the kinematic viscosity of the mixture, D is the diameter of the output tube and A is the cross-sectional area of the output tube. The kinematic viscosity was calculated for the final ethanol-water mixture based on reported dynamic viscosity and density values. An equation was created using JMP by SAS to predict the kinematic viscosity with dependence on ethanol mole fraction and the output temperature. As the enthalpy of mixing for water and ethanol mixtures is exothermic, the final output temperature varied from the initial temperatures of both phases (i.e. 23° C.) up to ˜32° C. These temperatures were recorded for the various flow conditions and were used in the Re calculation. The flow velocity ratio (FVR) is FVR=vᵢ/vₒ, where vᵢ is the inner tube velocity and vₒ is the outer tube velocity. Both velocities are calculated directly from the volumetric flow rates and the geometry of the tube. For the outer tube velocity calculation, the inner tube outer diameter was subtracted from the outer tube inner diameter.

### Results:

### Mixing of Ethanol and Aqueous Phase

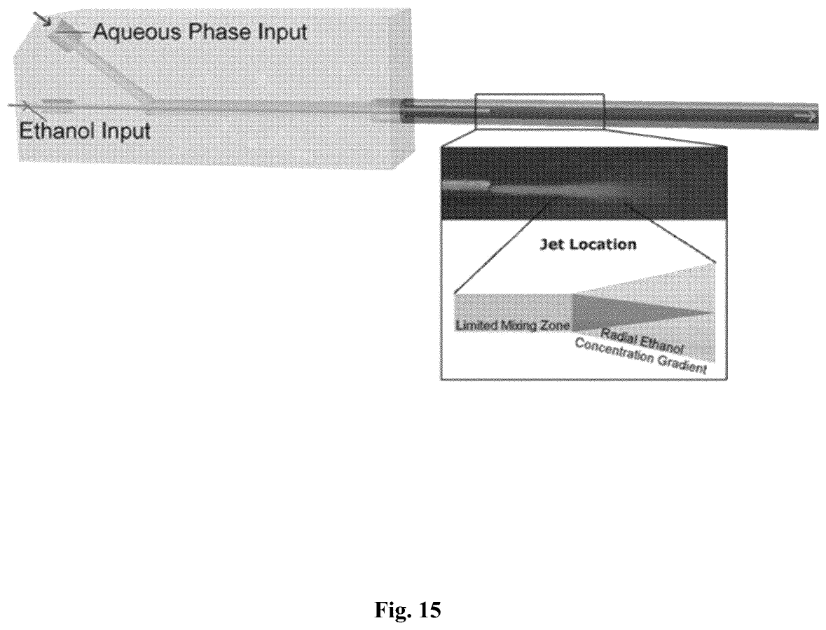

An injection port was fabricated to accommodate the formation of a coaxial turbulent jet in co-flow. A cylindrical tube (first conduit) designed to carry the ethanol phase was positioned concentrically within second or outer cylindrical tube (FIG. 15). The second cylindrical tube (second conduit) carries the aqueous phase prior to jet formation. There are three criteria useful to achieve suitable conditions for a stable turbulent jet. The first is that all flow rates may be pulseless to reduce flow rate fluctuations to negligible levels. The second two criteria come from non-dimensional values of fluid dynamics: (1) Reynolds number (Re) and (2) flow velocity ratio (FVR). The Re is that of the mixed ethanol/aqueous flow stream just downstream of the “jet location” and will subsequently be referred to as the Reₘᵢₓₜᵤᵣₑ.

### Relationship Between Fluid Flow Properties and Liposomal Polydispersity Index

The fluid flow properties of the injection port were related to the liposome polydispersity index. Liposomes were analyzed using dynamic light scattering (DLS) and a polydispersity index (PDI) of 0.10 was considered as the upper limit for monodispersity. The ethanol flow rate ranged from 5-40 mL/min and the aqueous phase flow rate ranged from 70-400 mL/min. The organic phase consisted of DPPC:DPPG:Chol (4.5:0.4:3 molar ratio) dissolved in ethanol and the aqueous phase was 10 mM phosphate buffer, pH 7.4. The inner tube diameter was 0.508 mm or 1.016 mm. The outer tube diameter was 3.175 mm or 4.572 mm. In addition, the maximum final ethanol percentage was chosen to be less than 40% v/v ethanol to reduce the possibility of forming any non-liposomal structures. For this lipid formulation, the average zeta-potential was-39.4±6.34 mV (averaged for all samples).

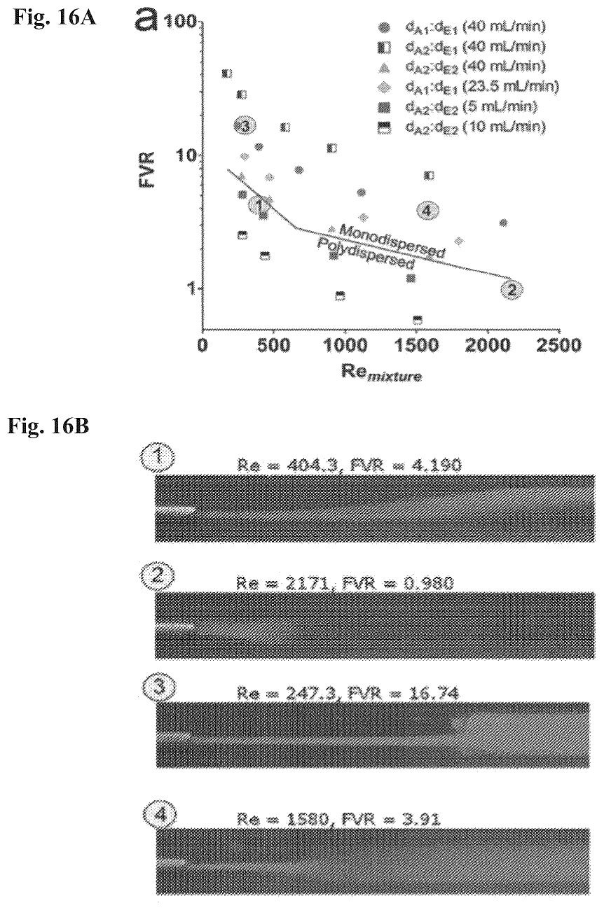

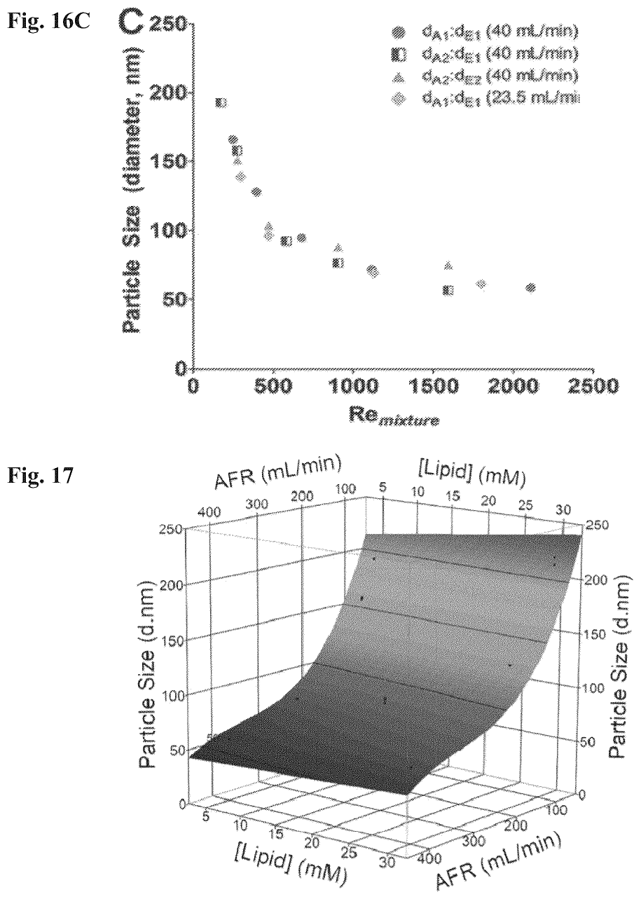

The flow rates were transformed to Reₘᵢₓₜᵤᵣₑ and FVR as outlined in the methods section. To achieve various Reₘᵢₓₜᵤᵣₑ and FVR combinations, different inner and outer tube diameters were investigated. From FIG. 16A, it is clear that in order to achieve a monodispersed system, certain Reₘᵢₓₜᵤᵣₑ and FVR combinations are useful to form a stable jet. FIG. 16B depicts the fluid profiles of four locations on the FVR vs. Reₘᵢₓₜᵤᵣₑ plot from FIG. 16A. At a Reₘᵢₓₜᵤᵣₑ<500 and FVR<7, a stratified flow is observed with the lipid+ethanol staying separated and moving to the top of the tubing (FIG. 16A-1). Limited mixing occurs in this case and the actual lipid mixing/liposome formation would occur downstream (i.e. possibly in the collection vessel)—leading to polydispersed liposomes. At FVR≤2 and Reₘᵢₓₜᵤᵣₑ>˜500, a weak jet forms and this also leads to polydispersed liposomes (FIG. 16B-2). The other two flow conditions depicted lead to rapid mixing downstream of the injection site and stable jet formation, resulting in monodispersed liposomes (FIG. 16B-3 and FIG. 16B-4). In the case monodispersed liposomes, it is evident that liposome formation is dependent on mixing and can be predicted by the Reₘᵢₓₜᵤᵣₑ (FIG. 16C). At a high FVR (i.e. ≥7), the liposome particle size is monodispersed and independent of FVR and only changes according to the Reₘᵢₓₜᵤᵣₑ. The latter case outlines that monodispersed liposomes may be formed under a variety of injection port dimensions that lead to the same FVR and Reₘᵢₓₜᵤᵣₑ conditions.

Design of Experiment: Lipid Concentration Vs. Particle Size

A design of experiment (DOE) study was completed to demonstrate the effects of the injected lipid concentration on liposomal particle size for a monodispersed population of liposomes. The ethanol flow rate was fixed at 40 mL/min as this flow rate corresponding to a flow region that produces monodispersed particles (FIG. 16A). The dimensions of the injection port were fixed at an aqueous phase tubing ID of 3.175 mm and an ethanol phase tubing ID of 0.508 mm. For the DOE study, the factors included: (1) aqueous phase flow rate (70-400 mL/min) and (2) injected lipid concentration (5-30 mM). The aqueous phase was 10 mM phosphate buffer. The lipid composition was fixed at DPPC:DPPG:Chol (4.5:0.4:3 molar ratio). The DOE model has a R²-value of the actual vs. predicted values of 0.985, an analysis of variance p-value <0.0001 and a lack-of-fit p-value=0.331 (Table 1). The surface profile for this study demonstrates the dependence of the mean particle size on the aqueous phase flow rate (FIG. 17). For this formulation, the smallest liposomes appeared around 58 nm and the largest around 240 nm. The PDI value averaged 0.05±0.04 for all experiments, and only started to reach 0.10 at the lower aqueous phase flow rates (e.g. 70 mL/min). Thus, the liposomes could be considered monodispersed over the entire range of flow rates studied. The lipid concentration had a modest positive impact on the particle size. It was apparent that the aqueous phase flow rate interaction terms were dominant in controlling the z-average liposome particle size.

### Types of Lipid on Liposome Particle Size

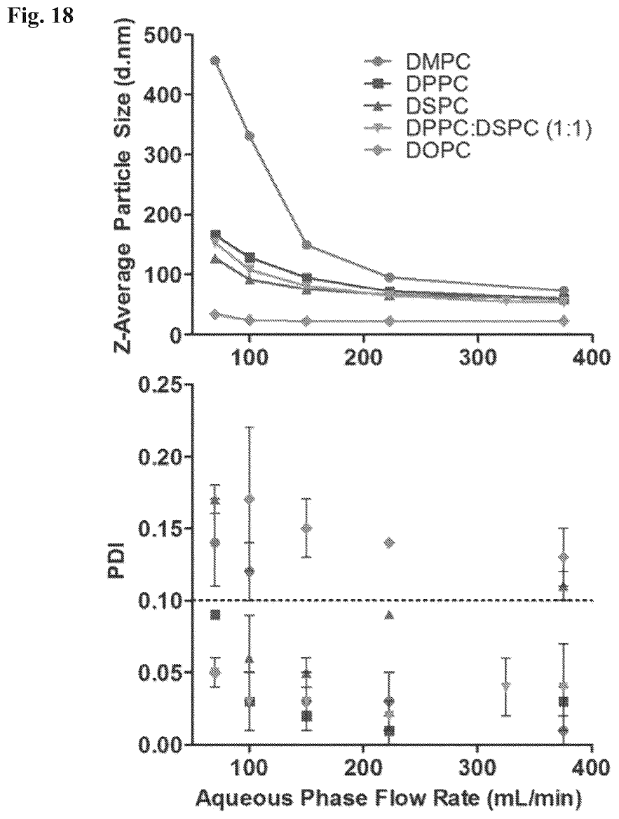

From the results above, it is evident that the Reₘᵢₓₜᵤᵣₑ and lipid concentration may play a role in controlling liposome particle size. To determine whether lipid characteristics affect liposome particle size, four different lipid molecules were investigated, namely DOPC, DMPC, DPPC, DSPC and a mixture of DPPC:DSPC (1:1 molar ratio). Each formulation also contained cholesterol and DPPG. The molar ratio was held constant for lipid:DPPG:Chol (4.5:0.4:3.0) and 5 mM total lipid was dissolved in the ethanol phase. The z-average particle size and PDI values are plotted (FIG. 18). It is clear that the lipid molecule significantly altered the liposome particle size. Liposomes with a mean particle size were controllably formed from approximately 25 nm up to 465 nm and the maximum PDI value was equal to 0.18; however, the PDI was ≤0.05 for the majority of the samples (FIG. 18).

### Aqueous Phase Additives on Liposome Particle Size

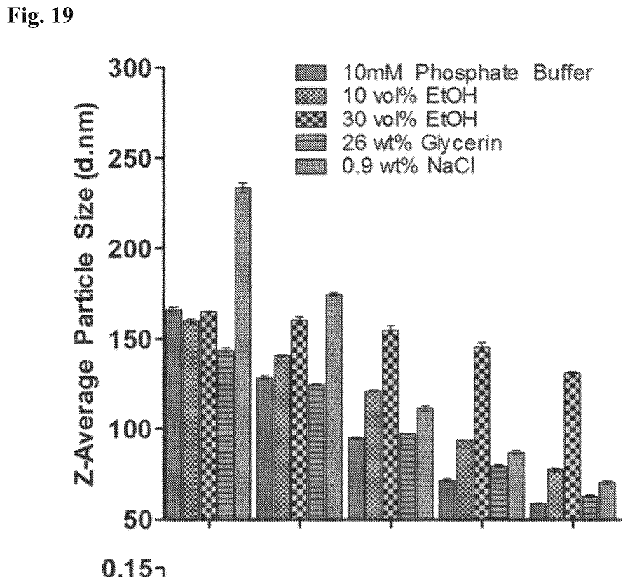

Additives to the aqueous phase were used to determine any impact on liposome formation. For this study, the lipid formulation was kept constant at DPPC:DPPG:Chol (4.5:0.4:3 molar ratio, 5 mM lipid injected) and all samples contained 10 mM phosphate buffer, pH 7.4. NaCl; glycerol; and ethanol were investigated as additives (FIG. 19). Liposomes prepared in 10 mM phosphate buffer with no additive was used as a control. For all flow conditions, the formulation containing 26 wt % glycerol was the most similar to the control. The addition of 10-30% v/v ethanol to the aqueous phase increased the particle size under most flow conditions. The 30% v/v ethanol addition caused the liposomes to be linearly dependent on the aqueous phase flow rate. The addition of 0.9 wt % NaCl dramatically increased the mean particle size under all conditions compared to the control.

### Comparison of Particle Size and Size Distribution Using Multiple Measurement Techniques

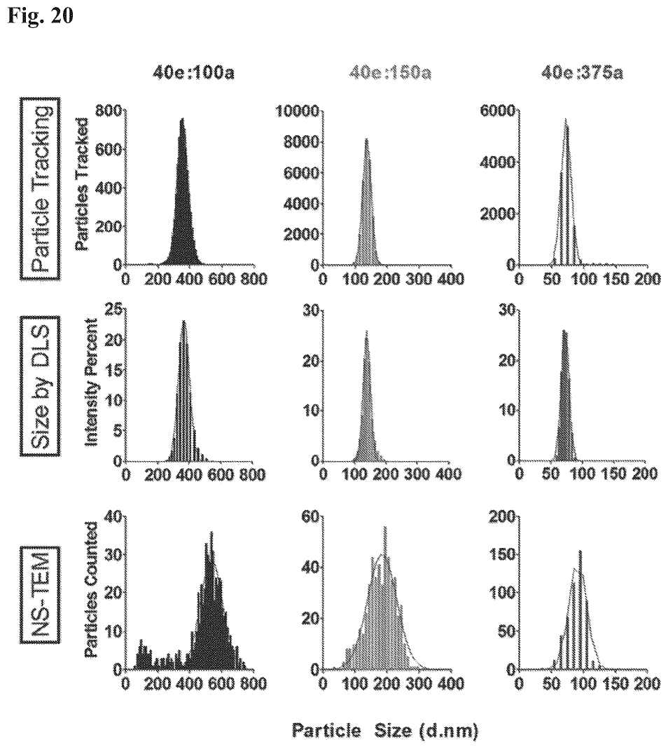

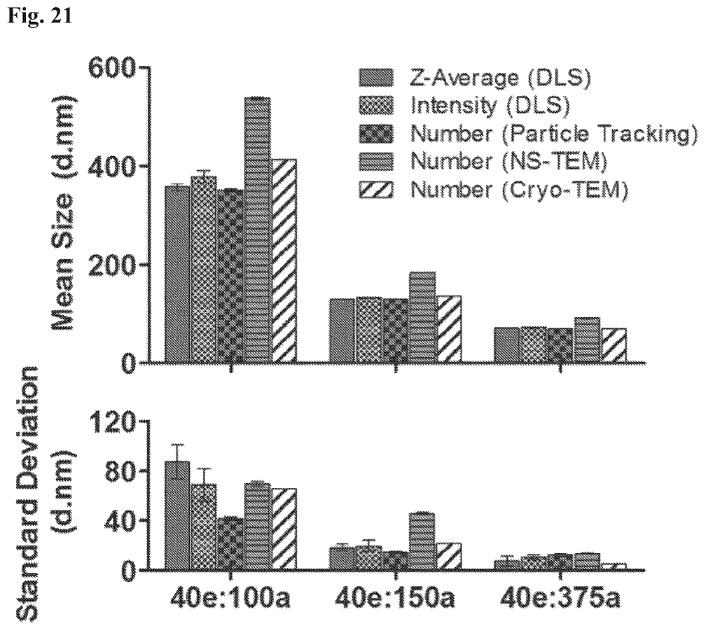

To accurately assess the mean particle size and particle size distribution, multiple techniques (i.e. dynamic light scattering, nanoparticle tracking and negative stain TEM) were used. Each of the three techniques can be used to determine the mean particle size and particle size distribution; however, each technique differs fundamentally. Dynamic light scattering is an intensity-based measurement, while nanoparticle tracking and negative stain TEM are number-based. Therefore, it is not desired to compare absolute values from each technique, but instead to compare trends and conclude if monomodal populations of particles are present. Samples were prepared in 10 mM ammonium-acetate-acetic acid buffer at pH=5.0 to reduce artifacts in the negative staining procedure. The lipid composition for this study was DMPC:Chol:DPPG (4.5:3.0:0.4 molar ratio) and 15 mM lipid was injected into the aqueous phase. Three samples were prepared at a constant ethanol flow rate (40 ml/min) but at different aqueous phase flow rates (i.e. 100, 150 and 375 ml/min). The three samples were chosen as they were estimated to produce liposomes with a mean particle size around 350, 140 and 70 nm, respectively (FIG. 18). FIG. 20 displays the mean particle size data from the three separate techniques. It is clear that nanoparticle tracking and dynamic light scattering display a monodispersed population. Negative staining produces an overall wider distribution of particles and possibly smaller particles present in the larger-sized liposome sample. However, the negative stain TEM results may not adequately represent the liposome population due to a low number count and multiple artifacts that can occur during sample preparation. FIG. 21 is a plot of the mean particle size and the standard deviation for each sample and technique. It was demonstrated that the mean particle size trend is the same using all three particle sizing techniques, i.e. for an increase in aqueous flow rates (higher Reₘᵢₓₜᵤᵣₑ), the particle size decreases. For all three samples and each particle size analysis technique, the standard deviations were 15.8±4.70% of the mean.

### Negative Stain TEM Micrographs of Liposomes

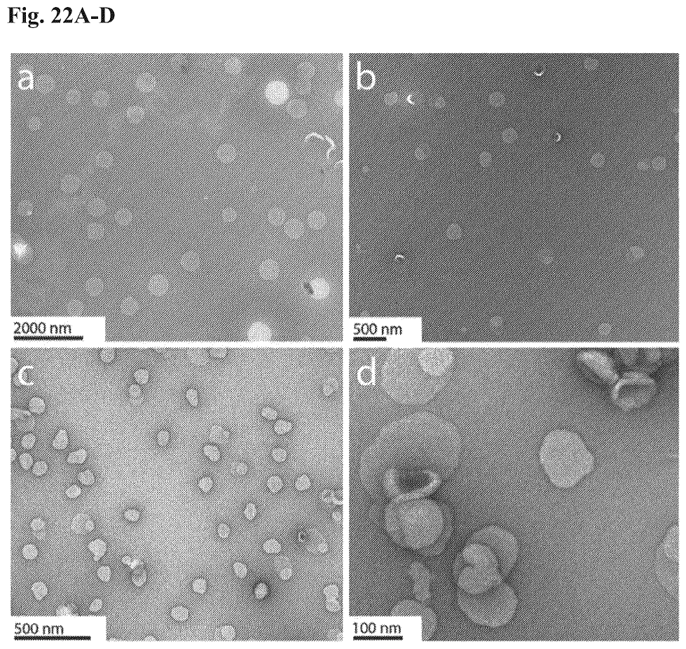

FIGS. 22A-C are micrographs of the three different samples outlined above (FIG. 20) from the particle size technique analysis. The micrographs demonstrate particle size differences between samples. Each sample set appears to be monodispersed. FIG. 22D demonstrates how liposomes are affected by the staining process. It appears that the liposomes are in one of three possible states: (1) “partially-hydrated” liposomes (these liposomes appear to be dehydrated, but partially retain the structure as in the hydrated state); (2) flattened-stacked bilayers; or (3) mixture of a flattened-stacked bilayer and/or single bilayer. The “partially-hydrated” liposomes have an appearance of dehydrated liposomes and have more uniform size, while the “flattened” states vary in size. This apparent size variation (that results from the processing required for this technique) can explain why the mean particle size and size distribution are overall greater from the NS-TEM micrographs compared to the other particle size analysis techniques.

### Cryo-TEM Micrographs of Liposomes

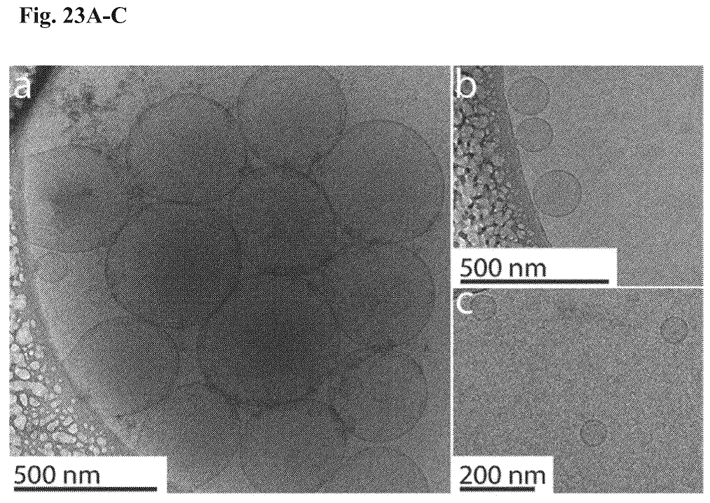

The micrographs from FIG. 23A-C are of the three different samples outlined above in FIG. 20 and FIG. 22. These micrographs confirm the particle size trend stated previously and that these liposomes are unilamellar. Comparing the visible black band of each liposome, the thickness of the band is very similar for the small to the large liposomes.

### Liposome Monodispersity Via a Coaxial Turbulent Jet

Flow conditions, characterized by the FVR and the Reₘᵢₓₜᵤᵣₑ, lead to either polydispersed or monodispersed liposomes (FIG. 16A). Polydispersed liposomes were formed under two different flow conditions—i.e. an apparent stratified flow (FIG. 16B-1) and a weak jet (FIG. 16B-2). The stratified flow led to stream separation and uncontrolled mixing. The weak jet appeared to develop vortices that led to backflow along the jet—also resulting in uncontrolled mixing.

In order to achieve monodispersed liposomes, the formation of a jet was employed (FIG. 15). Depending on the flow conditions, it appeared that there was the coexistence of a laminar/transitional flow followed by a jet that led to turbulent flow (FIG. 16B-3 and FIG. 16B-4). It does not appear that the aqueous phase significantly dilutes the ethanol phase in this laminar/transitional flow region; otherwise, a color change in the fluorescent marker (Nile Red) would be observed due to the change in fluid polarity. Accordingly, it may be stated that limited mixing occurs throughout the laminar/transition region. For the formation of a jet, it has been shown that the center velocity decreases and the jet boundary spreads radially, resulting in a concentration gradient of the injected phase (in this case, lipid+ethanol). Therefore, the majority of mixing occurs where the center velocity decreases and jet boundary spreads radially. As the spreading of the lipid+ethanol phase establishes a radial concentration gradient, it is proposed here that this promotes the controlled formation of monodispersed liposomes. Moreover, convective inertial forces are dominant compared to viscous forces when Re>>1, which supports the reasoning that increasing Re will correspond to an increase in the extent of mixing, thus forming different sized liposomes.

For the formation of monodispersed liposomes, it is evident that Reₘᵢₓₜᵤᵣₑ is directly related to the liposome particle size. In addition, above a FVR of approximately 7, liposome formation is independent of FVR and dependent only on the Reₘᵢₓₜᵤᵣₑ. This observation is made by comparing FIG. 16A with FIG. 16C, where the liposomes formed at the same Reₘᵢₓₜᵤᵣₑ have a similar particle size, regardless of the FVR. This indicates that liposome formation from a turbulent jet may be a predominately a convective process and occurs at the radial spreading in the turbulent region of the jet.

Considering the phospholipid formulation as well as the Reₘᵢₓₜᵤᵣₑ and FVR, the formulations containing DSPC, DPPC and DMPC formed mostly monodispersed liposomes (for an FVR≥7). Some polydispersity was evident at lower aqueous flow rates and may have been due to higher ethanol percentages destabilizing the liposomes. However, the formulation containing DOPC formed only monodispersed liposomes at the lower aqueous flow rates. For DOPC, a higher Reₘᵢₓₜᵤᵣₑ appears to destabilize the formulation, which could be due to the high curvature of the small particles (˜25 nm) and/or the low phase transition temperature of DOPC-making the fluid bilayer more susceptible to fusion at ambient temperature conditions.

### Liposome Formation Model Using a Coaxial Turbulent Jet

The injection of lipid dissolved in ethanol into an aqueous phase is further complicated by changes in properties such as viscosity, density, molar volume, heat of mixing (exothermic in this case), lipid solubility, and lipid structure (e.g. lipid molecular volume). It does not appear that any property above is solely related to the observed particle size changes of liposomes. By using the Reₘᵢₓₜᵤᵣₑ, the following terms are taken into account: viscosity, density and sensible heat gains.

The exact mechanism of how liposomes form is still elusive; however, a detailed model for the liposome formation process is beginning to emerge through experimental findings. Initial work in this field has outlined that bilayered phospholipid fragments (BPF) form and fuse together as the volume percentage of ethanol decreases. For a turbulent jet, a model based on the formation and subsequent fusion of BPF resulting in monodispersed liposomes leads to some doubt. During the centerline velocity dissipation of a jet, multiple vortices form and subsequently shear off. Since this process is turbulent, vortices of different sizes would develop and the mixing in these micro-environments would appear to be heterogeneous. Consequently, BPFs that fused during this process would only form polydispersed particles.

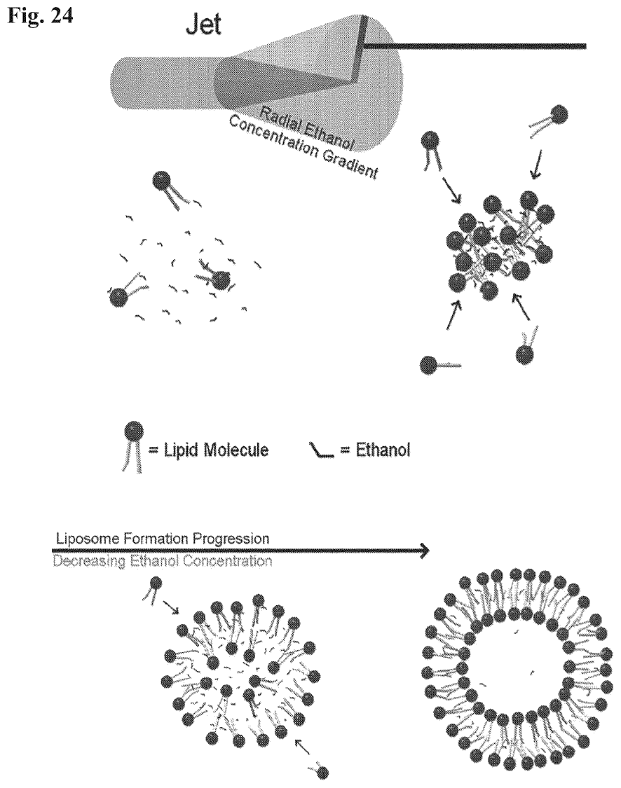

A new model for liposome formation is proposed in FIG. 24. This model is based on the growth of a highly fluid lipid/ethanol aggregate (denoted here as a pro-liposome). Initially, lipid is dissolved in ethanol forming a solution. As outlined above, the ethanol spreads radially at the jet location resulting in a concentration gradient. At this point, water mixes with the ethanol+lipid phase and pro-liposomes begin to grow in size until a critical solubility is reached (˜50-60% v/v ethanol). The final liposome size is then dependent on the following factors: (1) ethanol diffusion out of the pro-liposome, (2) pro-liposome fluidity, (3) lipid packing, (4) pro-liposome surface charge and (5) lipid concentration.

Ethanol diffusion out of the pro-liposomes is exemplified by the addition of excess ethanol to the aqueous phase. Ethanol is known to be able to cross the lipid bilayer, i.e. move from the aqueous phase into one bilayer leaflet and cross from one leaflet to the other. In addition, P-NMR studies have confirmed that ethanol causes the liposome bilayer to become less packed. Comparing 10-30% v/v excess ethanol to 0% v/v excess ethanol in the aqueous phase, ethanol diffusion out of the pro-liposome would be slower during the mixing process and consequently the bilayer would have higher permeability due to the larger amount of ethanol. Accordingly, there would be more time and space for lipid molecules to enter the pro-liposome-thus growing in size. Moreover, the addition of 26 wt % glycerin to the aqueous phase did not cause any major change in particle size, which indicates that the increased bulk viscosity is less essential compared to ethanol diffusion out of the pro-liposome and convective forces.

The lipid phase transition is useful in assessing the fluidity of the pro-liposome. The phase transition temperatures of the phospholipids in this study are ranked in the following order: DSPC>DPPC>DMPC>DOPC (highest to lowest). By comparing only the saturated phospholipids, DSPC is the most ordered while DMPC is the most fluid over the temperature range caused by exothermic mixing in these experiments (i.e. 23-32° C.). It appears that liposomes form when lipid molecules are in the fluid/disordered state rather than the gel/ordered state. For example, DPPC:DPPG (7.5:0.4 molar ratio) formed a viscous, gel-like structure instead of liposomes at a 5 mM lipid injection (data not shown). It should be noted that adding cholesterol increases the fluidity/disorder of the lipid membrane; thus, making it is possible to form liposomes at temperatures below the lipid phase transition temperature of the corresponding pure lipid. A more ordered structure would prevent lipid molecules from entering the pro-liposome-resulting in smaller liposomes. This reasoning explains why liposomes form in the following order of smallest to largest (DSPC<DPPC<DMPC). A more detailed analysis that includes the impact of temperature, cholesterol percentage and charged lipid percentage may be useful to thoroughly explain the above observation.

Changes in lipid packing are exemplified by DOPC, which adds an additional complexity in that this lipid is unsaturated (i.e. it has a double bond in each hydrocarbon tail). The geometric packing parameter of DOPC is =1.08 and, when mixed with other lipids, may support a geometrically smaller sized particle (i.e. as low as 25 nm in diameter). In comparison, DSPC, DPPC, and DMPC lipid molecules have a packing parameter ˜1 and are more cylindrical in shape. Thus, these DOPC liposomes can support higher curvature/smaller sized liposomes than DSPC even though the phase transition temperature of DOPC was much lower relative to the experimental conditions. Moreover, the more cylindrical shape of DSPC, DPPC and DMPC may explain why these liposomes appear to plateau at a mean particle size of ˜60-70 nm at a high Reₘᵢₓₜᵤᵣₑ. This indicates that the overall lipid packing of the lipid mixture is a geometric constraint on the liposome particle size.

In the case of the surface charge, the addition of salt to the aqueous phase (e.g. 0.9 wt % NaCl) would lower the surface charge of the pro-liposome and lessen the electrostatic repulsion between the pro-liposome and the individual lipid molecules. This reduced repulsion would allow more lipid molecules to enter the pro-liposomes, thus increasing the final liposome size.

Lastly, the lipid concentration led to a modest increase in liposome particle size. This increase in size further supports the pro-liposome model as more lipid molecules would be recruited into the pro-liposomes. It should be noted that only 5-30 mM lipid was injected, which is a relatively small amount of lipid compared to the other components in the system. Therefore, increasing the lipid concentration would be expected to increase the number of liposomes instead of proportionally increasing the size of the liposomes. Moreover, too high of an injection lipid concentration may cause other types of structures to form (e.g. stacked bilayers) and increased polydispersity.

Overall, the pro-liposome model appears to provide a clearer explanation on the liposome formation process using a turbulent jet. From the above discussion, Reₘᵢₓₜᵤᵣₑ can be used to predict the liposome particle size for a fixed set of factors (i.e. lipid type, lipid concentration, aqueous phase additives, etc.), but will not predict particle size when changing these factors.

### Particle Size Analysis Using Multiple Measurement Techniques

Dynamic light scattering is a suitable technique to determine monodispersity by analyzing multiple parameters. These parameters include the z-average, intensity mean, volume percentage and the PDI. The z-average is calculated from a cumulants analysis (an intensity-weighted fitting algorithm) and the intensity mean is determined directly by an intensity fitting algorithm. When both the z-average and intensity mean values are very similar, it indicates that a single population is present. In addition, a volume percentage of 100% further points to a monodispersed system since transforming the data from intensity to volume shifts the emphasis away from the mean particle size. A volume percentage other than 100% may indicate the presence of additional populations of particles. However, there was an initial uncertainty in relying only on dynamic light scattering without comparing to other techniques, as the light intensity of any larger particles will overshadow the light intensity of smaller particles. This overshadowing may prevent the smaller particles from being detected, even when transforming the raw intensity data to a volume measurement.

Comparing nanoparticle tracking and dynamic light scattering, both techniques appeared to show similar results with respect to mean particle size and size distribution. Since both of these techniques determine the particle size using completely different methods (i.e. individually tracking particles vs. fitting functions), the agreement in mean size and size distribution greatly supports that this liposome processing technique has the ability to controllably produce a large size range of monodispersed liposomes.

The NS-TEM micrographs were originally obtained as a way to characterize the liposomes and possibly make visible smaller particle populations that dynamic light scattering might have failed to detect. After analyzing the TEM images, it was not possible to determine an accurate mean diameter or particle size distribution. One reason is due to the processing conditions apparently causing multiple states of liposomes present (i.e. partially-hydrated to flattened stacked bilayers). A second reason is that what appears to be small particles may actually be fragments of larger particles. These possible fragments may explain why the nanoparticle tracking analysis via Nanosight, which analyzed 30,000-90,000 particles per sample, did not show a wider particle distribution and a possible second population of particles in the 40e:100a sample (FIG. 20).

Lastly, the cryo-TEM micrographs further confirmed the mean particle size trend observed using the three particle size analysis techniques outlined above. The advantage of cryo-TEM over NS-TEM is that the samples were controllably frozen to prevent ice-crystal damage and the liposomes were imaged in a more native state. In addition, these micrographs confirmed that the liposomes are unilamellar.

A turbulent jet mixer can be used to form unilamellar, monodispersed liposomes with a known particle size. The unilamellar, monodispersed particles have a mean size anywhere from ˜25 nm to >465 nm. The liposome mean particle size is highly dependent on the Reₘᵢₓₜᵤᵣₑ and is independent of the flow velocity ratios. The monodispersity and mean particle size trend of the liposomes was analyzed using three fundamentally different particle size analysis techniques. Dynamic light scattering and nanoparticle tracking demonstrated that the liposomes were monodispersed and increased in size with a decrease in Reₘᵢₓₜᵤᵣₑ. Lastly, a new model outlining the liposome formation process is explained via a pro-liposome growth model that takes into account aqueous phase additives, types of lipid molecules, and lipid concentration.

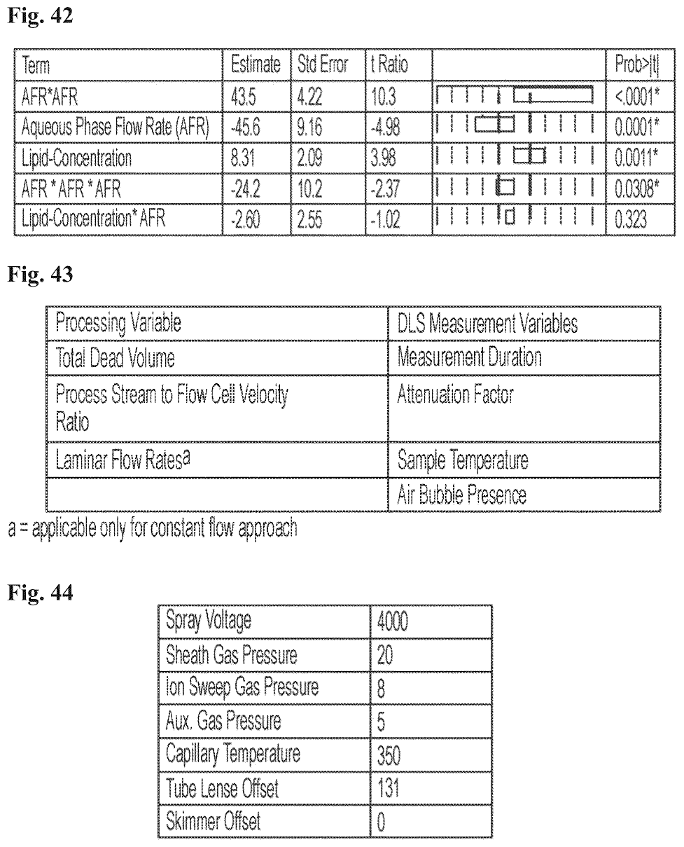

FIG. 42 illustrates a table showing DOE on lipid concentration vs. particle size-model parameter estimates sorted by statistical significance.

### Example 2

### Materials and Methods:

Materials: 1,2-dimyristoyl-sn-glycero-3-phosphocholine (DMPC); 1,2-dipalmitoyl-sn-glycero-3-phosphocholine (DPPC); 1,2-distearoyl-sn-glycero-3-phosphocholine (DSPC); 1,2-dipalmitoyl-sn-glycero-3-phospho-(1′-rac-glycerol, sodium salt) (DPPG-Na); and Lipoid S PC-3 (HSPC) were purchased from Lipoid™. Cholesterol (Chol) was purchased from Sigma. Ethanol (200 proof, ACS/USP grade) was purchased from Pharmco-AAPER.

### Experimental Methods:

Liposome Formation and Dilution. Liposomes were prepared by a modified ethanol injection method. A schematic of this system is demonstrated in FIG. 7. Three separate 316 stainless steel tanks contained the lipid+ethanol solution. These tanks were pressurized (at 20 psi) and the flow rates from these tanks were controlled by analog flow meters (McMillian) and proportioning solenoid valves (Aalborg). The flow meters were factory calibrated for water with less than 1% error full-scale. For the lipid+ethanol flow streams, these flow sensors were re-calibrated for ethanol and had an R-squared value of 0.9989, with a working range from 5-50 mL/min. The three tanks were then connected at a single point using a 4-way connector (Swagelok). A static mixer was implemented to ensure that the lipid+ethanol solutions from the three tanks were adequately mixed prior to reaching the injection port where the ethanol and aqueous phase I streams converged. The aqueous phase I volumetric flow rate was controlled by a gear pump (Micropump®). To form liposomes, the mixed lipid+ethanol solution was then injected into an aqueous phase (aqueous phase I) at various flow rates. The tubing ID of the ethanol phase was 0.508 mm (1.588 mm OD). The aqueous phase I tubing ID was fixed at 4.572 mm. Flow rates of the lipid+ethanol phase ranged from 5-40 mL/min and those of the aqueous phase I ranged from 70-300 mL/min.

After the liposomes were formed, the liposomes passed through a degassing unit (Liqui-Cel) followed by a second three-way T-port. This three-way T-port has one inlet for the liposomes, a second inlet for aqueous buffer and one outlet. A second gear pump (Micropump®) was used to control the flow of the aqueous phase into this port (aqueous phase II). The aqueous phase II flow rate was adjusted such that mixed aqueous phase would have 5% vol. ethanol. Aqueous phase II flow rates ranged from 690-460 mL/min.

### Data Acquisition System and Computer Software.

The entire process was controlled by a custom-made program written using National Instruments (NI) LabVIEW® software. A data acquisition system (NI PXIe-1078) was combined with multiple NI modules to accommodate various input/output signals (e.g. analog and digital inputs/outputs, counters, circuit switches, etc.). The entire system was automated and only required the user to define the final lipid concentration and molar ratios of lipid. Process variables such as flow rates, pressure, and temperature were monitored and some variables were automatically adjusted using custom computer algorithms. For example, proportional-integral-derivative controls were implemented in the computer program to precisely control the flow rates of both the ethanol and aqueous phases.

Communication to and from the Malvern Zetasizer was accomplished using the Malvern Link II software. Malvern Link II software was setup as an OPC server and NI LabVIEW was setup as an OPC client. The z-average particle size and PDI were recorded in the custom computer program. The custom computer program was able to send measurement instructions to the Malvern Zetasizer.

### Experimental Outline for Liposomal Dilution

The impact of diluting liposomes was tested for liposome formulations consisting of lipid:DPPG:Chol at a molar ratio of 4.5:0.4:3, where lipid was either DPPC or DMPC. These lipids were chosen since each lipid was previously investigated and they produced liposomes of different sizes, i.e. up to ˜500 nm for DMPC vs. up to 150 nm for DPPC. Two processing setups were investigated for the in-line dilution of liposomes. The first processing setup (setup I) was injecting the formed liposomes directly into the aqueous phase II (without the degassing unit in FIG. 7). The second processing setup (setup II) consisted of incorporating a contactor (degassing unit) at the end of the liposome formation stage prior to the ethanol dilution stage (FIG. 7). For each processing setup, aqueous phase I flow rates ranging from 70 mL/min to 300 mL/min were tested. The aqueous phase used in this experiment was 10 mM phosphate buffer at pH=7.4. Each sample was analyzed for mean particle size and polydispersity index.

### Temperature Effects on Liposome Formation and Dilution

For the sample liposomal formulations outlined below, these formulations were tested using the second processing setup over a range of temperatures. A chiller was connected to a custom designed heat sink and the aqueous phase I was chilled in-line to a set temperature (e.g. 8° C.). The flow rate of the aqueous phase I was fixed at 100 mL/min. The temperature at the liposome formation stage was recorded in addition to the temperature of the aqueous phase II. Each sample was analyzed for mean particle size and polydispersity index.

### Particle Size Measurements

All particle size measurements were performed with a Malvern Zetasizer Nano S. Both off-line and at-line measurements were completed. Prior to measurements, the liposomes were diluted in-line to 5% vol. ethanol and the viscosity and refractive index were pre-set in the Malvern Zetasizer software. Particle size measurements included the z-average particle size and polydispersity index (PDI). For the off-line measurements, disposable plastic cuvettes were used. The samples were equilibrated at 25° C. prior to each measurement. Each off-line measurement duration was set for 10 runs at 10 seconds each with n=3.

For at-line measurements, a flow cell equilibrated at 25° C. was used. Prior to running at-line measurements, a population of liposomes with a low PDI was analyzed for various measurement conditions (i.e. attenuation, run duration, and count rate). Based on these results, the run duration was fixed (between 6-8 seconds) and the attenuation (and count rate) were adjusted to a satisfactory signal for DLS analysis. Two approaches were taken to transfer sample to the Malvern Zetasizer. The first approach (Continuous Flow Mode) was when the liposomes flowed at a constant flow rate 1-1.5 ml/min through the flow cell while the particle size measurement was taken. The setup for this approach consisted of a miniature solenoid pump (Biochem™) that pumped the sample from the process stream to the Malvern Zetasizer. This pump operates by pumping 70 uL for each actuation and by controlling the actuation frequency, precise flow rates can be maintained.

The second approach (Load/Stop Mode) was based on loading the flow cell followed by stopping the flow prior to the measurement. A Micropump® pump was used to control the flow through the flow cell (20-25 mL/min). The pump operated at the set flow rate just prior to particle size measurements, at which point a custom computer algorithm then stopped the pump to prevent fluid flow during the measurements.

### Automatic Particle Size Control

A liposome formulation consisting of HSPC:Chol:DPPG (4.5:3:0.4 molar ratio) was used to form the liposomes. The particle size was automatically controlled via the custom Lab VIEW program. Initially, a model was established as a feed forward control using information such as salt concentration and type of lipid to reach a user defined particle size. This feed forward control provided an estimate of the aqueous phase I flow rate (ml/min) required to form liposomes of the user defined particle size. To maintain the particle size, a feedback algorithm was implemented using a proportional-integral-derivative (PID) control with the at-line particle size analysis via the Malvern Zetasizer as the process control input.

### Effect of Degassing Unit Prior to Ethanol Dilution

After the liposomes were formed, the liposomal dispersion was diluted to reach 5% vol. ethanol. The liposomes were diluted using the following two processing setups outline in the methods, namely: (1) setup I: without the degassing unit and (2) setup II: with the degassing unit. For DPPC liposomes, the addition of a degassing unit did not cause any major changes in the mean particle size nor the PDI value over the entire flow rate range. For DMPC liposomes, the degassing unit only appeared to cause changes at the lower aqueous phase I flow rate (i.e. 70 mL/min). At 70 mL/min, the mean particle size was larger and the PDI was lower compared to DMPC liposomes without the degassing unit. These results indicate that a larger dynamic range of particles that are more monodispersed are only obtained when the degassing units is positioned at the end of the liposome formation stage.

### Temperature Effects on Liposome Formation and Dilution

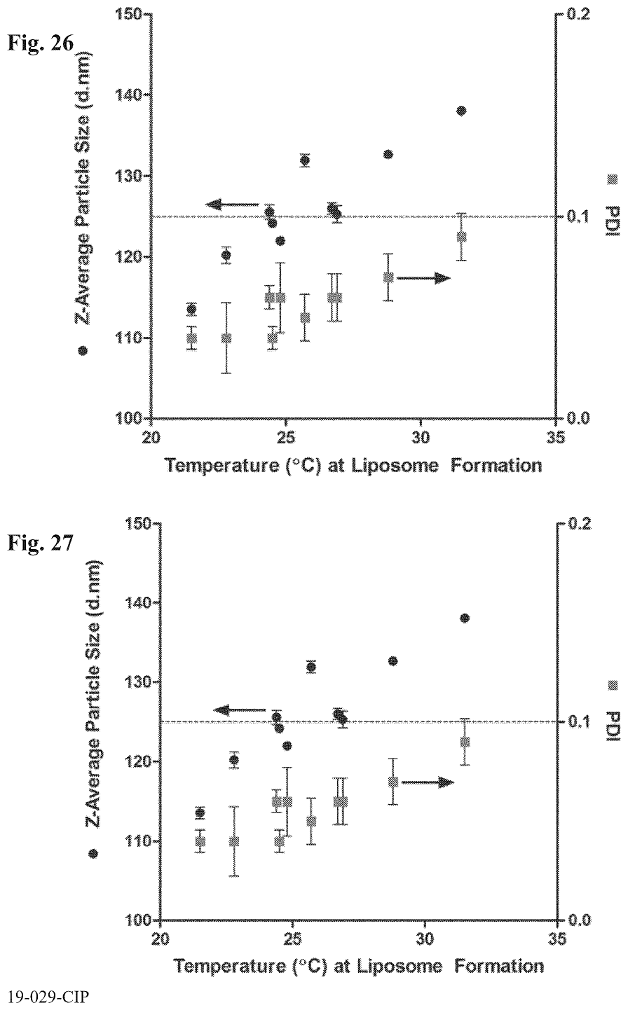

For these experiments, the temperature of the aqueous phase I and aqueous phase II were the same. When the ethanol and lipid phase was injected into the aqueous phase I, exothermic mixing caused an increase in temperature. The mean particle size and PDI for the DPPC liposomes exhibited an inverse relationship with an increase in temperature at the liposome formation stage (FIG. 26). This observation implies that at higher temperatures, larger liposomes form; however, at higher temperatures, the PDI also tends to increase. For DPPC liposomes, the PDI value did not exceed 0.1 even at the highest temperature, indicating that all of the liposomes, regardless of the temperature at liposome formation, were monodispersed.

Sizing data for DMPC liposomes also demonstrated an inverse relationship with an increase in temperature at the liposome formation stage (FIG. 27); however, significant changes in both the PDI and mean particle size occurred around 25° C. As the temperature increased from 24° C., the PDI increased from less than 0.09±0.02 up to 0.24±0.02. This change in PDI indicates that the particle size distribution was wider and/or multiple populations of liposomes were present as the temperature increased. In addition, the mean particle size of the liposomes increased significantly from 26° C. up to 29° C., i.e. from 171.1±1.7 nm to 333.5±4.03 nm.

### DLS Measurement Analysis

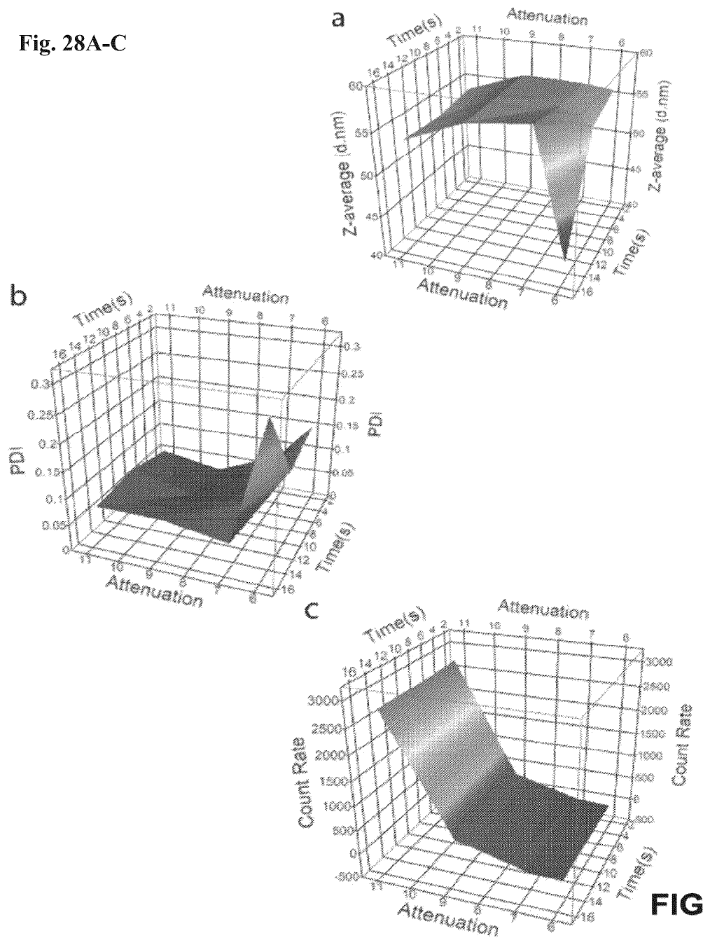

A previously prepared sample of liposomes was placed in the DLS flow cell and the DLS attenuation and cell position settings were set to automatic. These settings resulted in an optimized attenuation setting of 9 and a cell position of 4.2—with the run duration fixed at 3 runs for 10 seconds each. The particle size information resulted in a z-average of 56.50±0.03 nm, a PDI of 0.05±0.02 and a count rate of 401.4±2.77. Manual measurements were then taken at different attenuations (6, 7, 9 and 11) and run durations (3, 9, or 15 seconds) for a single run only. The plots from FIGS. 28A-C indicate how changing the DLS measurement settings impact the particle size analysis. From FIG. 28A, the z-average for this sample was most accurate at an attenuation of 7-9. At a higher value (i.e. 11), the particle size decreased. The PDI was similar to the control sample at the high attenuation (FIG. 28B). At a low attenuation (i.e. 6), the particle size was incorrect due to a very low count rate (FIG. 28C). In addition, the PDI increased significantly for this measurement. From these results, it is apparent that the count rate should be around or greater than 40 kcps and less than 500-1000 kcps for accurate particle size analysis. Lastly, the run duration did not appear to cause significant changes to the particle size analysis. However, a higher value would increase the number of photons collected and would provide a more accurate particle size analysis.

### At-Line Particle Size Analysis—Approach 1: Continuous Flow Mode

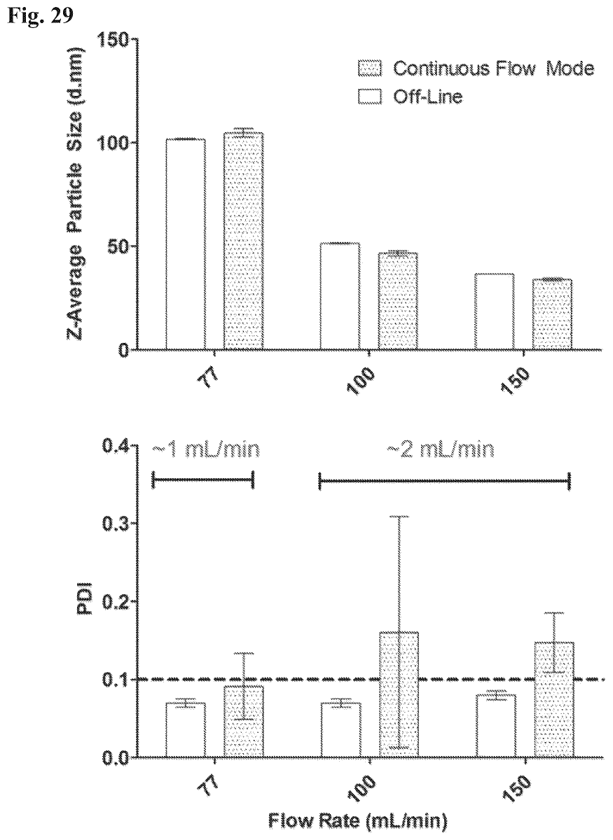

The at-line particle size analysis via the continuous-flow mode was accomplished using a micro-solenoid pump that pumped the liposome samples at a constant flow rate (referred to as DLS flow rate) through the DLS flow cell during the particle size measurement. An initial study was conducted to determine DLS flow rates that resulted in similar particle size data to that obtained using off-line measurements. Liposomes composed of DPPC:Chol:DPPG (4.5:3:0.4 molar ratio) were formed at three aqueous phase flow rates (i.e. 80, 100 and 150 mL/min). The at-line particle size measurements were compared with the off-line particle size measurements. From FIG. 29, the mean particle size was similar for both the continuous flow mode and the off-line measurements at the three different aqueous phase I flow rates and for DLS flow rates at ˜1 and 2 mL/min. To the contrary, the PDI was only similar when the DLS flow rate was around 1 mL/min. At 2 mL/min in the continuous flow mode, the standard deviations and mean PDI were larger when compared to the off-line measurements. Therefore, the subsequent experiments for the continuous flow mode operated with a DLS flow rate around 1 mL/min.

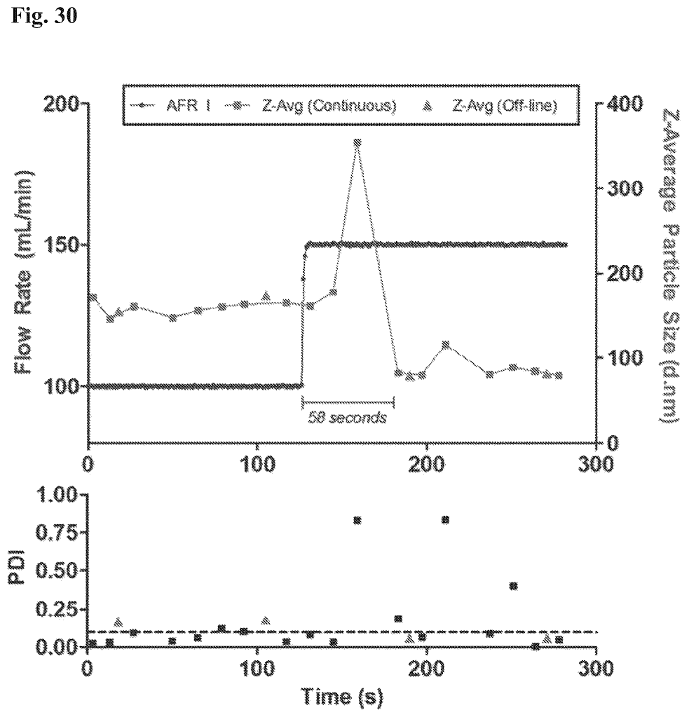

Liposomes were then analyzed over a period of time to investigate how process changes (i.e. flow rate changes) impacted the mean particle size and PDI with respect to both accuracy and measurement lag time. Measurement lag time is the difference in time between a process change to the corresponding particle size data that is recorded in the custom software. This lag time is from the DLS measurement (e.g. run duration and temperature equilibration), delays in software/instrument communication and time required to remove the previous sample in the DLS flow cell. The liposomal samples from FIG. 30 were run at 1 mL/min and showed agreement between some of the continuous particle size data and the off-line data. The mean particle sizes and PDI values for both continuous and off-line measurements were similar except for after the flow rate change. These anomalies may be explained by air bubbles entering the flow cell. In addition, there was a 58 second delay between the process changes to when the corresponding particle size data was recorded in the custom LabVIEW program.

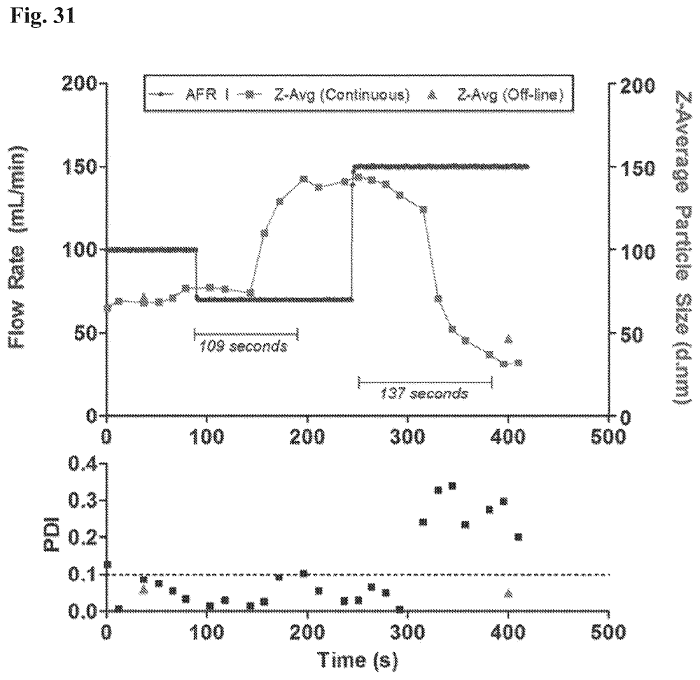

A second analysis was conducted using for DPPC:Chol:DPPG (4.5:3:0.4 molar ratio) liposomes in 10 mM Hepes buffer (FIG. 31). For this experiment, the liposomes flowed through a degassing unit prior to entering the DLS flow cell. The off-line particle size measurement data at the 100 mL/min aqueous 1 phase overlapped the continuous measurement data. At 150 mL/min, the particles became smaller (i.e. approximately 45 nm) and the particle measurement data for the off-line and continuous measurements did not correspond. The mean particle size was different by 15 nm and the continuous mode PDI ranged from 0.20-0.33, but was 0.05 for the off-line measurement. In addition, the measurement lag time was from 109-137 seconds.

### Approach 2: Load/Stop Mode

For this approach, the liposomes were loaded into the flow cell at 20-25 mL/min prior to the DLS measurement. At 1-2 seconds before the DLS measurement, the flow was stopped. After the DLS measurement was completed, the flow began again and this process repeated for the duration of the experiments. The experiments here were designed to accommodate small and large liposomes using the same lipid formulation, i.e. DPPC:Chol:DPPG (4.5:3:0.4 molar ratio).

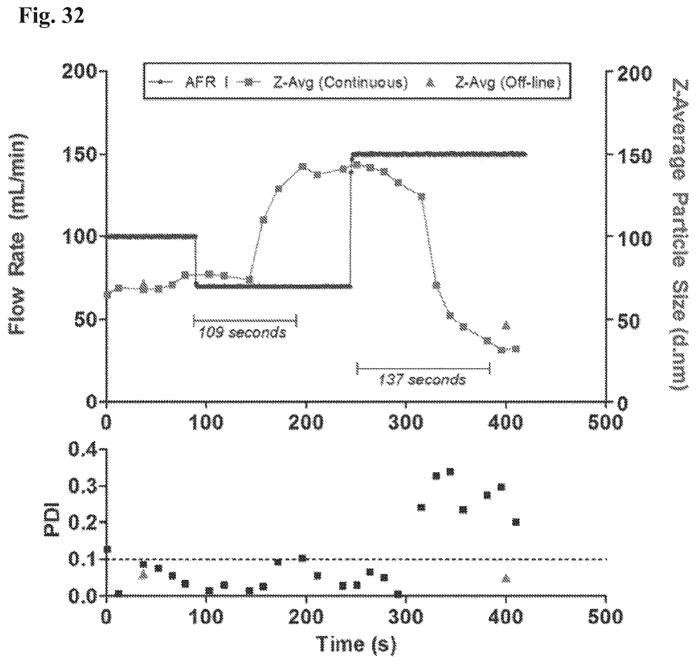

To achieve different sizes, three different aqueous phases were investigated, i.e. 10 mM NaCl, 75 mM NaCl and 140 mM NaCl. Liposomes prepared in 10 mM NaCl formed liposomes ranging from approximately 70 nm down to 45 nm in diameter (FIG. 32). Slight deviations for the continuous particle size and off-line particle size were observed. The PDI was similar and less than 0.2 in all cases. The measurement lag time appeared to be consistent around 40-47 seconds. Process temperatures at both liposome formation and at the ethanol dilution stage were recorded as both of these temperatures have an impact on the mean particle size and PDI.

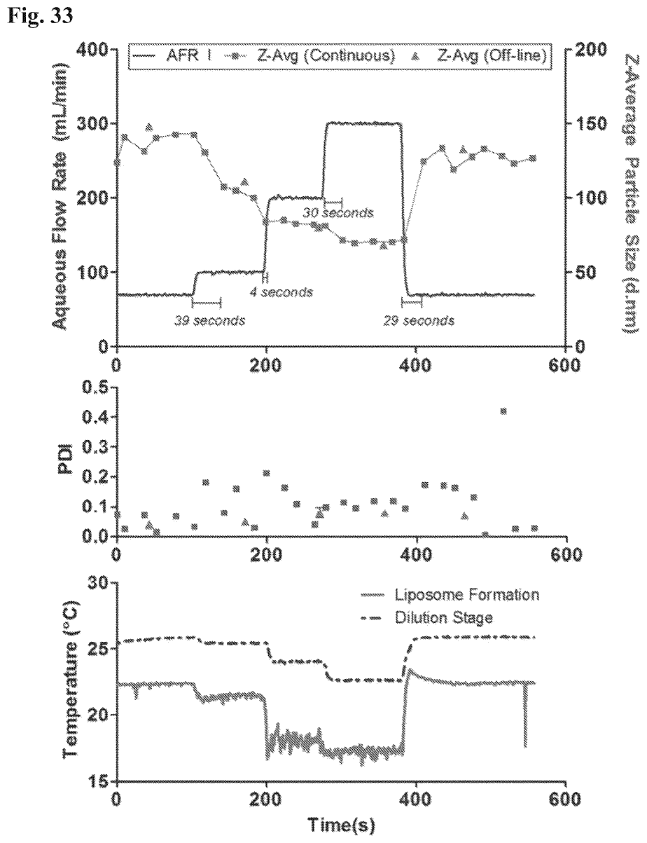

Liposomes prepared in 75 mM NaCl formed liposomes ranging from approximately 145 nm down to 70 nm in diameter (FIG. 33). The mean particle size for the continuous and the off-line measurements overlapped for the majority of each flow condition. The same observation was true for the PDI values. The measurement lag time appeared to vary from 4-39 seconds; however, the 4 second may have been an anomaly. More accurately, the lag time appears to be constant around 29-39 seconds.

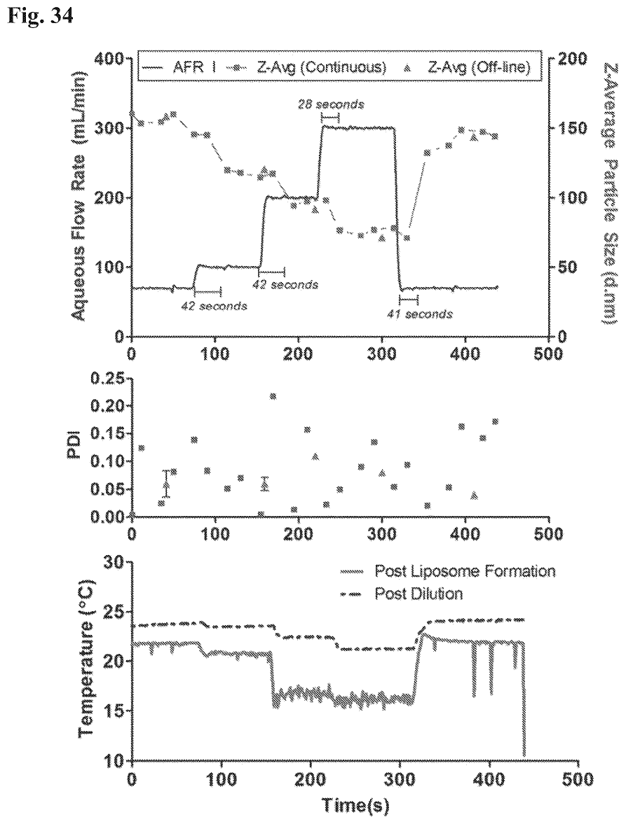

Liposomes prepared in 140 mM NaCl formed liposomes ranging from approximately 160 nm down to 70 nm in diameter (FIG. 34). The mean particle size for the continuous and the off-line measurements also overlapped for the majority of each flow condition. The same observation was true for the PDI values. The measurement lag time was from 28-42 seconds, consistent with the previous two salt conditions.

### Ionic Strength on Liposomal Physical Properties

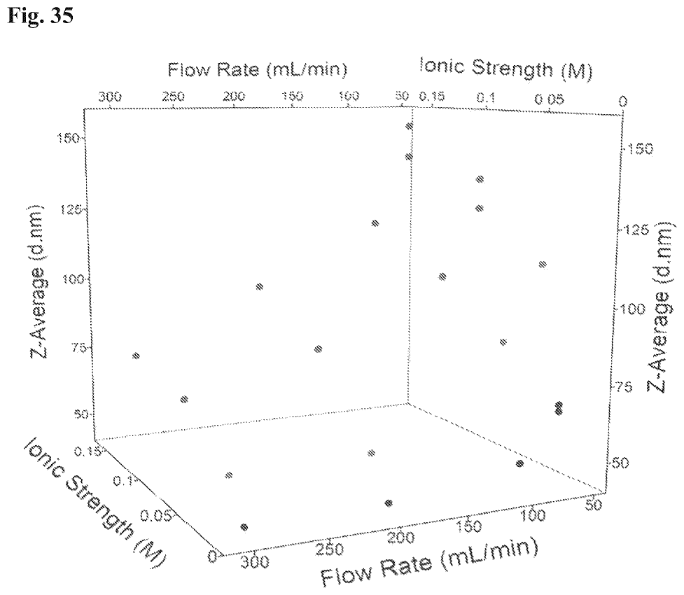

The off-line particle size data from FIGS. 32-34 were replotted vs. flow rate (FIG. 35). It is clear that the mean particle size has a dependence on the amount of NaCl present in the aqueous phase. At low salt concentrations, i.e. 10 mM NaCl and 10 mM PB, pH 7.4, the particles were smaller compared to higher salt concentrations. There was not a large difference between the liposomes prepared in 75 mM NaCl and 140 mM NaCl. Thus, the NaCl concentration appears to have more of an impact on the particle size in between 10 to 75 mM NaCl. The 10 mM phosphate buffer had an ionic strength of 0.025 M, and the liposomes that formed under this condition had a mean particle size that was in between the 10 mM NaCl and 75 mM NaCl.

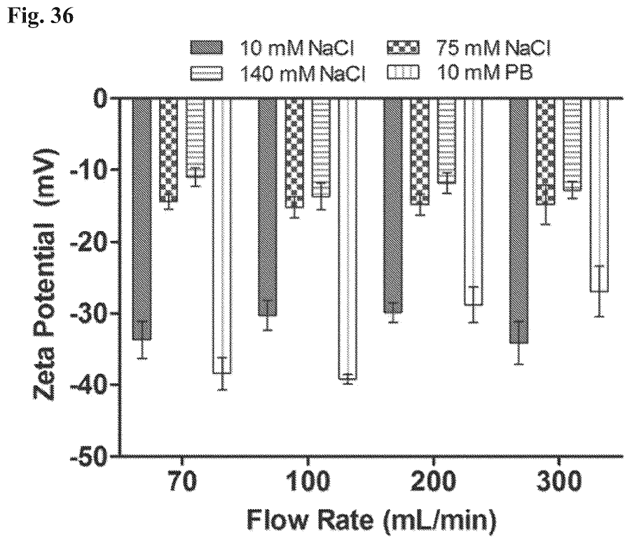

The zeta-potential was measured for the liposomes prepared in 10-140 mM NaCl and for 10 mM phosphate buffer (FIG. 36). As the NaCl concentration increases, the zeta-potential on the particles decreases. This decrease in zeta-potential corresponds to a decrease in the particle size for the liposomes prepared in NaCl. Liposomes prepared in 10 mM phosphate buffer had a similar zeta-potential to those prepared in 10 mM NaCl; however, the particle size of the 10 mM phosphate buffer liposomes were more similar to liposomes prepared in 75 mM NaCl.

### Automatic Particle Size Control

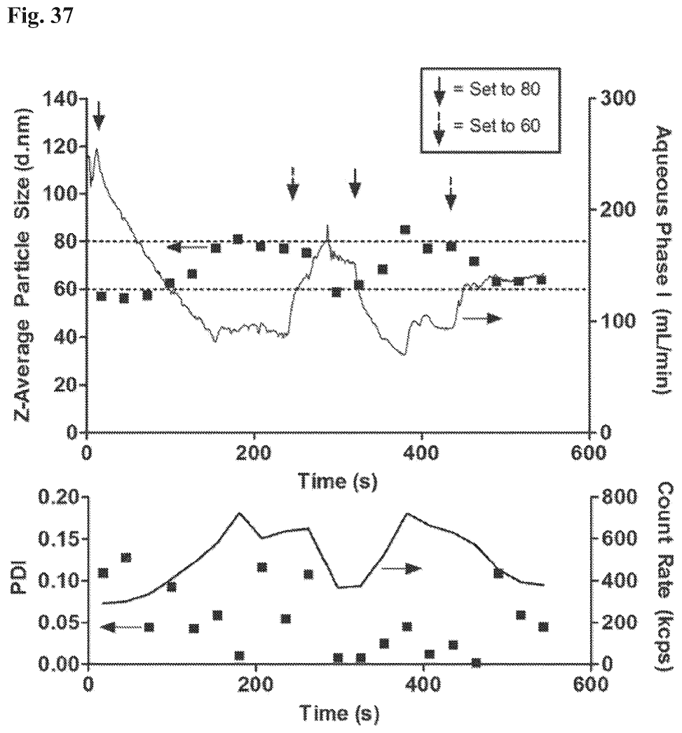

The feedforward model used related the flow rate to the particle size, type of lipid and salt concentration. The feedback control used a PID controller with the following settings: P=1.5, I=0.3 and D=0.001. Two particle size set points were set during this experiment, i.e. 60 nm and 80 nm. Once the set point particle size was reached, the user adjusted the particle size set point to the other set point (FIG. 37). Initially, the feedforward algorithm was able to accurately predict the particle size. After this initial prediction, the feedback algorithm took over to maintain the particle size at the set point. From FIG. 37, it was demonstrated that the feedback control satisfactory maintained the mean particle size and was able to automatically adjust the flow rates to achieve the set point particle size (i.e. from 60 nm to 80 nm or vice versa). The PDI remained around 0.1 or less during the entire experiment. The DLS count rate fluctuated based on the flow rate conditions, but was within a range that was previously determined to provide satisfactory particle size analysis.

### In-Line Liposomal Dilution

The importance of degassing liposomes at the end of the liposome formation stage prior to the ethanol dilution stage has been introduced. As mentioned, the mixing of ethanol with an aqueous phase is exothermic and leads to sensible heat changes. These heat changes caused dissolved gas to leave the solution, forming bubbles/an air-water interface. For DPPC liposomes, the presence of bubbles did not appear to affect the liposomal particle size distributions. For DMPC liposomes, the particle size distribution was affected at the lower aqueous phase I flow rates, but not at the higher flow rates. Moreover, it was observed that at the lower aqueous phase I flow rates (i.e. 70 mL/min), foam was visible for the DMPC liposomes, but not for the DPPC liposomes. This foaming may be due to a reduction in surface tension as temperature increased—subsequently causing an increase in the mobility of the lipid molecules. This analysis was further corroborated by FIG. 26 and FIG. 27. In these Figures, a change in temperature caused changes in liposomal mean particle size; although, to a greater extent for DMPC liposomes than for DPPC liposomes. In addition, DMPC liposomes exhibited an increased particle size distribution (higher PDI) as temperatures exceeded 24° C. and a significant change in mean particle size as temperatures exceeded 26° C. These events can be explained since the transition temperature for the DMPC phospholipid is around 24° C., which would cause this lipid to experience a more fluid-like behavior near and/or above this temperature. This increased lipid mobility resulted in the formation of larger liposomes, as well as increased foaming. For the DPPC phospholipid, the phase transition temperature is closer to 41° C., which explained why DPPC liposomes did not exhibit larger particle size changes compared to DMPC liposomes over the temperatures investigated.

When foam formed at the liposome formation stage and passed into the ethanol dilution stage (aqueous phase II), this dilution stage became a second stage of mixing, which caused the foam to mix back into the aqueous phase and formed a second population of liposomes. The liposomes formed at the dilution stage would then depend on the mixing at the dilution stage, i.e. the Reynolds number and temperature. Since the flow rates ranged from 460-660 mL/min, the Reynolds number at this stage would be >1000 and supported the formation of smaller liposomes. Therefore, with the addition of foam, a larger particle size distribution existed because essentially two populations of particles formed, one at the liposome formation stage and one at the ethanol dilution stage. By removing the foam after liposome formation, the tendency to form a second population of particles was reduced.

As previously explained, the Reynolds number may be used as a predictive measure of particle size; however, it is only suitable with fixed conditions such as lipid concentration, types of salts, salt concentrations, etc. A lower Reynolds number supports larger liposomes while a higher Reynolds number supports smaller liposomes. By lowering the temperature at the liposome formation stage, this would cause the Reynolds number to decrease, and the liposome particle size to decreases. Therefore, the Reynolds number alone is not a satisfactory measure for the liposome formation process. Instead, a more a thorough model that takes into account factors such as the Reynolds number, temperature, lipid-phase transition temperature, lipid hydrocarbon saturation and buffer/salt composition may be beneficial.

Variables that Influence Particle Size Measurements

There are a number of variables that influence accurate particle size measurement of liposomes for at-line measurements. These variables can be divided into processing variables and DLS measurement variables (FIG. 43). For processing variables, the first is the total dead volume, i.e. the volume of the tubing from the process stream to the flow cell plus the volume of the flow cell. This volume is important since this is the volume that may be replaced after each measurement; otherwise, liposomes that were formed at earlier time points may be mixed with liposomes formed at later time points. Large total dead volumes will incur a large time shift with respect to processing conditions.

A second processing variable is the process stream to flow cell velocity ratio. This ratio is the velocity of the liquid in the process stream divided by the velocity of the liquid flowing to the flow cell. In order to achieve a small time shift, this value may be >>1. This variable is linked with the total dead volume since higher ratios cannot be achieved with large dead volumes, especially at flow rates around 1-1.5 mL/min. For example, the DLS flow cell volume used in these experiments is 100 μL and the total volume including the pump and tubing was approximately 220 μL. Moreover, if DLS measurements were taken every 15 seconds, then 250 μL of sample would pass through during this time. Ideally, since the flow cell has a larger volume than the tubing, it may require more volume to remove the entire previous sample (i.e. 2-3× the total dead volume) and longer delay times in between measurements would be required.

A third processing variable is whether laminar flow occurs. This variable is only important for the constant flow mode. For this variable, small inner diameter tubing (e.g. 0.01″) may cause turbulence and affect the Brownian motion of the particles, thus resulting in incorrect particle size measurements. To reduce these effects, larger inner diameter tubing should be used; however, larger inner diameter tubing will increase the total dead volume.

DLS measurement variables include settings such as measurement duration, number of runs and attenuation factor. The measurement duration for each DLS run can be set in the Zetasizer software. For off-line DLS measurements, each measurement consisted of approximately 10-15 runs and each run lasted 10 seconds. The DLS data from each run was then combined to provide a single DLS result. Good quality DLS data is when the total photon count, i.e. the total number of photons acquired after all of the measurements, is greater than 10,000. Additionally, the mean count rate measured in kilo counts per second (kcps) should be greater than 20 kcps and less than 1000 kcps. For lower photon counts, the data may not result in an accurate particle size analysis. For the at-line measurements, only a single run of six second duration was used for the DLS measurements, which would result in a low photon count. However, from FIGS. 30-34, the 6 second duration was adequate for determining the z-average particle size and in most cases, the PDI was similar for both off-line and at-line measurements. Shorter measurement durations (e.g. 3 seconds) may have also provided satisfactory results, but would lead to a lower photon count. Therefore, the at-line measurement experiments used a longer measurement duration (i.e. 6 seconds) to achieve more consistent and higher quality data.

The attenuation factor is another important variable. A low attenuation factor refers to when a lesser amount of light passes through the sample and a high attenuation factor is when a greater amount of light passes through the sample (for a Malvern Zetasizer, the attenuation range is from 0-11, respectively). Changing the attenuation factor will cause the photon count rate to increase or decrease; however, very high count rates will no longer provide accurate data since the DLS detector has a maximum count rate where the response remains linear. For the off-line measurements, the count rate was set to “automatic” in the Zetasizer software. For the at-line measurements, the count rate was kept between 150-400 kcps by programmatically adjusting the attenuation factor depending on the particle size of the liposomes being tested. The advantage of a user-defined attenuation is the reduced overall time per measurement. The disadvantage is that the user-define attenuation factor may not allow for a sufficiently high photon count during measurement—resulting in lower quality data.

A fourth measurement variable is the presence of air bubbles in the sample. Air bubbles will affect the overall quality of the results since the air bubbles also scatter light. One way to circumvent this issue is to use a degassing unit between where the sample is taken and the DLS flow cell. The disadvantage of using a degassing unit is that the volume of the degassing unit adds to the total dead volume, resulting in longer measurement delays (FIG. 30).

### At-Line Particle Size Measurements Comparisons

By comparing the Continuous Flow mode vs. the Load/Stop Mode, the Load/Stop mode appeared to be more accurate and had a more consistent measurement time-delay. When using the Load/Stop mode, the entire sample was removed from the DLS flow cell since the flow rates were around 20-25 mL/min vs. 1-1.5 mL/min for the Continuous Flow mode. In addition, a larger inner diameter tubing was used for the Load/Stop mode and this may have reduced air bubble formation, resulting in fewer artifacts present with the DLS data. One disadvantage of the Load/Stop approach is the rapid loading of the flow cell, which does not allow for temperature equilibration. In this case, the sample temperature may be different than the temperature set in the DLS software, which could explain why the mean particle size, especially for smaller liposomes, was lower when compared to the off-line DLS measurement (FIG. 31). This deviation was only observed for small liposomes (i.e. <50 nm).

### Ionic Strength on Liposome Formation

The ionic strength of the aqueous phase significantly affected the liposome mean particle size. From FIG. 35, 10 mM NaCl formed 70 nm liposomes and 140 mM NaCl formed around 160 nm liposomes at the same flow rate (i.e. 70 mL/min). The portion of the phospholipid molecule that is in contact with the aqueous phase is the phosphate head group. Accordingly, the head group may be changing in size (e.g. mean molecular area) and would influence lipid packing. Moreover, by comparing liposomes prepared in 10 mM NaCl to 10 mM phosphate buffer (at pH 7.4), the liposomes prepared in 10 mM NaCl were smaller in diameter. When taking into account the ionic strength, the 10 mM phosphate buffer had an ionic strength greater than 10 mM NaCl but less than 75 mM NaCl. Therefore, an increase in ionic strength caused an increase in liposomal mean particle size.

The ionic strength affects the electrostatic or charge repulsion of neighboring phospholipid molecules (FIG. 35). At a low ionic strength (e.g. 10 mM NaCl), the repulsion would be greater than at 140 mM NaCl since a high salt concentration would lower the overall zeta-potential of the particles (FIG. 36). This is explained by the Gouy-Chapman-Stern theory, which describes that increasing salt concentrations decrease the distance from the charged surface to the plane of shear. When increased amounts of charged species (e.g. Na⁺) associate with negatively charged phospholipid membranes, the magnitude of the zeta-potential is reduced. According to a previously described liposome formation model, a lower zeta-potential may allow more phospholipids to enter the pro-liposomes and hence result in the formation of larger liposomes.

A second explanation for the increase in size with increase in NaCl concentration is related to local heat effects as the liposomes are initially forming. The excess enthalpy of mixing for the ternary mixture of ethanol, water and NaCl becomes more positive as the salt concentration increases. Reduced enthalpy of mixing indicates more bond breaking events are occurring compared to low salt conditions, i.e. less water-ethanol hydrogen bond formation. This event may suggest that more ethanol is interacting with the lipid molecules during the initial mixing stage, thus promoting larger lipid aggregates to form prior to liposomes formation. However, either explanation, i.e. electrostatic or changes in enthalpy of mixing would be difficult to measure directly since liposome formation is taking place at the molecular level and under turbulent flow conditions. A future study on changing the phospholipid molar ratio of the charged phospholipid may be a suitable alternative to exploring the effects of charge repulsion on the liposome formation process.

### Automatic Particle Size Control

In the continuous manufacturing of liposomes, process changes such as pressure or temperature fluctuations will cause changes in the liposomal particle size during the liposome formation process. Using feedforward control to initially predict the process conditions (i.e. aqueous phase I flow rate) and a feedback control to maintain the particle size was demonstrated. By implementing these control strategies, liposomal quality attributes (i.e. mean particle size and particle size distribution) could be maintained, which supported an overall higher quality formulation.

In-line dilution of liposomes to reduce the ethanol concentration was implemented in this continuous process to form liposomes. Incorporating the in-line dilution stage post the liposome formation process may cause changes to the liposomal particle size distribution-depending on the liposomal formulation. Therefore, it was determined to be useful to include a degassing unit post liposome formation and prior to the in-line dilution stage. At-line particle size analysis was implemented into the continuous processing of liposomes. To reduce time delays between process changes (i.e. flow rates) and the particle size measurement data, it was determined that the Load/Stop mode provided more consistent results when compared with the Continuous flow mode. In addition, the ionic strength of the aqueous phase significantly impacted the mean particle size of the liposomes, i.e. an increase in ionic strength favored the formation of larger liposomes. Lastly, automatic particle size analysis was implemented using both a feedforward and a feedback control, which resulted in precise control and maintenance of the liposomal particle size and polydispersity index.

FIG. 43 illustrates a table showing variables that influence continuous particle size measurements.

### Example 3

### Materials and Methods:

Materials. 1,2-dipalmitoyl-sn-glycero-3-phosphocholine (DPPC), 1,2-dipalmitoyl-sn-glycero-3-phospho-(1′-rac-glycerol) (sodium salt) (DPPG-Na) and Lipoid S PC-3 (HSPC) were purchased from Lipoid™. Cholesterol (Chol) was purchased from Sigma. Ethanol (200 proof, ACS/USP grade) was purchased from Pharmco-AAPER.

Experimental Methods. Liposome Formation and Dilution. Liposomes were prepared by a modified ethanol injection method. A schematic of this system is depicted in FIG. 7. Three separate 316 stainless steel tanks contained the lipid+ethanol solution. These tanks were pressurized (at 20 psi) and the flow rates from these tanks were controlled using analog flow meters (McMillian) and proportioning solenoid valves (Aalborg). The flow meters were factory calibrated for water with less than 1% error full-scale. For the lipid+ethanol flow streams, these flow sensors were re-calibrated for ethanol and had an R-squared value of 0.9989, with a working range from 5-50 mL/min. The three tanks were then connected at a single point using a 4-way connector (Swagelok). A static mixer was implemented to ensure that the lipid+ethanol solutions from the three tanks were adequately mixed prior to reaching the injection port where the ethanol and aqueous phase 1 streams converged. The aqueous phase I volumetric flow rate was controlled by a gear pump (Micropump®). To form liposomes, the mixed lipid+ethanol solution was then injected into an aqueous phase (aqueous phase I) at various flow rates. The tubing ID of the ethanol phase was 0.508 mm (1.588 mm OD). The aqueous phase I tubing ID was fixed at 4.572 mm. Flow rates of the lipid+ethanol phase were from 5-40 mL/min and aqueous phase I were from 70-300 mL/min.

After the liposomes were formed, the liposomes passed through a degassing unit (Liqui-Cel®) followed by a second three-way T-port. This three-way T-port has one inlet for the liposomes, a second inlet for aqueous buffer and one outlet. A second gear pump (Micropump®) was used to control the flow of the aqueous phase into this port (aqueous phase II). The aqueous phase II flow rate was adjusted such that mixed aqueous phase would have 5% vol. ethanol. Aqueous phase II flow rates ranged from 690-460 mL/min.

### Data Acquisition System and Computer Software

The entire process was controlled by a custom-made program written using National Instruments (NI) LabVIEW® software. A data acquisition system (NI PXIe-1078) was combined with multiple NI modules to accommodate various input/output signals (e.g. analog and digital inputs/outputs, counters, circuit switches, etc.). The entire system was automated and only required the user to define the final lipid concentration and molar ratios of lipid. Process variables such as flow rates, pressure, and temperature were monitored and, for some variables, automatically adjusted using custom computer algorithms. For example, proportional-integral-derivative controls were implemented in the computer program to precisely control the flow rates of both the ethanol and aqueous phases.

Communication to and from the Malvern Zetasizer was accomplished using the Malvern Link II software. Malvern Link II software was setup as an OPC server and NI LabVIEW was setup as an OPC client. The z-average particle size and PDI were recorded in the custom computer program. The custom computer program was able to send measurement instructions to the Malvern Zetasizer.

### Particle Size Measurements

All particle size measurements were performed using a Malvern Zetasizer Nano S. Prior to measurements, the liposomes were diluted in-line to 5% vol. ethanol and the viscosity and refractive index were pre-set in the Malvern Zetasizer software. Particle size measurements included the z-average particle size and polydispersity index (PDI). For the off-line measurements, disposable plastic cuvettes were used. The samples were equilibrated at 25° C. prior to each measurement. Each off-line measurement duration was set for 10 runs at 10 seconds each with n=3.

For at-line measurements, a flow cell equilibrated at 25° C. was used. The measurement duration was set to 1 run for 6 seconds. The Load/Stop Mode, based on loading the flow cell followed by stopping the flow prior to the measurement, was used in all cases (see Chapter 5). A Micropump® pump was used to control the flow through the flow cell (20-25 mL/min). The pump operated at the specified flow rate prior to the particle size measurement. Before any measurement took place, the custom computer algorithm stopped the pump to prevent fluid flow during the measurement.

### NIR (Turbidity) Measurements

An Optek® TF16-N Scattered light dual channel turbidity sensor was used for the measurements. This device has two simultaneous channels, the first measures light absorption, i.e. this principle is based on detecting the light at 0° from the light source by a single hermetically sealed photodiode. This measurement is in concentration units (CU). The second measurement principle is based on light scattering and the scattered light is detected at 11° by eight hermetically sealed silicon photodiodes. This measurement is reported in parts per million (PPM). The measurement wavelengths are a band ranging from 730 nm to 970 nm. The optical path length of the sensor is fixed at 40 mm and is in a flow cell configuration, i.e. has an inlet and outlet for in-line application. The linearity of the sensor is <±1% of the full scale for each measurement and has a repeatability of <±0.5%.

### Tangential Flow Filtration System

An EMD Millipore Pellicon Mini Holder with Pellicon 2 Mini Ultrafiltration Biomax-100 modules was used as the tangential flow filtration (TFF) device. This device was connected to a peristaltic pump (Blue-White Industries, LTD) to control the flow rate. A pressure transducer and solenoid valve were connected to the output of the TFF device. The pump, pressure transducer and the solenoid valve were connected to the custom LabVIEW computer program (FIG. 8).

### Lipid Concentration Analysis Via the Stewart Assay

The Stewart assay is a UV-spectrometric technique that determines the amount of phospholipid present. Briefly, ammonium ferrothiocyanate (AF) was prepared by dissolving 13.52 g of ferric chloride hexahydrate and 15.2 g of ammonium thiocyanate in 0.5 liters of deionized water. A calibration curve was generated by taking 10-70 mg of phospholipid stock solution (originally dissolved in ethanol) added to approximately 3 mg of chloroform. 2 mL of the AF solution was added to this mixture, which was then vortexed for 30 seconds followed by centrifugation at 1,500 rpm for 2 minutes. The AF was removed and the chloroform containing lipid was analyzed using a Cary 50 UV-spectrophotometer at 470 nm. The calibration curve consisted of 9 values with a quantitation limit (QL) of 0.023 ug/mL and an R-squared of 0.997.

### Lipid Concentration Analysis Via High Pressure Liquid Chromatograph-Mass Spectrometry

The lipid concentration was determined using a high pressure liquid chromatography (HPLC) with a mass spectrometer (MS). A Waters Xbridge C8, 3.5 μm, 4.6×75 mm column heated at 30° C. was used for lipid separation. The mobile phase was 2 mM ammonium formate in MS-grade methanol. The flow rate was set at 0.3 mL/min and 3 μL of sample was injected for each measurement. An ESI probe was used and the operating conditions were optimized in the TSQ software (FIG. 44).

The sample was analyzed for the main phospholipid depending on the lipid formulation, i.e. for DPPC. The raw chromatographic data was transformed using a power function value (PFV) and the area under the curve was calculated. The tailing factor was less than 1.20 for each peak. The calibration curves had a QL of approximately 1.22 ug/mL and the R-squared value was >0.996. The PFV used for DPPC was 1.23.

### Lipid Concentration Prediction Models

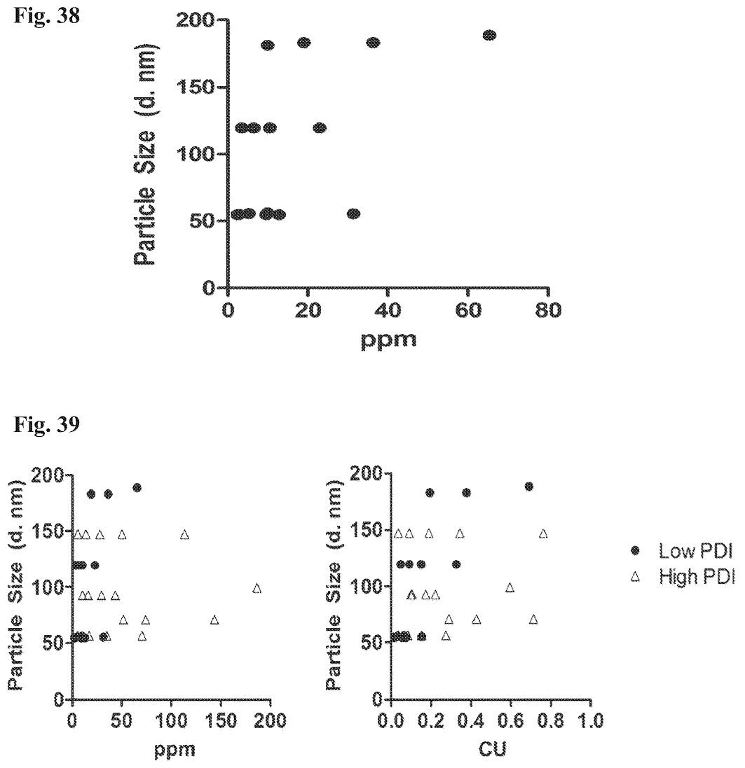

JMP by SAS was used to generate prediction models and equations. Two models (defined as Model 1 and Model 2) were generated that had the response as the total lipid concentration ([Lipid]) in units of mM. The possible factors for the model were the NIR measurements (both CU and ppm) the z-average particle size (d·nm) and the polydispersity index (PDI). Model 1 only included particle size and ppm as factors. Only monodispersed liposome (i.e. having a PDI≤0.1) were used to generate this model. The experimental design for Model 1 is outlined in FIG. 38. Since the ppm signal was highly dependent on the particle size, a typical experimental design (e.g. full factorial) was difficult to achieve. In addition, the maximum concentration reported for this model was approximately 7 mM total lipid. Higher total lipid concentrations would be required to achieve a higher ppm signal for the smaller particle sizes (e.g. 50 nm vs. 150 nm). Model 2 is an extension of Model 1 and included particle size, PDI, ppm and CU as factors. The experimental design of Model 2 is outlined in FIG. 39.

### Results:

### Prediction Models

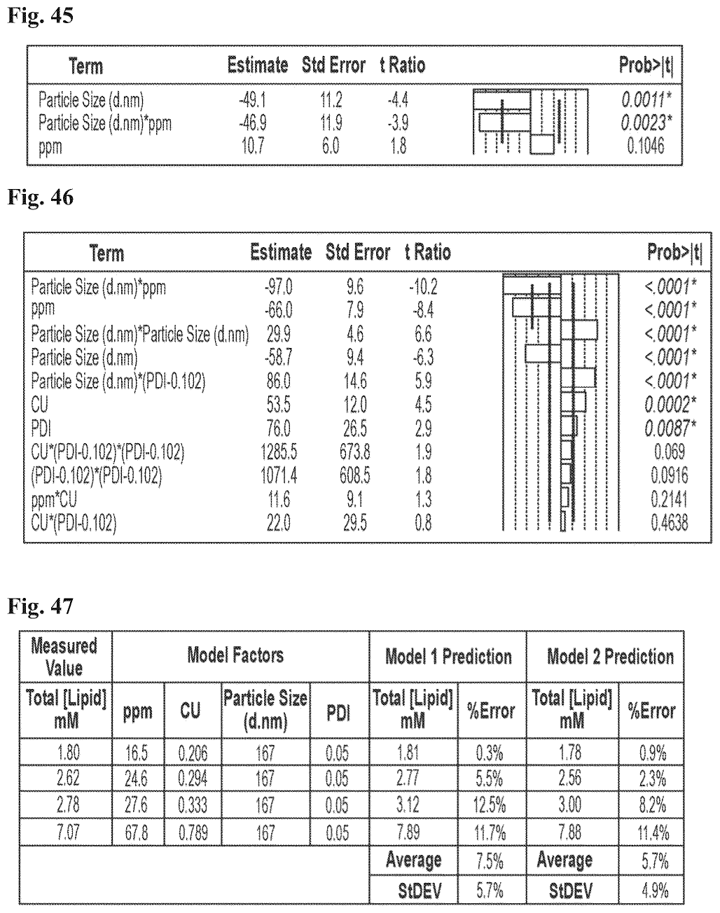

The liposomal particle size diameter ranged from 55 nm to 188 nm. For Model 1, the PDI was less than 0.10 for all sizes and concentrations tested. The total lipid concentration ranged from 0.38 mM up to 7.96 mM. The significant terms (P<0.05) were particle size, particle size*ppm and ppm (FIG. 45). Both the particle size and particle size*ppm negatively impacted the lipid concentration, whereas an increase in ppm related to an increase in lipid concentration. The NIR CU measurement did not correlate with the model and was omitted. The R-squared for the actual vs. prediction lipid concentration was 0.931, indicating a linear relationship. The model had 15 observations (with 3 degrees of freedom for the model), a RMSE of 0.587 and an analysis of variance <0.001.

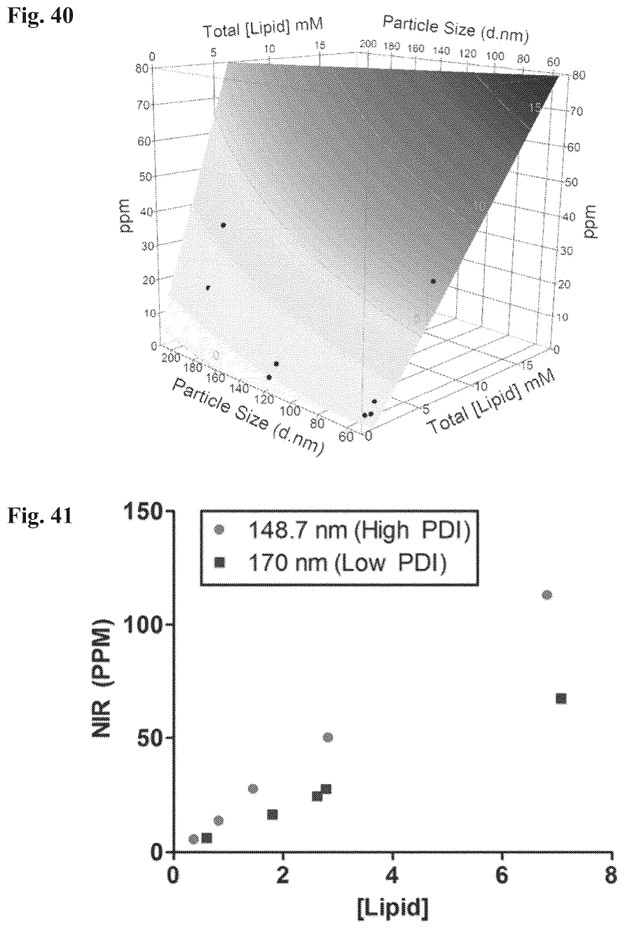

The surface profile for Model 1 is demonstrated in FIG. 40. The profile is of ppm vs. particle size vs. total lipid concentration. As the particle size increases, the ppm vs. [Lipid] slope increases and higher ppm values are reached for lower lipid concentrations. The smaller sized liposomes only reached approximately 30 ppm for the same maximum [Lipid], whereas the large liposomes reached up to 70 ppm. The empirical prediction equation for Model 1 is:

$$[ 0001 ] [ [ 0001 ] Lipid [ 0001 ] ] [ 0001 ] = [ 0001 ] 9.66 [ 0001 ] - [ 0001 ] 49.1 [ 0001 ] * ( \frac{[ 0001 ] Particle [ 0001 ] [ 0001 ] Size [ 0001 ] - [ 0001 ] 263}{[ 0001 ] 238} ) [ 0001 ] + [ 0001 ] 10.7 [ 0001 ] * ( \frac{[ 0001 ] ppm [ 0001 ] - [ 0001 ] 250}{[ 0001 ] 250} ) \qquad ( 1 )$$

$$[ 0001 ] + [ 0001 ] ( [ 0001 ] - [ 0001 ] 46.9 [ 0001 ] ) [ 0001 ] * ( \frac{[ 0001 ] Particle [ 0001 ] [ 0001 ] Size [ 0001 ] [ 0001 ] - [ 0001 ]}{[ 0001 ] 238} [ 0001 ] * ( \frac{[ 0001 ] ppm [ 0001 ] - [ 0001 ] 250}{[ 0001 ] 250} )$$

This equation was implemented into the custom computer program to predict the lipid concentration based on both particle size and turbidity measurements.

For Model 2, the same particle size diameter range was used as outlined in Model 1 above. The total lipid concentration ranged from 0.38 up to 20 mM. Significant terms for Model 2 are listed in FIG. 47, with particle size*ppm and ppm as the most significant. Both the CU and PDI also had statistical significant terms in the model. The R-squared for the actual vs. prediction lipid concentration was 0.987, indicating a linear relationship. The model had 35 observations (with 11 degrees of freedom for the model), a RMSE of 0.527 and an analysis of variance <0.001. The empirical prediction equation for Model 2 is:

$$[ 0001 ] [ [ 0001 ] Lipid [ 0001 ] ] [ 0001 ] = [ 0001 ] - [ 0001 ] 20.1 [ 0001 ] - [ 0001 ] 58 [ 0001 ] * ( \frac{[ 0001 ] Particle [ 0001 ] [ 0001 ] Size [ 0001 ] - [ 0001 ] 263}{[ 0001 ] 238} ) [ 0001 ] - [ 0001 ] 66. [ 0001 ] * ( \frac{[ 0001 ] ppm [ 0001 ] - [ 0001 ] 250}{[ 0001 ] 250} ) [ 0001 ] + [ 0001 ] 53.5 [ 0001 ] * ( \frac{[ 0001 CU [ 0001 ] - [ 0001 ] 2}{[ 0001 ] 2} ) [ 0001 ] + [ 0001 ] 76. [ 0001 ] * [ 0001 ] PDI [ 0001 ] + [ 0001 ] 29.9 [ 0001 ] * ( \frac{[ 0001 ] Particle [ 0001 ] [ 0001 ] Size [ 0001 ] [ 0001 ] - [ 000}{[ 0001 ] 238} * ( \frac{[ 0001 ] Particle [ 0001 ] [ 0001 ] Size [ 0001 ] - [ 0001 ] 263}{[ 0001 ] 238} ) [ 0001 ] - [ 0001 ] 97. [ 0001 ] * ( \frac{[ 0001 ] Particle [ 0001 ] [ 0001 ] Size [ 0001 ] [ 0001 ] - [ 000}{[ 0001 ] 238} [ 0001 ] * ( \frac{[ 0001 ] ppm [ 0001 ] - [ 0001 ] 2 \; 50}{[ 0001 ] 250} ) [ 0001 ] + [ 0001 ] 11.6 [ 0001 ] * ( \frac{[ 0001 ] ppm [ 0001 ] - [ 0001 ] 250}{[ 0001 ] 250} ) * ( \frac{[ 0001 ] CU [ 0001 ] - [ 0001 ] 2}{[ 0001 ] 2} ) [ 0001 ] + [ 0001 ] 86. ( \frac{[ 0001 ] Particle [ 0001 ] [ 0001 ] Size [ 0001 ] [ 0001 ] - [ 0001 ] 263}{[ 0001 ] 238} ) [ 0001 ] * [ 0001 ] ( [ 0001 ] PDI [ 0001 ] - [ 0001 ] 0.102 [ 001 ] ) [ 0001 ] + [ 0001 ] 22. [ 0001 ] * ( \frac{[ 0001 ] CU [ 0001 ] - [ 0001 ] 2}{[ 0001 ] 2} ) [ 0001 ] * [ 0001 ] ( [ \text{} 0001 ] PDI [ 0001 ] - [ 0001 ] 0.102 [ 0001 ] ) [ 0001 ] + [ 0001 ] 1290 [ 0001 ] * ( \frac{[ 0001 ] CU [ 0001 ] - [ 0001 ] 2}{[ 0001 ] 2} ) [ 0001 ] * [ 0001 ] ( [ 0001 ] PDI [ 0001 ] - [ \text{} 0001 ] 0.102 [ 0001 ] ) [ 0001 ] * [ 0001 ] ( [ 0001 ] PDI [ 0001 ] - [ 0001 ] 0.102 [ 0001 ] ) [ 0001 ] + [ 0001 ] 1070 [ 0001 ] * [ 0001 ] ( [ 0001 ] \{ DI [ 0001 ] - [ 0001 ] 0.102 [ 0001 ] ) [ 0001 ] * [ 0001 ] ( [ 0001 ] PDI [ 0001 ] - [ 0001 ] 0.102 [ 0001 ] ) \qquad ( 2 )$$

A validation for both Model 1 and Model 2 was included. The liposomes had a mean particle size of 167±4.40 nm and a PDI of 0.05±0.02 (FIG. 47). The total lipid concentration range measured was from 1.80-7.07 mM. As the PDI was less than 0.1, both models could be used to predict the mean particle size, with the mean error less than equal to 7.5%. When comparing the percent error of the measured [Lipid] to the predicted [Lipid], a two-tailed, paired t-test resulted in a p-value of 0.23, indicating that the differences between the sets of data are insignificant.

### Polydispersity on the NIR Signal

A comparison was made between two sets of data for liposomes of a similar particle size but with differences in the PDI. The lower PDI (≤0.1) indicates a single population of particles, whereas a higher PDI indicates multiple populations of particles present. From FIG. 41, it is evident that the PDI is a factor that may preferably be controlled. The liposomes with a mean particle size of 149 nm and a PDI of 0.18±0.02 produced a PPM signal greater than those with a mean diameter of 170 nm and a PDI of 0.06±0.02.

Lipid Concentration Model. The relationship between scattered light and particle size are explained by Mie scattering theory. The Mie theory explains light scattering by an induced dipole moment from an incident electromagnetic wave. The induced dipole acts as a source of electromagnetic radiation and emits or scatters light at the same frequency as the source, i.e. clastic scattering. This theory provides an angular dependence of the scattered light based on the incident wavelength and the particle size. Relationships between liposomal particle size and light scattering and turbidity have been previously analyzed for liposomes. The theory is based on an approximation of the Mie scattering theory, called the Rayleigh-Gans-Debye approximation. From this approximation, lipid concentration may be estimated at a fixed incident wavelength if additional properties such as the refractive index of the aqueous medium and the refractive index of the lipid bilayer are known. However, this approximation may not be suitable for the current case since the incident radiation is a band of wavelengths covering 730-970 nm. In addition, the liposomes in this study were both monodispersed and polydispersed, which would further cause difficulties in using theoretical approximations to predict the total lipid concentration. For this reason, an empirical model was developed to relate liposomal particle size, PDI and the NIR signals (ppm and CU) to the total lipid concentration.

As expected, smaller particles scatter less light compared to larger particles. For this reason, the ppm/CU increases as the particle size increases. Two predictive models were generated, the first for only monodispersed liposomes (i.e. liposomes with a PDI≤0.10) and the second included liposomal formulations with a higher PDI (PDI>0.10). For the monodispersed liposomal model, detection at 0° (measured in CU) did not appear to have any correlation with particle size and concentration at the concentrations measured. The CU did increase linearly with an increase in lipid concentration, but did not form a correlation when comparing different particle size liposomes. In contrast, the scattered light at 11° (i.e. the ppm) demonstrated a correlation with both liposomal particle size and total lipid concentration. For this reason, only the scattered light was used in the prediction model for monodispersed liposomes. Moreover, since the ppm signal is referenced to the medium, the NIR sensor was able to measure low lipid concentrations and the detection was not affected by additions to the aqueous phase (e.g. ethanol).

For the second model (Model 2), the CU signal and the particle size PDI were added to Model 1. This addition to the model enabled the total lipid concentration to be predicted for both monodispersed and polydispersed liposomal formulations. The addition of a polydispersity term into the model enhances the overall predictability of the total lipid concentration for both monodispersed and polydispersed systems. The validation sample set demonstrated the robustness of both models. By comparing the mean error for each model, the error was insignificant, indicating that each model could be used for low PDI formulations. However, Model 1 could not be used for higher PDI formulations. These results demonstrated that an empirical model with only 3 degrees of freedom could predict the particle size of monodispersed liposomes; whereas an empirical model with 11 degrees of freedom was required for polydispersed samples. Therefore, when liposomes are formed with a low polydispersity, a relatively simple and low degree of freedom model may be used to predict the total lipid concentration of the liposomes.

### Polydispersity on NIR Detection

To emphasize how the polydispersity of the sample negatively impacted the prediction model, two data sets were plotted. The result that a high PDI sample increased the scattered light was expected as multiple populations of liposomes in the same sample will cause large variations in the scattered light. From the Mie theory, large particles will scatter light in the forward direction more than smaller particles. In addition, larger diameter particles scatter more light. The combination of a change in the angular scattering and scattering intensity prevented this model from predicting the lipid concentration. Therefore, a limitation to Model 1 is that it is only applicable to monodispersed liposomes. For polydispersed liposomes, Model 2 should be used to predict the total lipid concentration.

A tangential flow filtration system was implemented with a continuous liposome formation process to continuously concentrate liposomes in-line. Empirical models were developed for both monodispersed and polydispersed liposomes that had the total lipid concentration as the model response. These models can predict the lipid concentration from 0.38 up to 20 mM total lipid for particle size diameters from approximately 50 nm up to 200 nm. One limitation for Model 1 is that it is only applicable to monodispersed liposomes. Model 2 has predictive power for both monodispersed and polydispersed, but requires a model with 11 degrees of freedom. The implementation of the concentrating system and predictive models into a continuous process for liposomes enhances process control. Moreover, this system results in effectively controlling one quality attribute (i.e. lipid concentration) of liposomal drug products.

FIG. 44 illustrates a table showing TSQ HPLC-MS ESI Operating Conditions used in the Analysis of Lipid Concentration Quantitation.

FIG. 45 illustrates a table showing sorted parameter estimates and model terms for Model 1.

FIG. 46 illustrates a table showing sorted parameter estimates and model terms for Model 2.

FIG. 47 illustrates a table showing validation data points for both lipid concentration ([Lipid]) models. Model 1 is based on particle size and ppm, whereas Model 2 includes particle size, polydispersity index (PDI), ppm and CU.

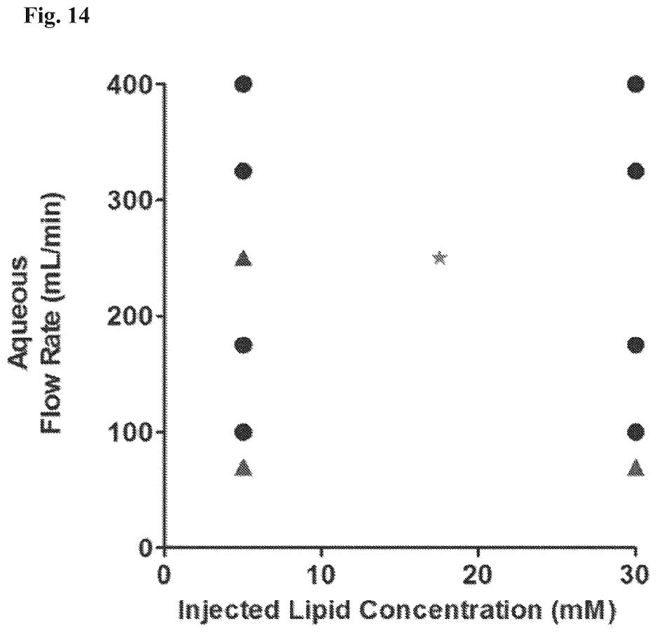

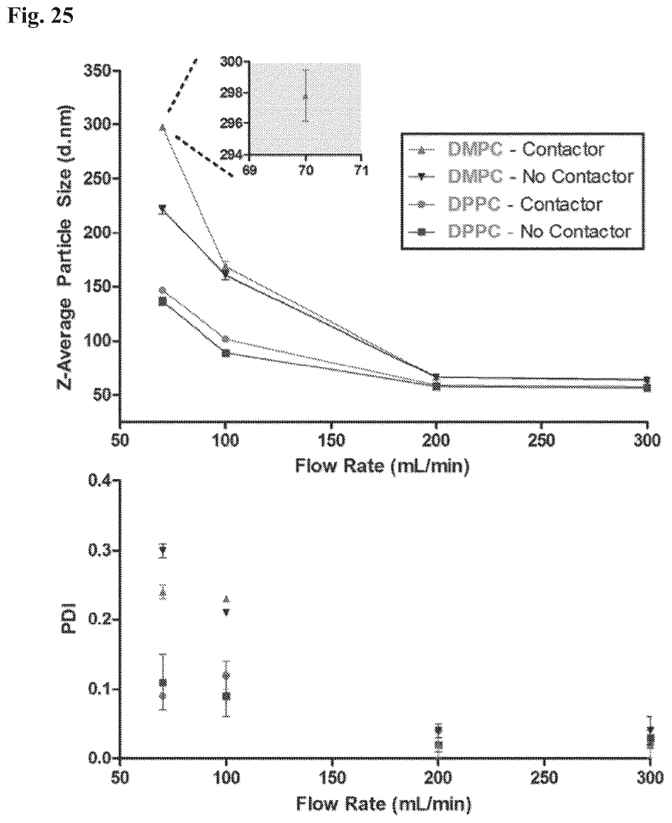

FIG. 48 is an example of a continuous process for the formation of nanoparticles using a solvent injection approach. This approach can be used to form various nanoparticles (i. e. from around 10 nm up to 1000 nm) such as liposomes, solid lipid nanoparticles, lipid complexes, polymeric micelles, etc. The system of FIG. 48 may include one or more of the features disclosed in U.S. patent application Ser. No. 15/557,575, the contents of which are incorporated by reference in their entirety (as set forth above and with reference to FIGS. 1 through 47). As shown in FIG. 48, the nanoparticle formation system comprises of multiple segments, including a loading process or nanoparticle modification segment, which is used to modify the intra-particle and extra-particle characteristics. The nanoparticle modification segment will be discussed in additional detail below. Accordingly, the systems described herein may be used in conjunction with the system outlined in FIG. 48, for example by being inserted where the loading process is positioned. In another example, the nanoparticle modification systems described below can be standalone systems that are separate from the nanoparticle formation system of FIG. 48.

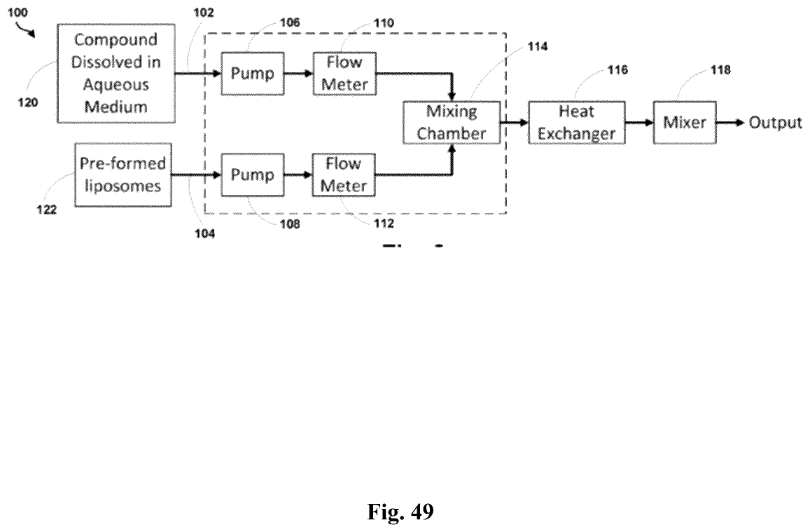

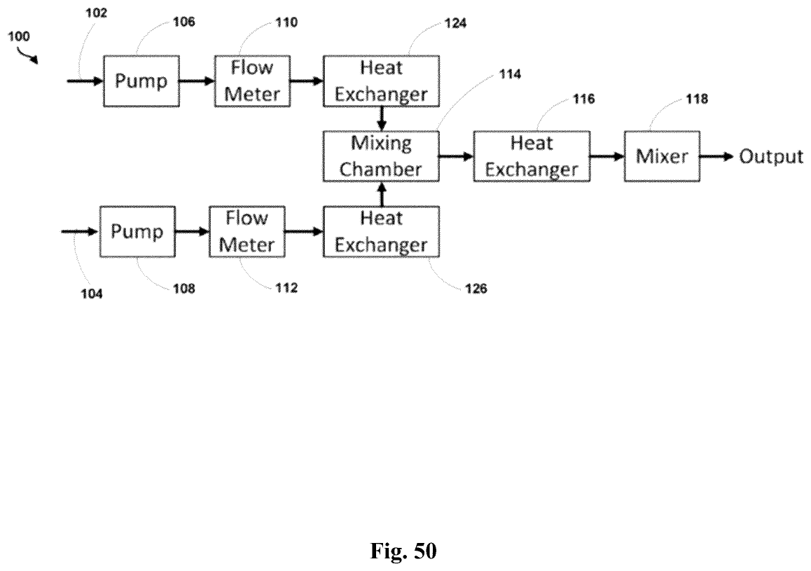

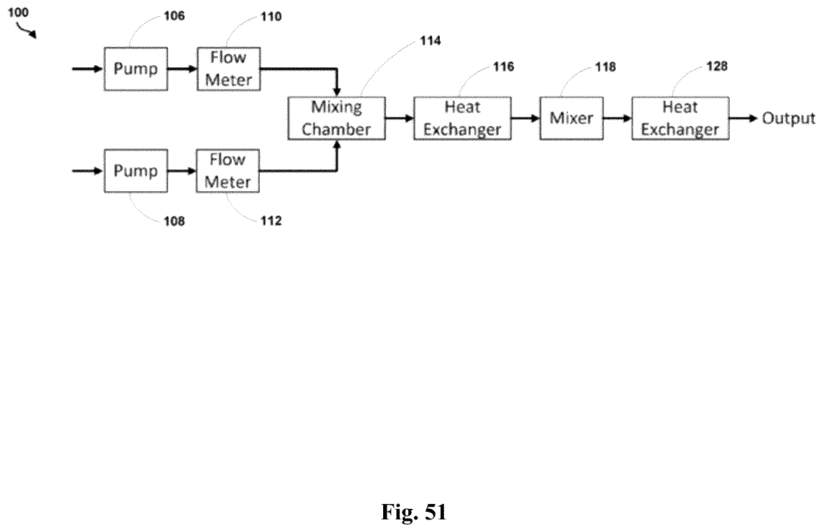

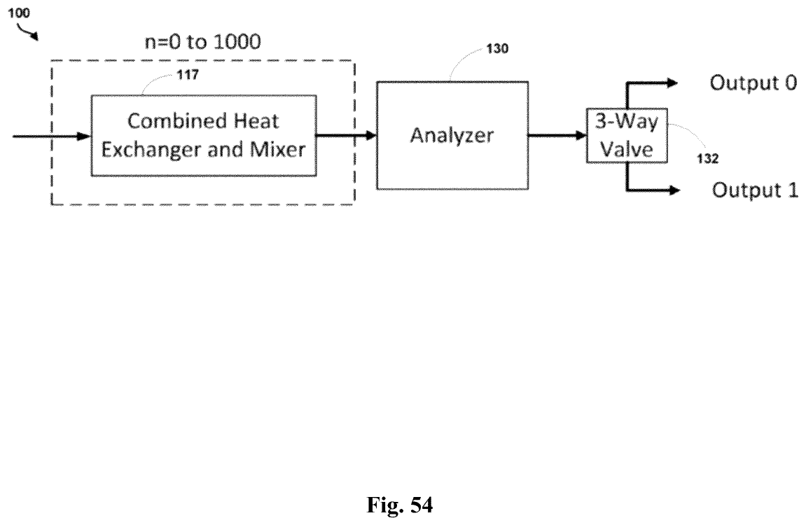

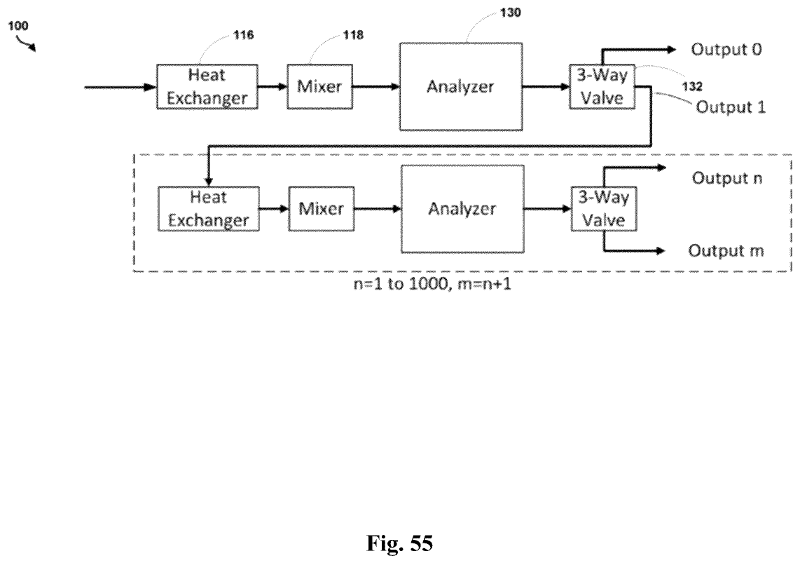

FIGS. 49-64 provide additional detail on the solvent injection approach. In this technique, FIG. 49 depicts aspects of a continuous processing system with a formation module, a buffer-exchange module, a concentrator, a modification module, sensors, and a controller. FIG. 50 depicts aspects of a degassing unit that removes dissolved gas from a dispersion before buffer exchange. FIGS. 51-53 depicts aspects of tangential-flow units and manifolds that perform buffer exchange and concentration under a transmembrane pressure and a crossflow that maintain target particle size and composition. FIG. 54 depicts aspects of a UV-Vis spectrum that confirms encapsulation and composition in a continuous line. FIG. 55 depicts aspects of a method flow that provides inputs to a controller and adjusts flows and temperature to maintain target values.

In the example of FIG. 49, an illustration of an example system 100 for internal and external modification of nanoparticles in a continuous process is shown. As shown in FIG. 49, the system 100 includes a first inlet 102 and a second inlet 104. The system 100 further includes a first pump 106 in fluid communication with the first inlet 102, and a second pump 108 in fluid communication with the second inlet 104. The system further includes a first flow meter 110 in fluid communication with the first pump 106, and a second flow meter 112 in fluid communication with the second pump 108. The system further includes a mixing chamber 114 in fluid communication with the first flow meter 110 and the second flow meter 112. In one example, the mixing chamber 114 is a static mixer configured to combine solutions from the first inlet 102 and the second inlet 104. The system also includes a first heat exchanger 116 in fluid communication with the mixing chamber 114. In one example, the system 100 further includes a first mixer 118 in fluid communication with the first heat exchanger 116. In one example, as shown in FIG. 49, the first heat exchanger 116 and first mixer 118 are separate components with the first mixer 118 positioned downstream from the first heat exchanger 116. In another example, the first heat exchanger 116 and first mixer 118 are combined into a single component 117. In one example, as shown in FIG. 49, the first inlet 102 is in fluid communication with a first container 120, and the second inlet 104 is in fluid communication with a second container 122. In one particular example, the first container 120 may include a compound dissolved in an aqueous medium, and the second container 122 may include pre-formed liposomes. In another example, the second inlet 104 is in fluid communication with an output of a system for the continuous formation of nanoparticles, such as the system shown in FIG. 48.

FIG. 49 is a first embodiment of the system 100 for nanoparticle modification, where a molecule (such as doxorubicin-HCL) is dissolved in an aqueous medium (e.g. histidine buffer) and pre-formed liposomes (with a high intra-liposomal salt concentration) are mixed together, where the mixing and heating causes the liposomal nanoparticle to be modified. As one example, the “active loading” of doxorubicin-HCl into liposomes can be achieved by first forming the liposomes with a battery of ammonium sulfate (e.g. 250 mM) in the intra-liposomal space and pre-processing these liposomes by removing the extra-liposomal ammonium sulfate salt (e.g. to less than 5 mM). These pre-formed, pre-processed liposomes are then mixed with doxorubicin-HCl in a histidine/sucrose buffer by being injected into a mixing chamber and flow continuously to a downstream heat exchanger and mixer at a fixed flow rate. The degree of heating can be controlled by the flow rate and the temperature of the heat exchanger. Typically, temperatures between 40-90 degrees Celsius are used to promote this active loading process.

As such, the system 100 and methods disclosed herein can be used for controlled drug encapsulation or drug loading in pharmaceutical drug product processing. In this case, the morphology of the nanoparticle (e.g. liposome) can be dependent on the morphology of the intraliposomal structure (e.g. a crystal growth or salt complex). Changes in morphology that form non-spherical structures may affect the human complement system and can cause syndromes such as palmar-plantar erythrodysesthesia. One way to assess the morphology of a liposomal nanoparticle is to measure the apparent aspect ratio, which is the ratio of the largest diameter divided by the smallest diameter of a particle. For an apparent aspect ratio equal to one, the particle is spherical, whereas aspect ratios (ARs) greater than 1.05 tend to indicate elongated structures. These elongated structures may cause issues when introduced into the body. By controlling parameters such as (1) flow properties, such as the residence time in the flow process stream, (2) heating duration, (3) magnitude of heating, (4) extent of mixing, (5) the intra-liposomal salt concentration, (6) the extra-liposomal salt concentration, (7) the intraliposomal pH value and (8) the extra-liposomal pH value, the degree of molecular encapsulation and subsequent crystal growth or precipitation can be precisely controlled. Moreover, the system 100 described herein coupled with static mixers can be used to control the amount of mixing throughout the process. Lastly, the system 100 further coupled with one or more analyzers as discussed in additional detail below further enables control of drug encapsulation and can be used to accurately predict the drug encapsulation and/or crystal growth. Therefore, the system 100 described herein enables one to form nanoparticles with a controlled morphology that is well-suited for pharmaceutical applications, which can lead to high-quality drug products that may lead to minimized adverse reactions (patient complications), reduced safety issues and reduced drug product lot/batch variability.

As a second example, the system 100 of FIG. 49 can be used to modify the surface characteristics of liposomal nanoparticles, where a lipopolymer is inserted into the outer leaflet of the lipid bilayer (post-insertion method). In this case, a lipopolymer such as DSPE-mPEG2000 can be added into the first inlet 102. Pre-formed liposomes are added to the second inlet 104 and the two process streams are mixed at fixed flow rates using the pump/flow meters. The degree of heating can be controlled by the flow rate, the temperature of the first heat exchanger 114 and the first mixer 118. Temperatures between 60-90 degrees Celsius may be used to promote this post-insertion method.

As such, the system 100 and methods disclosed herein can be used for modifying the surface of nanoparticles such as liposomes with molecules that can be introduced into the nanoparticle's surface following the known “post-insertion” method. Molecules that can be inserted using this method into a nanoparticle, such as a liposome, may include lipopolymers such as DSPE-mPEG (2000) or other similar molecules. In addition, these molecules may have active components such as an “active pharmaceutical ingredient” (APHI) linked to the hydrophilic region of the molecule used for insertion. One example would be an activated PEG phospholipid such as DSPE-PEG-Maleimide that can be linked with a thiol-containing oligonucleotide, polynucleotide, peptide and/or small molecule. These insertion molecules may have both a hydrophobic region and hydrophilic region and can form micellar structures when mixed with an aqueous phase. Upon heating and mixing with a liposomal dispersion, these micellar structures will insert into the outer leaflet of the liposomal lipid bilayer, thereby modifying the surface characteristics of the nanoparticle. A continuous flow approach with controlled heating and mixing stages, along with one or more valves, and one or more spectrometers and/or surface characteristic analyzers, will enable the formation of nanoparticles with enhanced surface characteristics such as controlled surface thickness, degree of surface coverage/coating and degree of molecular moiety additions such as cellular targeting moieties or APHIs.

As a third example, both doxorubicin-HCl and lipopolymer are added together and are subsequently injected into the liposomal phase at the mixing chamber 114. In this manner, the system 100 is used for the simultaneous intra-liposomal doxorubicin-HCl “active loading” and extra-liposomal surface modification. As such, the system 100 and methods disclosed herein can be used for the combination of the second implementation (controlled drug encapsulation) with the third implementation (modifying the surface of nanoparticles). This simultaneous drug loading and surface modifying approach designed as a continuous process enables a single unit operation that would otherwise require multiple steps or processes and reduces the overall processing time.

FIG. 50 illustrates another embodiment of the system 100 where an additional heat exchanger is included at each inlet of the mixing chamber 114. In particular, FIG. 3 shows a second heat exchanger 124 positioned between the first flow meter 110 and the mixing chamber 114, and a third heat exchanger 126 positioned between the second flow meter 112 and the mixing chamber 114. These additional heat exchangers 124, 126 are used to initiate the active loading process and/or the post-insertion method, as outlined above, to take place in the mixing chamber 114.

FIG. 51 illustrates another embodiment of the system 100 where an additional heat exchanger 128 is positioned downstream from the first mixer 118. This additional heat exchanger 128 is used to increase the total surface area of heating, which can be used to increase the residence time at the set temperature of the two heat exchangers 116, 128 and promote a greater degree of nanoparticle modification. In one example, the first heat exchanger 116 is set at a first temperature, and the additional heat exchanger 128 is set at a second temperature that is less than the first temperature.

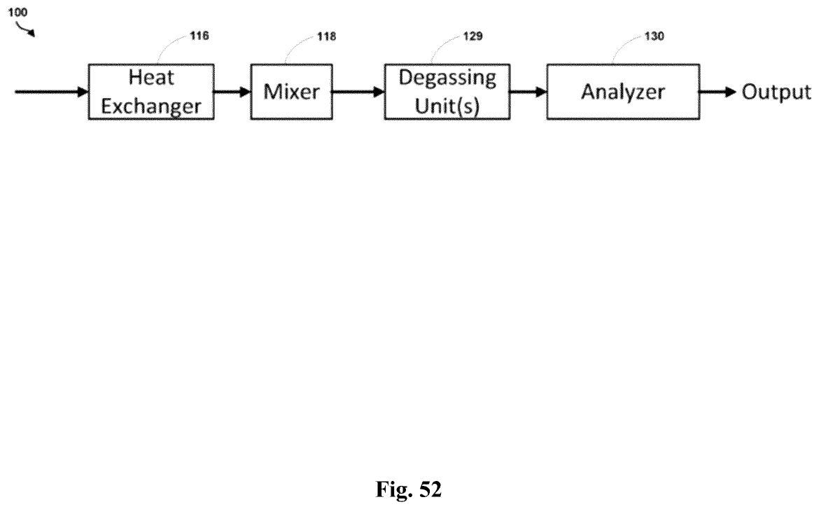

FIG. 52 illustrates another embodiment of the system 100, where an analyzer 130 is located downstream of the first mixer 116. The analyzer 130 is configured to analyze one or more attributes of a plurality of modified nanoparticles formed by the system 100. The analyzer 130 may comprises a single analyzer, or may comprise two or more analyzers. The analyzer 130 may take a variety of forms, such as a near-infrared (NIR) spectrometer, ultraviolet-visible (UV-VIS) spectrometer, Raman spectrometer, a VIS-NIR fluorescence spectrometer, a particle analyzer, conductivity, pressure, temperature and a zeta-potential analyzer. In one example, the analyzer 130 comprises a spectrometer configured for in-line analysis of the plurality of modified nanoparticles. As one specific example, the analyzer 130 can be a UV-Vis spectrometer and is used to determine the amount of doxorubicin-HCl that is loaded into intra-liposomal space. As another example, the analyzer is a surface charge analyzer and is used to measure the surface charge characteristics, such as the zeta-potential of the liposomal dispersion. From the post-insertion method described above, the insertion of lipopolymer into the liposomal outer leaflet may cause the zeta-potential change in magnitude and charge (e.g. from positive to negative charge) depending on the degree of surface coverage, lipopolymer characteristics and original surface charge of the pre-formed liposomes. In this manner, the surface charge analyzer coupled with predictive algorithms can be used to determine the amount of lipopolymer surface coverage on the outer leaflet of the liposomal nanoparticle.

The system may also include a controller (e.g. a microprocessor, field programmable gate array (FPGA), microcontroller, or the like) configured to a controller configured to (i) determine a difference between one or more desired attributes of the plurality of modified nanoparticles and one or more determined attributes of the plurality of modified nanoparticles, and (ii) in response to the determined difference, adjust one or more parameters of the system. In one example, the one or more parameters comprise one or more of a flow rate of the first pump, a flow rate of the second pump, a temperature of the first heat exchanger, a flow rate of the first heat exchanger, and a concentration of pre-formed liposomes provided to the second inlet. In one example, the one or more desired attributes of the plurality of modified nanoparticles may comprise one of a size or a surface charge of the plurality of modified nanoparticles. In another example, the one or more desired attributes of the plurality of modified nanoparticles comprises one or more physical characteristics of crystal growth in the plurality of modified nanoparticles including an amount of intra-vesicular crystal, a crystal packing, one or more dimensions of the intra-vesicular crystal, a quantity of crystals within an intra-vesicular space, a three dimensional space occupied by a crystal structure, and one or more surface characteristics.

As shown in FIG. 52, the system 100 may further include one or more degassing units 129 positioned upstream from the analyzer 130. The one or more degassing units 129 are used to stabilize the modified nanoparticles and remove dissolved gases that may interfere with the measurements performed by the analyzer 130.

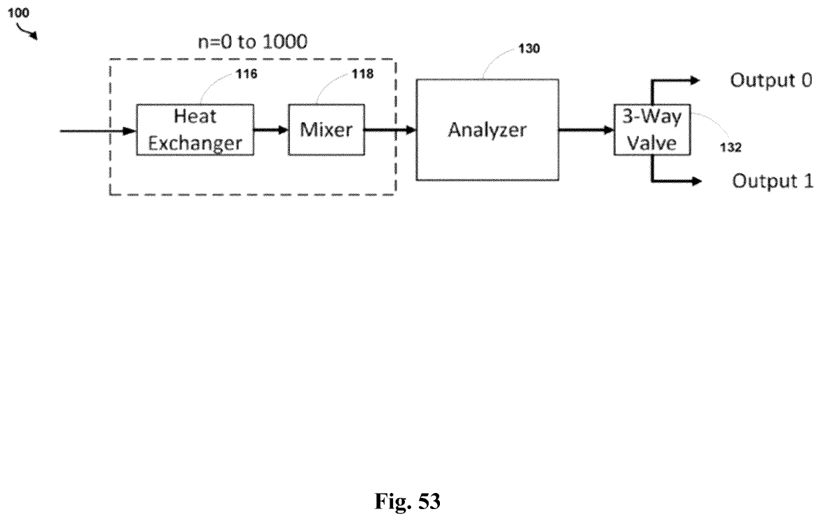

FIG. 53 illustrates an embodiment similar to FIG. 52, where the first heat exchanger 116 and first mixer 118 that are downstream from the mixing chamber 114 have one or more series of heat exchangers and mixers. As such, the system 100 may include one or more additional heat exchangers each in fluid communication with one or more additional mixers, where each of the one or more additional heat exchangers and the one or more additional mixers are positioned downstream from the first heat exchanger 116. These additional heat exchangers and mixers are used to increase the residence time at the setpoint temperatures and are also used to increase the amount of mixing. Any of the heat exchangers described herein may have a heat transfer area of 0.001 to 100 feet-squared.

FIG. 54 illustrates an embodiment similar to FIG. 53 with, except that the heat exchanger and the mixer are combined into a single unit 117.

FIG. 55 illustrates the first heat exchange 116, the first mixer 118, the analyzer 130, and a three-way valve 132 in fluid communication with the analyzer 130. FIG. 55 further illustrates that three-way valve 132 directs the plurality of modified nanoparticles to a first output or a second output based on the one or more determined attributes of the plurality of modified nanoparticles as determined by the analyzer 130. In one example, the first output comprises an exit of the system, and the second output is in fluid communication with one or more additional heat exchangers, mixers, and/or three-way valves as shown in FIG. 55. The three-way valves 132 are incorporated to direct the fluid flow to either exit the system or to continue to the next set of elements. In one example, doxorubicin-HCl is loaded into liposomes as outlined above, and where the analyzers are ultraviolet-visible light spectrometers, which are used to determine the total amount of doxorubicin-HCl that entered into the intra-liposomal space. Upon the doxorubicin-HCl/liposomal mixture flowing through each analyzer, a user-defined setpoint (e.g. 90% encapsulated) can be used to determine if the liposomal dispersion continues to the next set of elements or exits the system. In this case, if the doxorubicin-HCl/liposomal mixture was at only 75% encapsulated when it passed through the first set of elements, then the process stream would continue through the next n sets of elements until the desired setpoint of 90% or greater was reached.

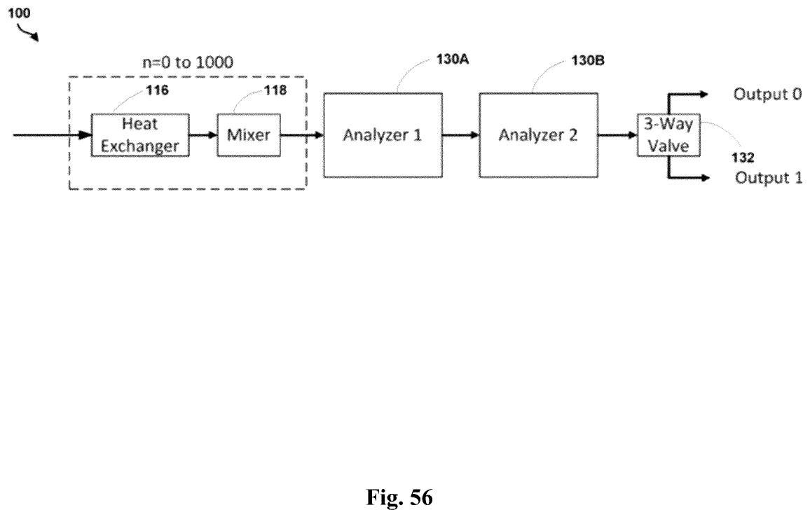

FIG. 56 illustrates another embodiment of the system 100, which incorporates a series of heat exchangers and mixers with two or more analyzers in fluid communication with the mixer. In particular, FIG. 56 illustrates a first analyzer 130A positioned downstream from the first heat exchanger 116, and a second analyzer 130B positioned downstream from the first analyzer 130A. The first analyzer 130A is configured to measure a first attribute of the plurality of modified nanoparticles, and the second analyzer 130B is configured to measure a second attribute of the plurality of modified nanoparticles that is different than the first attribute. In one example, the first attribute comprises an internal property of the plurality of modified nanoparticles (e.g. determining crystal growth and/or molecule encapsulation), and the second attribute comprises an external property of the plurality of modified nanoparticles (e.g. surface characteristics of the nanoparticle). This dual analyzer approach can be used when more than one nanoparticle modification is being performed simultaneously, e.g. the molecular loading or crystal growth in the intra-liposomal space and post-insertion of lipopolymers to the outer leaflet of the liposomal bilayer. Each analyzer can be coupled with predictive algorithms to determine if user-defined setpoints were achieved, and this information can then be used to determine which direction the process stream will flow out of the three-way valve 132.

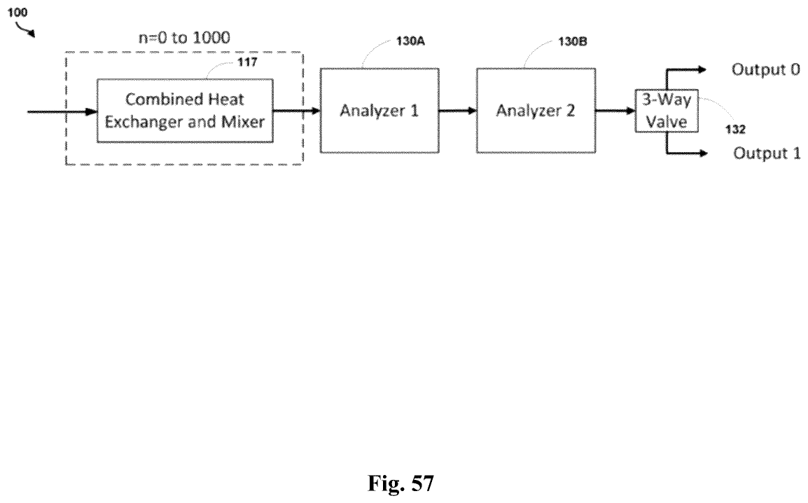

FIG. 57 illustrates the embodiment of FIG. 56, except that the first heat exchanger 116 and the first mixer 118 are combined into a single unit 117.

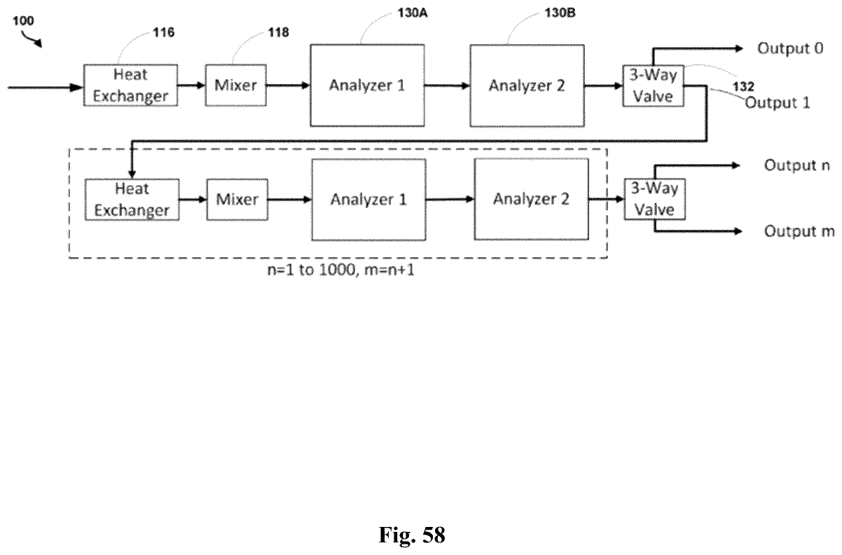

FIG. 58 illustrates an embodiment that combines the embodiments of FIG. 55 and FIG. 56. In this manner, two or more sets of analyzers 130A, 130B are used to determine multiple attributes. In one particular example, the user-defined values for doxorubicin-HCl encapsulation may be 90% and the surface coverage of the lipopolymer may be 80%. One possible algorithm that could be implemented would continue the pass the doxorubicin-HCl/liposomal dispersion through multiple sets of elements (a heat exchanger, mixer, a first analyzer, a second analyzer, and three-way valve) until both user-define attributes were reached. A second possible algorithm would selectively change the temperature of one or more heating exchangers to reach the user-defined values. In this manner, the system can be configured with one or more predictive algorithms to determine how to achieve the user-define setpoints simultaneously.

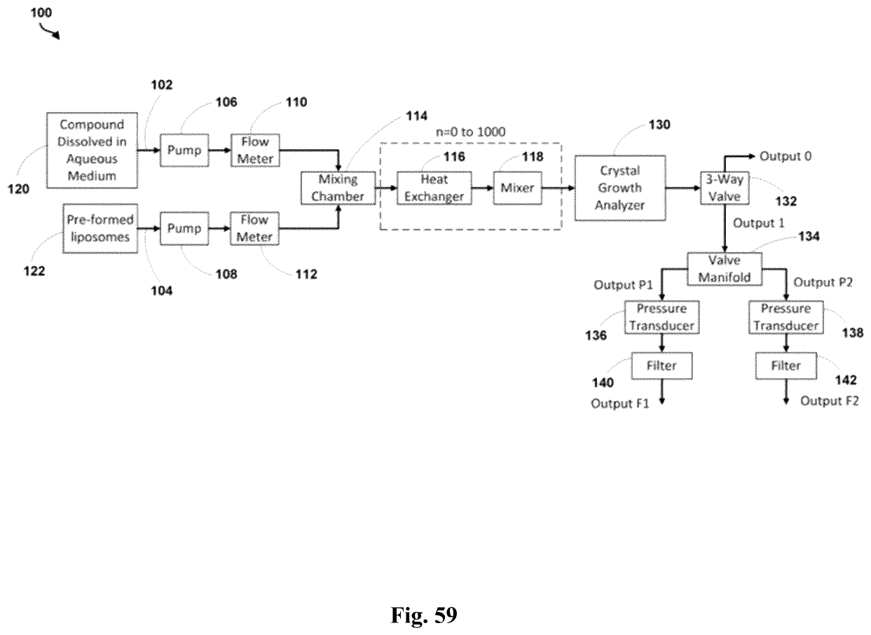

FIG. 59 illustrates a valve manifold 134 in fluid communication with the second output of the three-way valve 132. The valve manifold 134 comprises a first output and a second output. The system 100 of FIG. 59 further includes a first pressure transducer 136 in fluid communication with the first output of the valve manifold 134, and a second pressure transducer 138 in fluid communication with the second output of the valve manifold 134. The system 100 also includes a first filter 140 in fluid communication with the first pressure transducer 136, and a second filter 142 in fluid communication with the second pressure transducer 138. The first filter 140 and the second filter 142 may comprise 0.22 μm filters that are designed for sterile filtration. The valve manifold 134 is capable of switching from one filter to another depending on the pressure between the filter and the valve manifold 134 as detected by the pressure transducers 136, 138. If the pressure exceeds a set-point, the valve manifold will switch to another filter, where the filter that was at the high pressure is replaced with a new filter. That process repeats and the valve manifold 134 can keep switching between the filters 140, 142 until system shutdown.

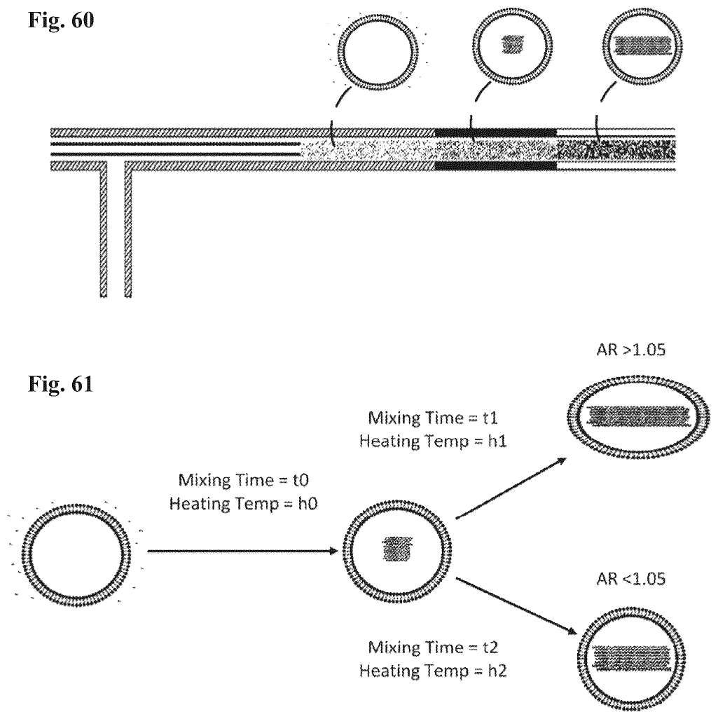

FIG. 60 is an example of a turbulent jet in co-flow that can be used to mix both process streams together. In this manner, one stream (e.g. the molecule to be entrapped) is injected directly into the centerline of the second stream (e.g. pre-formed liposomes) and the difference in flow characteristics can establish a turbulent jet to form, which can be used to mix both process streams. A heating zone and a static mixing zone downstream from where the process streams are mixing can promote molecular growth of intra-liposomal crystal structures. As such, the structure illustrated in FIG. 60 could be used as the mixing chamber 114 described above. In such an example, and as illustrates in FIG. 60, in one example the mixing chamber comprises an injection port including (i) a third inlet including a first tube in fluid communication with the first inlet, (ii) a fourth inlet including a second tube in fluid communication with the second inlet, and (iii) an outlet, wherein the second tube extends through the outlet of the injection port, and wherein the first tube is positioned concentrically within the second tube and terminates within the second tube. In one example, the first inlet includes pre-formed liposomes and the second inlet includes a compound dissolved in an aqueous medium. In another example, the first inlet includes a compound dissolved in an aqueous medium and the second inlet includes pre-formed liposomes. A degree of crystal growth in such a system is controlled by heating duration and degree of mixing.

FIG. 61 is an example of the mechanism of molecular growth within an intra-liposomal space. Different residence times are required to achieve different degrees of molecular growth. Some of the factors that can affect molecular growth such as intra- and extra-liposomal salt concentration, intra- and extra-liposomal pH values, the encapsulating molecule/total lipid ratio, total volumetric flow rate, extent of mixing, temperatures of the heat exchangers, surface area of the mixers and surface area of the heat exchangers can be used to control the growth of the intra-liposomal crystal. In some cases, the intra-liposomal crystal will only grow to the diameter of the pre-formed liposomes, resulting in an apparent aspect ratio of around less than 1.05 (nearly spherical particle). However, if the intra-liposomal crystal continues to grow under certain conditions (e.g. excess heat transfer, increased residence times, etc), then the intra-liposomal crystal may form elongated structures, with an AR of >1.05 and thus caused the liposomal nanoparticle to exhibit a non-spherical morphology.

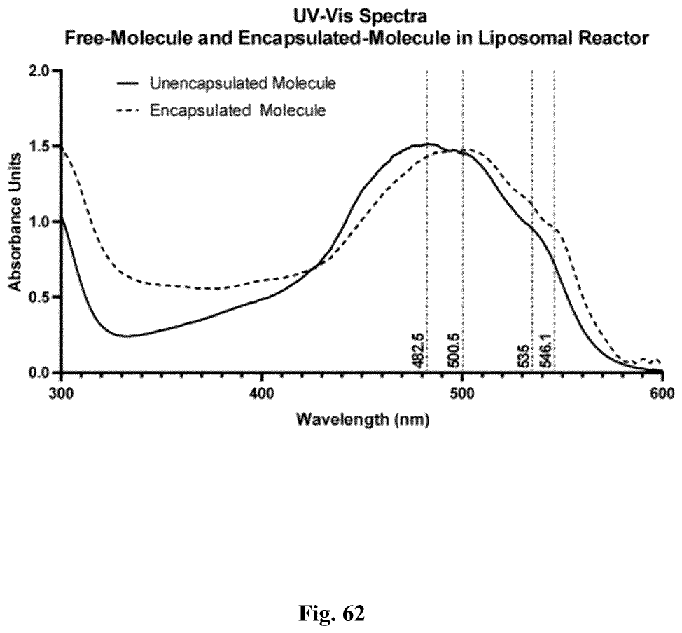

FIG. 62 is an example of how electronic spectrum may shift for a free-molecule (unencapsulated) and an encapsulated molecule that is undergoing crystal growth. This electronic spectrum is an example absorbance spectrum for doxorubicin-HCl over the ultraviolet-visible light range. The encapsulated molecule spectrum is red-shifted when compared to the unencapsulated molecule spectrum. In addition, a new shoulder appears near 535 nm and the shoulder near 546 nm becomes more prominent. By incorporating the spectral changes into a statistical design and analyzing the ratios of selected wavelengths, along with the total concentration of the doxorubicin-HCl in the sample, a predictive expression was formed that can be used to determine the amount of doxorubicin-HCl in the intra-liposomal space. This predictive equation has an R-squared of 0.99 and has less than 2% error. In this manner, electronic spectrum data can be used to determine crystal growth and extent of growth within the intra-liposomal space. Moreover, by coupling this electronic spectrum analysis with particle size analysis of the liposomes with encapsulated doxorubicin-HCl, the morphological changes can be further examined and characterized to enhance the predictive power for intra-liposomal crystal growth.

Below is an example of an expression that can be used to determine the encapsulated molecule percentage by taking ratios of wavelengths in the electronic spectrum at selected wavelengths.

$$[ Molecular Encapsulation ] = ( - 39.6 ) + 0.034 * Y 3 + 219.6 * Y 1 - 60.72 * Y 2 + ( Y 3 - 72.83 ) * ( ( Y 2 - 1.742 ) * 0.1104 ) + ( Y 3 - 72.83 ) * [ ( Y 1 - 1.027 ) * 4.569 ) + Y 1 - 1.027 ] * ( ( Y 2 - 1.742 ) * 726.2 ) + ( Y 3 - 72.83 ) * ( Y 2 1.742 * ( Y 1 - 1.027 ) * 16.82 ) )$$

[Molecule Encapsulation]=Concentration of Intraliposomal Molecule
ABS=Absolute Value
Y1=(ABS 500/482), where 500 and 482 represent Absorbance Units at respective wavelengths in nm.
Y2=(ABS 482/546), where 482 and 546 represent Absorbance Units at respective wavelengths in nm.
Y3=Total Concentration of Molecule (Encapsulated and Unencapsulated)

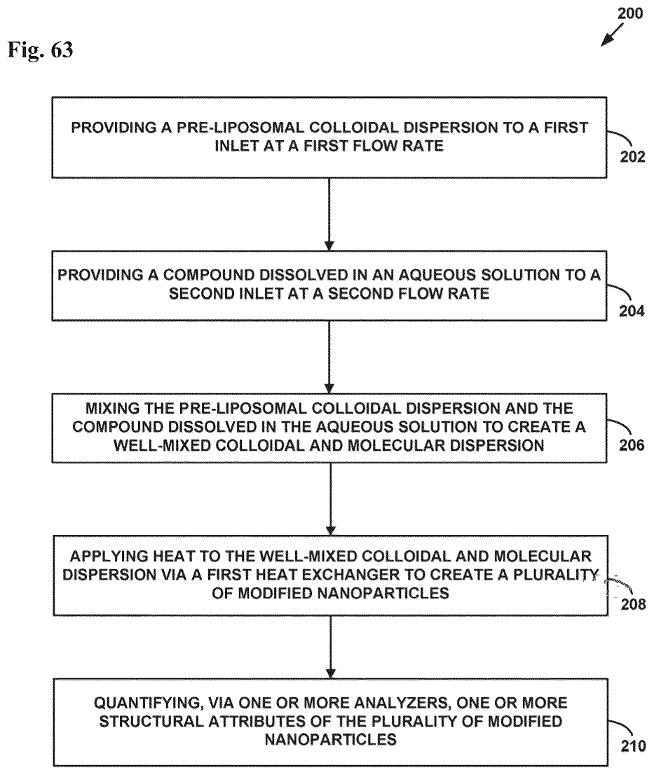

FIG. 63 is a block diagram of a method 200 for internal and external modification of nanoparticles in a continuous process. Method 200 shown in FIG. 63 presents an embodiment of a method that could be used by the system 100 of FIGS. 48-62, as an example. Method 200 may include one or more operations, functions, or actions as illustrated by one or more of blocks 202-210. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

In addition, for the method 200 and other processes and methods disclosed herein, the block diagram shows functionality and operation of one possible implementation of present embodiments. In this regard, each block may represent a module, a segment, or a portion of program code, which includes one or more instructions executable by a processor or computing device for implementing specific logical functions or steps in the process. The program code may be stored on any type of computer readable medium, for example, such as a storage device including a disk or hard drive. The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage device.

Initially, at block 202, the method 200 includes providing a pre-liposomal colloidal dispersion to a first inlet at a first flow rate. At block 204, the method 200 further includes providing a compound dissolved in an aqueous solution to a second inlet at a second flow rate. At block 206, the method 200 further includes mixing the pre-liposomal colloidal dispersion and the compound dissolved in the aqueous solution to create a well-mixed colloidal and molecular dispersion. At block 208, the method 200 further includes applying heat to the well-mixed colloidal and molecular dispersion via a first heat exchanger to create a plurality of modified nanoparticles. At block 210, the method 200 further includes quantifying, via one or more analyzers, one or more structural attributes of the plurality of modified nanoparticles.

The quantification of the one or more structural attributes can take a variety of forms. As examples, the one or more structural attributes of the plurality of modified nanoparticles comprise one or more of a particle size, a particle size distribution, an amount of intra-liposomal crystal, a crystal packing, one or more dimensions of the intra-liposomal crystal, a quantity of crystals within an intra-liposomal space, and a three dimensional space occupied by a crystal structure.

In one example, the method 200 further includes providing the plurality of modified nanoparticles to a static mixer, where the compound enters a liposomal core in the static mixer. In another example, the method 200 further includes reducing a temperature of the well-mixed colloidal and molecular dispersion via the heat exchanger to create a temperature-controlled colloidal and molecular dispersion that halts or reduces crystal growth.

In another example, the method 200 further includes (i) determining a difference between a desired structural attribute of the plurality of modified nanoparticles and a determined structural attribute of the plurality of modified nanoparticles, and (ii) in response to the determined difference, adjusting one or more of the second flow rate, a mixing time of the pre-liposomal colloidal dispersion and the compound in the aqueous solution, a temperature of the first heat exchanger, and a flow rate of the first heat exchanger.

In one example of the method 200, a residence time inside the first heat exchanger is adjusted to control a structural formation of a crystal structure in the plurality of modified nanoparticles. The first flow rate can range between about 1 mL/min and about 5,000 mL/min, and the second flow rate can range between about 1 ml/min and about 5,000 mL/min.

In one example, as discussed above in relation to FIG. 60, the first inlet is in fluid communication with a first tube, the second inlet is in fluid communication with a second tube, the first tube is positioned concentrically within the second tube, and the first tube terminates within the second tube, and the well-mixed colloidal and molecular dispersion is created at a location within the second tube where the first tube terminates. The method 200 can further include providing the compound in the aqueous solution to the second inlet at the second flow rate causes a turbulent jet to form.

As discussed above, the one or more analyzers may comprise one or more of a near-infrared (NIR) spectrometer, ultra-violet (UV-VIS) spectrometer, Raman spectrometer or a VIS-NIR fluorescence spectrometer, a particle analyzer, or a zeta-potential analyzer.

In one example, the one or more analyzers comprise (i) a first analyzer positioned downstream from the first heat exchanger, where the first analyzer is configured to measure a first attribute of the plurality of modified nanoparticles, and (ii) a second analyzer positioned downstream from the first analyzer, where the second analyzer is configured to measure a second attribute of the plurality of modified nanoparticles that is different than the first attribute.

In one example, the method 200 further includes (i) heating, via a second heat exchanger positioned between the first heat exchanger and the first inlet, the pre-liposomal colloidal dispersion, and (ii) heating, a third heat exchanger positioned between the first heat exchanger and the second inlet, the compound dissolved in the aqueous solution. These additional heat exchangers are used to initiate the active loading process and/or the post-insertion method, as outlined above, to take place in the mixing chamber

In another example, a valve manifold having a first output and a second output is positioned in fluid communication with the one or more analyzers, as discussed above in relation to FIG. 59. In such an example, the method 200 can further include (i) detecting, via a first pressure transducer in fluid communication with a first output of the valve manifold, a pressure between a first filter and the valve manifold, and (ii) if the detected pressure exceeds a threshold, then causing the valve manifold to close the first output and open the second output. In such an example, the valve manifold is capable of switching from one filter to another depending on the pressure between the filter and the valve manifold. If the pressure exceeds a set-point, the valve manifold will switch to another filter, where the filter that was at the high pressure is replaced with a new filter. This process repeats and the valve can keep switching between the filters until system shutdown.

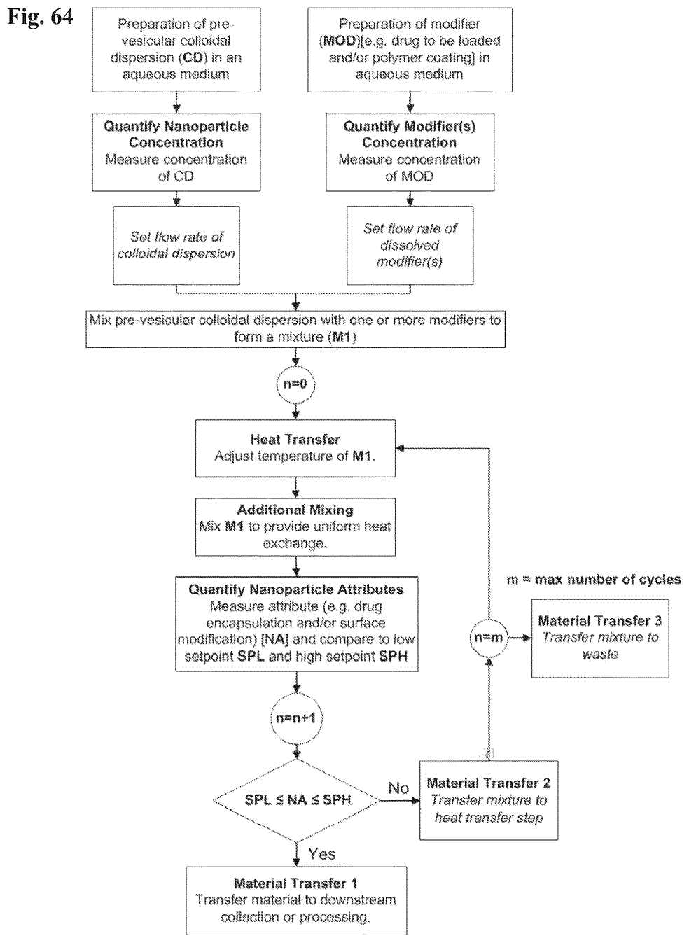

In another example, the method 200 further includes (i) determining a difference between a desired structural attribute of the plurality of modified nanoparticles and a determined structural attribute of the plurality of modified nanoparticles, (ii) if the determined difference is between a first threshold and a second threshold that is greater than the first threshold, providing the plurality of modified nanoparticles to an outlet, and (iii) if the determined difference is less than the first threshold, providing the plurality of modified nanoparticles back to the first heat exchanger. Such a method is illustrated in additional detail in FIG. 64.

In particular, as shown in FIG. 64, a pre-vesicular colloidal dispersion (CD) is prepared in an aqueous medium, and a modifier (MOD) (e.g. compound or drug to be loaded and/or polymer coating) is prepared in an aqueous medium. As used herein, the term “compound” and “modifier” are used interchangeably. The concentration of the CD and MOD is then determined, and a flow rate of the colloidal dispersion and a flow rate of the dissolved modifier(s) is set. The pre-vesicular colloidal dispersion with the dissolved modifiers are then mixed to form a mixture (M1). Heat is added to M1, and M1 is further mixed to provide uniform heat exchange throughout the mixture. One or more attributes of M1 are then measured (e.g. drug encapsulation and/or surface modification). The measured one or more attributes are compared to a low threshold (or low set point) as well as a high threshold (or high set point). If the measured one or more attributes are between the low threshold and the high threshold, then the M1 material is transferred downstream for collection or further processing. If the measured one or more attributes are above the high threshold, then the M1 material goes to waste. If the measured one or more attributes are under the low threshold, then the M1 material continues to the next set of heat exchangers and mixers. If the measured one or more attributes are under the low threshold there are no more heat exchangers/mixers in the process, then the M1 material goes to waste.

Having introduced aspects of methods and apparatus, some additional definitions, features and/or considerations are now presented.

In some embodiments, a computer program product is stored on non-transitory machine readable media. The computer program product (also known as “software”) may be configured to operate the methods and devices disclosed herein. The software may be configured with setpoints describing operational limitations of any one or more component, may include data tables such as may be used for guiding operations, evolutions, calibrations, error checking, troubleshooting, interfacing, reporting, communicating and data logging, among other things.

The software may include aspects of machine learning and artificial intelligence. Such aspects may collect data on an ongoing basis to improve characteristics of the methods and apparatus and system output.

The software may be configured to coordinate with external systems, such as systems providing feedstock, storage of output and other such systems.

The software may be configured to control a quality attribute according to a need. Generally, a quality attribute is any particular aspect, or aspects, of the nanoparticles that is of particular concern to an interested party.

Generally, with regard to “formation,” (FIG. 1, others) a mixing module forms nanoparticles from an organic phase and an aqueous phase. The mixing module may be a hardware assembly that meets a solvent-exchange rate within a target range inside a mixing zone. For example, the mixing module may include a concentric injector that forms a jet of organic phase into an aqueous phase at a flow ratio within a target range that a particle-size test confirms. Similar examples may include a T-junction mixer; an impingement jet mixer; a Dean-vortex mixer; a herringbone micromixer.

A flow ratio may be used to set an organic fraction in a mixing zone within a target range that a solvent assay confirms. A shear condition may be used to set a particle-size distribution within a target band that a particle-size test confirms. A heat exchanger sets a temperature within a target range. Sensors may be used to confirm at least one structural attribute. With regard to “conditioning” and “degassing” (FIG. 1; FIG. 50) a conditioner reduces solvent content from an initial fraction to a target fraction that a solvent assay confirms. A degassing unit removes dissolved gas to a residual level that an analyzer confirms.

With regard to “buffer exchange” (FIG. 1; FIGS. 51-53), a buffer-exchange module reduces a residual solvent fraction below a limit that a gas-chromatography assay confirms. Generally, the buffer-exchange module may include a membrane assembly that reduces a solvent fraction below a limit under a transmembrane pressure and a crossflow. For example, the buffer exchange module may be a cassette with a cutoff within a target range performs five diavolumes under a transmembrane pressure within a target range that a solvent assay confirms. Similar examples may include a hollow-fiber module; a flat-sheet cassette; a staged diafiltration manifold. It may be noted that a crossflow below a threshold causes fouling.

Generally, a “membrane unit” performs diafiltration under a transmembrane pressure within a target range. A crossflow rate sets shear that prevents fouling within a pressure limit. With regard to “concentration” (FIG. 1; FIGS. 51-53), a concentrator increases lipid concentration to a target level that an assay confirms. A recirculation loop sets crossflow that prevents fouling and that maintains a pressure below a limit. A concentrator holds a particle-size distribution within a target band during concentration that a particle-size test confirms.

With regard to “modification” (FIG. 49), a modification module may be used to perform internal loading or external surface change under a residence time and a temperature that an assay confirms. A packed-bed contactor or an equivalent unit provides a residence time within a target range. A heater provides a temperature within a target range. An assay may be used to confirm a loading efficiency or a surface-ligand density. Generally, the modification module is a hardware assembly that performs internal loading or external surface change under a residence time and a temperature. For example, the modification module may be a packed-bed contactor performs remote loading at a temperature within a target range for a residence time within a target range that an encapsulation assay confirms. Similar examples may include a tubular heater with a residence-time section; a membrane post-insertion unit; a static mixer that adds a ligand-conjugation reagent stream. It should be noted that a residence time below a threshold may yields an encapsulation efficiency below a limit.

With regard to “sensors” and “Control” (FIG. 1; FIG. 54-55), sensors provide at least one signal that correlates with particle size or composition. A UV-Vis spectrum confirms encapsulation or composition during production. A controller computes an error relative to a set-point. A controller adjusts at least one flow and at least one temperature to maintain each target within limits.

Advantages and technical effects of the teachings herein include a platform that provides real-time control of critical quality attributes relative to conventional batch and chip-parallel systems. A controller receives sensor signals and adjusts flows and temperature to hold a particle-size distribution within a target band that a dynamic light scattering test confirms. A mixing module and a conditioner reduce uncontrolled growth by limiting hold-up volume between formation and downstream units that a residence-time distribution test confirms. A buffer-exchange module reduces residual solvent to a target fraction that a gas-chromatography assay confirms. A concentrator increases lipid concentration to a target level without an increase in polydispersity that a particle-size test confirms. Quality attributes may include at least one of particle-size, residual-solvent fraction, nanoparticle concentration, encapsulation efficiency, a quantity of an active pharmaceutical ingredient, an endotoxin concentration, a bacterial concentration and surface-ligand density.

Additionally, an end-to-end line removes intermediate storage steps that may cause drift in composition and size. A degassing unit reduces dissolved gas to a target residual that a dissolved-oxygen or headspace analysis confirms. A modification module achieves a target encapsulation efficiency or a target surface-ligand density that an HPLC or UV-Vis assay confirms. A single continuous train scales throughput by flow rate rather than by multi-chip parallelization that a mass-balance test confirms. A controller maintains target values within preset limits during step changes in feed conditions that a designed disturbance test confirms.

Described are embodiments of manufacturing systems that includes sensors, at least one controller, mixing module, conditioner, buffer-exchange module, concentrator, and modification module. Generally, the controller reads a particle-size proxy and a composition proxy from sensors. The controller computes an error relative to a set point. The controller actuates pumps, valves, and heaters to change a flow ratio, a recirculation flow, a diafiltration flow, and a temperature within preset limits. The system produces a processed dispersion that meets target particle size, residual-solvent content, concentration, and encapsulation that defined tests confirm.

The disclosure recites a feedback loop that conventional batch and chip-parallel arrangements do not provide. The controller receives sensor inputs during formation and during downstream processing. The controller issues commands that drive hardware modules. The feedback loop maintains critical quality attributes within limits during feed disturbances and temperature shifts. The claim therefore recites a specific control architecture applied to specific manufacturing equipment that produces a material transformation by defined operations.

Accordingly, in some embodiments, a computer program product is provided. The computer program product may be stored on non-transitory machine readable media and include instructions for implementing methods. The methods may provide for control of equipment (such as that which is disclosed herein as well as a variety of other functionally related equivalents), communications, user-interaction, input and output, calculations and estimations, and other functions as set forth herein.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Various other components may be included and called upon for providing for aspects of the teachings herein. For example, additional elements, combinations of elements and/or omission of elements may be used to provide for added embodiments that are within the scope of the teachings herein. Adequacy of any particular element for practice of the teachings herein is to be judged from the perspective of a designer, manufacturer, seller, user, system operator or other similarly interested party, and such limitations are to be perceived according to the standards of the interested party.

Interpretation of embodiments disclosed herein are to be construed liberally and in favor of the inventors. No conflicts or statements against interest should be construed from the various embodiments disclosed herein.

In the disclosure hereof any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Applicants thus regard any means which can provide those functionalities as equivalent to those shown herein. No functional language used in claims appended herein is to be construed as invoking 35 U.S.C. § 112(f) interpretations as “means-plus-function” language unless specifically expressed as such by use of the words “means for” or “steps for” within the respective claim.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. The term “exemplary” is not intended to be construed as a superlative example but merely one of many possible examples.

What is claimed is:

1. A continuous nanoparticle processing system comprising:
a flow path between an inlet and an outlet;
at least one sensor positioned to generate a signal indicative of a quality attribute of nanoparticles within the flow path;
at least one actuator coupled to the flow path; and
a controller operatively coupled to the sensor and the actuator and configured to, during operation, adjust the actuator in response to the signal to maintain the quality attribute of the nanoparticles within a target range while the nanoparticles traverse the flow path.

2. The system of claim 1, wherein the actuator comprises at least one of a pump, a valve, a heater, a mixer, a heat exchanger, a chiller, or a pressure regulator.

3. The system of claim 1, wherein the sensor comprises at least one of a near-infrared (NIR) spectrometer, ultraviolet-visible (UV-VIS) spectrometer, Raman spectrometer, a VIS-NIR fluorescence spectrometer, a particle analyzer, conductivity, pressure, temperature and a zeta-potential analyzer.

4. The system of claim 1, wherein the controller comprises a processor and a non-transitory memory storing instructions that, when executed by the processor, configure the controller to adjust the actuator in response to the signal.

5. The system of claim 1, wherein the flow path comprises modular connections between components of the system that permit reconfiguration without intermediate hold tanks.

6. The system of claim 1, wherein the flow path lacks uncontrolled hold volumes between a formation location and a downstream location.

7. The system of claim 1, wherein the quality attribute comprises at least one of particle-size, residual-solvent fraction, nanoparticle concentration, encapsulation efficiency, a quantity of an active pharmaceutical ingredient, an endotoxin concentration, a bacterial concentration and surface-ligand density.

8. A non-transitory computer-readable medium storing instructions that, when executed by a processor of a controller of a continuous nanoparticle processing system having a flow path between an inlet and an outlet, cause the controller to:
receive a signal from at least one sensor indicative of a quality attribute within the flow path;
compute an error relative to a set point; and
command at least one actuator to adjust at least one parameter to maintain the quality attribute within a target range during continuous passage.

9. The non-transitory computer-readable medium of claim 8, wherein the parameter comprises at least one of a flow ratio, a flow, a diafiltration step, pressure and a temperature.

10. The non-transitory computer-readable medium of claim 8, wherein the sensor comprises at least one of a near-infrared (NIR) spectrometer, ultraviolet-visible (UV-VIS) spectrometer, Raman spectrometer, a VIS-NIR fluorescence spectrometer, a particle analyzer, conductivity, pressure, temperature and a zeta-potential analyzer.

11. The non-transitory computer-readable medium of claim 8, comprising instructions that implement an application programmer interface (API) with endpoints to (i) set a target for a quality attribute, (ii) read a current value and an error, and (iii) enable or disable closed-loop control.

12. The non-transitory computer-readable medium of claim 8, comprising instructions that expose an API endpoint to write actuator limits for at least one of a flow, a pressure, and a temperature.

13. The non-transitory computer-readable medium of claim 8, comprising instructions that implement role-based access control for application programmer interface (API) operations including viewing status, editing set points, editing limits, and initiating a controlled shutdown.

14. The non-transitory computer-readable medium of claim 8, comprising instructions that compute a control output by a proportional-integral-derivative algorithm with anti-windup subject to actuator limits.

15. The non-transitory computer-readable medium of claim 8, comprising instructions that implement an application programmer interface (API) endpoint to publish alarms upon error threshold exceedance or loss of a sensor or actuator.

16. The non-transitory computer-readable medium of claim 8, comprising instructions that load a recipe comprising a set point, a ramp profile, and actuator limits, and expose an application programmer interface (API) endpoint to activate the recipe.

17. The non-transitory computer-readable medium of claim 8, comprising instructions that expose an application programmer interface (API) endpoint to declare availability of a formation module, a buffer-exchange module, a concentrator, or a modification module and to reconfigure control routing when a module is bypassed.

18. The non-transitory computer-readable medium of claim 8, comprising instructions that detect loss of sensor updates or control-loop execution and commands a controlled shutdown according to stored limits, a concentrator, or a modification module and to reconfigure control routing when a module is bypassed.

19. A continuous nanoparticle processing system comprising:
a flow path that receives a stream comprising nanoparticles; at least one sensor that generates a signal indicative of a critical quality attribute;
at least one actuator; and
a controller configured to adjust the actuator in response to the signal to maintain the critical quality attribute of the nanoparticles within a target range during continuous passage of the stream.

20. The system of claim 19, wherein the nanoparticles comprises liposomes.
